(19) United States
(12) Patent Application Publication
(10) Pub. No.: US 2015/0261427 A1
(43) Pub. Date: Sep. 17, 2015

(54) METHOD FOR CONTROLLING INFORMATION APPARATUS AND COMPUTER-READABLE RECORDING MEDIUM

(71) Applicant: PANASONIC INTELLECTUAL PROPERTY CORPORATION OF AMERICA, Torrance, CA (US)

(72) Inventor: Takamitsu SASAKI, Osaka (JP)

(73) Assignee: PANASONIC INTELLECTUAL PROPERTY CORPORATION OF AMERICA, Torrance, CA (US)

(21) Appl. No.: 14/674,600

(22) Filed: Mar. 31, 2015

Related U.S. Application Data
(63) Continuation of application No. PCT/JP2014/000866, filed on Feb. 19, 2014.
(60) Provisional application No. 61/880,237, filed on Sep. 20, 2013.
(60) Provisional application No. 61/856,126, filed on Jul. 19, 2013.

(51) Int. Cl. G06F 3/0484; G06F 3/0482; H04L 12/24; G06F 3/0481

(52) U.S. Cl. CPC G06F 3/04847; G06F 3/04817; G06F 3/0482; G06F 3/04842; H04L 41/22

(57) ABSTRACT

A method of the present disclosure causes a computer of an information apparatus to: display on the display a display screen including one or more device type icons, each of the one or more device type icons representing each of the one or more target devices for each of device types; and when selection of any one of the one or more device type icons is sensed on the display screen, display a device screen for one or more target devices included in one device type corresponding to the selected one device type icon. The device screen includes one or more first operation screens and a second operation screen, each of the one or more first operation screens being used for operating respective one of the one or more target devices, the second operation screen being used for turning off powers of all of the one or more target devices.

### TECHNICAL FIELD

The present disclosure relates to a method for controlling an information apparatus and a computer-readable recording medium.

### BACKGROUND ART

Technologies for remotely monitoring or remotely controlling one or more target devices using a single remote controller have been proposed.

In Patent Document 1, “list/menu of home electric appliances” is displayed as a first layer of display screen for operating home electric appliances. This “list/menu of home electric appliances” shows icons for “air conditioner”, “refrigerator”, “microwave oven”, and “washing machine”, for example. Next, when, for example, the icon for “air conditioner” is selected from the display screen showing the “list/menu of home electric appliances”, “air conditioner menu” is displayed as a second layer of display screen. This “air conditioner menu” shows icons for “living room”, “child room”, and “kitchen”, for example, where air conditioners are installed. Subsequently, when the icon for “living room” is selected from this “air conditioner menu”, for example, “operation menu” is displayed as a third layer of display screen. This “operation menu” shows, for example, “operation state (ON state)”, “operation mode (automatic mode)”, “temperature (23° C.)”, and “air purification (OFF state)” (paragraphs [0018] to [0028], FIG. 4, etc).

In Patent Document 2, a control screen showing “entire house” is displayed as a first layer of display screen for operating home electric appliances. This “entire house” control screen displays an illumination component type control object corresponding to “illumination system”, an environment component type control object corresponding to “thermostat”, and audio component type control objects corresponding to “audio”, “player”, and “alarm system”, for example. Next, when the illumination component type control object corresponding to “illumination system” is selected from the “entire house” control screen, for example, “illumination control screen” is displayed as a second layer of display screen. This “illumination control screen” displays illumination control objects such as “Family Room Light”, “Theater Light”, and “Master Bath Light 2”. Subsequently, when any of the illumination control objects is selected from the room control screen for the “illumination control screen”, “sublevel screen” is displayed as a third layer of display screen. This “sublevel screen” displays available control options such as “dimming” and “timer control” (paragraphs [0044] to [0051], FIGS. 6 and 7, etc).

However, Patent Documents 1 and 2 need further improvement.

### CITATION LIST

### Patent Document

Patent Document 1: Japanese Unexamined Patent Publication No. 2005-310022

Patent Document 2: Japanese Unexamined Patent Publication No. 2011-187080

### SUMMARY OF INVENTION

In one general aspect, the techniques disclosed here feature a method for controlling an information apparatus, the information apparatus having a display and being connected to a network, one or more target devices being controlled over the network,

the method causing a computer of the information apparatus to:

display on the display a display screen including one or more device type icons, each of the one or more device type icons representing each of the one or more target devices for each of device types;

when selection of any one of the one or more device type icons is sensed on the display screen, display a device screen for one or more target devices included in one device type corresponding to the selected one device type icon, the device screen including one or more first operation screens and a second operation screen, each of the one or more first operation screens being used for operating respective one of the one or more target devices, the second operation screen being used for turning off powers of all of the one or more target devices;

output a first control command to the network when a first operation is sensed using any one of the one or more first operation screens, the first control command controlling one target device corresponding to the one of the one or more first operation screens among the one or more target devices based on the first operation; and

output a second control command to the network when a second operation is sensed using the second operation screen, the second control command turning off powers of all of the one or more target devices based on the second operation.

Further improvement can be achieved by the foregoing aspect. These general and specific aspects may be implemented using a system, a method, and a computer program, and any combination of systems, methods, and computer programs.

### BRIEF DESCRIPTION OF DRAWINGS

FIG. 1 is an overall configuration diagram of a home control system to which a home controller according to an embodiment of the present disclosure is applied.

FIG. 2 is a diagram showing the primary devices controlled by the home controller according to the embodiment of the present disclosure.

FIG. 3 is a block diagram showing the configurations of the home controller, a device, and a server, according to the embodiment of the present disclosure.

FIG. 4 is a diagram showing an example of the configuration of an implementation form of the home controller according to the embodiment of the present disclosure.

FIG. 5 is a diagram showing an example of a basic screen of the home controller according to the embodiment of the present disclosure.

FIG. 6 is a diagram showing another example of the basic screen of the home controller according to the embodiment of the present disclosure.

FIG. 7 is a diagram showing yet another example of the basic screen of the home controller according to the embodiment of the present disclosure.

FIG. 8 is a diagram showing an example of a room screen that is displayed on a display of the home controller in the embodiment of the present disclosure.

FIG. 9 is a diagram showing an example of a detail control screen that is displayed on the display of the home controller in the embodiment of the present disclosure.

FIG. 10 is a diagram showing another example of the detail control screen that is displayed on the display of the home controller in the embodiment of the present disclosure.

FIG. 11 is a diagram showing an example of transition of a display screen on the display according to the embodiment of the present disclosure.

FIG. 12 is a diagram showing an example of transition of the display screen on the display according to the embodiment of the present disclosure.

FIG. 13 is a diagram showing an example of transition of the display screen on the display according to the embodiment of the present disclosure.

FIG. 14 is a diagram showing an example of transition of the display screen on the display according to the embodiment of the present disclosure.

FIG. 15 is a diagram showing another example of transition of the display screen on the display according to the embodiment of the present disclosure.

FIG. 16 is a diagram showing another example of transition of the display screen on the display according to the embodiment of the present disclosure.

FIG. 17 is a diagram showing an example of a collective control setting screen that is displayed on the display of the home controller in the embodiment of the present disclosure.

FIG. 18 is a diagram showing an example of transition of the display screen having the collective control setting screen according to the embodiment of the present disclosure.

FIG. 19 is a diagram showing an example of transition of the display screen having the collective control setting screen according to the embodiment of the present disclosure.

FIG. 20 is a diagram showing yet another example of the basic screen of the home controller according to the embodiment of the present disclosure.

FIG. 21 is a diagram showing yet another example of the basic screen of the home controller according to the embodiment of the present disclosure.

FIG. 22 is a diagram showing the configuration of home information according to the embodiment of the present disclosure.

FIG. 23 is a diagram showing the configuration of room information managed by the server in the embodiment of the present disclosure.

FIG. 24 is a diagram showing the configuration of room information managed by the home controller in the embodiment of the present disclosure.

FIG. 25 is a diagram showing the configuration of a device list managed by the server in the embodiment of the present disclosure.

FIG. 26 is a diagram showing the configuration of a device list managed by the home controller in the embodiment of the present disclosure.

FIG. 27 is a sequence diagram showing a flow of processes in which the home controller acquires home information from the server in the embodiment of the present disclosure.

FIG. 28 is a sequence diagram showing a flow of processes in which the home controller senses a device on a network after being connected to the network in the embodiment of the present disclosure.

FIG. 29 is a sequence diagram showing a flow of processes in which the home controller senses a device on the network when the device is connected to the network in the embodiment of the present disclosure.

FIG. 30 is a flowchart showing a flow of processes in which the home controller controls a device when the basic screen or the room screen is displayed on the display in the embodiment of the present disclosure.

FIG. 31 is a flowchart showing a flow of processes in which the home controller controls a device when the detail control screen is displayed on the display in the embodiment of the present disclosure.

FIG. 32 is a flowchart showing a flow of processes in which the home controller transmits a control command in the embodiment of the present disclosure.

FIG. 33 is a sequence diagram showing a flow of processes in which the home controller directly controls a device in the embodiment of the present disclosure.

FIG. 34 is a sequence diagram showing a flow of processes in which the home controller controls a device through the server in the embodiment of the present disclosure.

FIG. 35 is a sequence diagram showing a flow of processes in which the home controller acquires a state of a device from the server in the embodiment of the present disclosure.

FIG. 36 is a sequence diagram showing a flow of processes in which the home controller directly controls a plurality of devices when controlling the plurality of devices by a single operation in the embodiment of the present disclosure.

FIG. 37 is a sequence diagram showing a flow of processes in which the home controller controls a plurality of devices through the server when controlling the plurality of devices by a single operation in the embodiment of the present disclosure.

FIG. 38 is a sequence diagram showing a flow of processes in which the home controller controls a plurality of devices through the server when controlling the plurality of devices by a single operation in the embodiment of the present disclosure.

FIG. 39 is a sequence diagram showing a flow of processes for updating the device lists of the home controller and the server in the embodiment of the present disclosure.

FIG. 40 is a sequence diagram showing a flow of processes for updating the device lists of the home controller and the server in the embodiment of the present disclosure.

FIG. 41 is a sequence diagram showing a flow of processes for updating the device lists of the home controller and the server in the embodiment of the present disclosure.

FIG. 42A is a diagram showing the configuration of power consumption information transmitted by the home controller or the server in the embodiment of the present disclosure.

FIG. 42B is a diagram showing the configuration of the power consumption information transmitted by the home controller or the server in the embodiment of the present disclosure.

FIG. 43 is a sequence diagram showing an example of a process in which the home controller and server acquire power consumption in the embodiment of the present disclosure.

FIG. 44 is a sequence diagram showing another example of the process in which the home controller and server acquire power consumption in the embodiment of the present disclosure.

FIG. 45 is a sequence diagram showing yet another example of the process in which the home controller and server acquire power consumption in the embodiment of the present disclosure.

FIG. 46 is a diagram showing yet another example of the basic screen of the home controller in the embodiment of the present disclosure.

FIG. 47 is a diagram showing an example of a device screen that is displayed on the display of the home controller in the embodiment of the present disclosure.

FIG. 48 is a diagram showing an example of the detail control screen that is displayed on the display of the home controller in the embodiment of the present disclosure.

FIG. 49 is a diagram showing another example of the detail control screen that is displayed on the display of the home controller in the embodiment of the present disclosure.

FIG. 50 is a diagram showing an example of transition of the display screen on the display when the display screen is the basic screen shown in FIG. 46, according to the embodiment of the present disclosure.

FIG. 51 is a diagram showing an example of transition of the display screen on the display when the display screen is the basic screen shown in FIG. 46, according to the embodiment of the present disclosure.

FIG. 52 is a diagram showing an example of transition of the display screen on the display when the display screen is the basic screen shown in FIG. 46, according to the embodiment of the present disclosure.

FIG. 53 is a diagram showing an example of transition of the display screen on the display when the display screen is the basic screen shown in FIG. 46, according to the embodiment of the present disclosure.

FIG. 54 is a flowchart showing a flow of processes in which the home controller controls a device when the basic screen shown in FIG. 46 or the device screen shown in FIG. 47 is displayed on the display in the embodiment of the present disclosure.

FIG. 55 is a flowchart showing a flow of processes in which the home controller controls a device when the detail control screen shown in FIG. 48 is displayed on the display in the embodiment of the present disclosure.

FIG. 56 is a diagram showing yet another example of the basic screen of the home controller in the embodiment of the present disclosure.

FIG. 57 is a flowchart showing a flow of processes in which the home controller controls a device when the basic screen shown in FIG. 56 is displayed on the display in the embodiment of the present disclosure.

FIG. 58 is a diagram showing a modification of the basic screen shown in FIG. 7, according to the embodiment of the present disclosure.

FIG. 59 is a diagram showing another modification of the basic screen shown in FIG. 20, according to the embodiment of the present disclosure.

### DETAILED DESCRIPTION

(Circumstances Leading to the Invention of an Aspect of the Present Disclosure)

First, viewpoints of an aspect according to the present disclosure will be described.

An example in which a plurality of types of target devices including four air conditioners and fifteen illumination devices are operated by a single operation device is considered. In this example, first, device icons corresponding to all the target devices are displayed on a first layer of display screen. Next, when a desired device icon is selected therefrom, an operation screen corresponding to the selected device icon is displayed on a second layer of display screen. In this case, however, the first layer of display screen displays a large number of device icons, making it difficult to find a desired device icon. As a result, it takes a long time to operate the corresponding desired target device, lowering the efficiency of operating this desired target device. For example, when turning on an illumination device of a bedroom at bedtime, it is difficult to find the device icon corresponding to the illumination device of the bedroom, taking a long time to turn the illumination device of the bedroom on.

As a measure to cope with such a problem, more than two layers of display screens can be displayed to organize the device icons, as proposed in Patent Documents 1 and 2.

For instance, as in Patent Documents 1 and 2, device type icons that are categorized by the types of target devices can be displayed on the first layer of display screen. In this case, the device icon corresponding to a device type icon selected on the first layer of display screen is displayed on the second layer of display screen. Next, an operation screen corresponding to the device icon selected on the second layer of display screen is displayed on a third layer of display screen.

In case of the air conditioners, for example, even when there exist four air conditioners, a single device type icon corresponding to the type called “air conditioner” is displayed on the first layer of display screen. Also, in case of the illumination devices, even when there exist fifteen illumination devices, a single device type icon corresponding to the type called “illumination device” is displayed on the first layer of display screen. Next, when the device type icon corresponding to the air conditioners is selected on the first layer of display screen, four device icons corresponding to the air conditioners are displayed on the second layer of display screen. Subsequently, an operation screen for the air conditioners corresponding to the device icon selected on the second layer of display screen is displayed on the third layer of display screen.

As described above, while the device type icon is selected on the first layer of display screen and the desired target device is operated on the third layer of display screen, the device icon corresponding to the desired target device is displayed on the middle layer, the second layer of display screen in connection with the device type icon. In this case, the device type icon is selected on the first layer of display screen, and the device icon is selected on the second layer of display screen.

Therefore, even when the device type icons can be displayed by the types of the devices, the number of operations and time it takes to operate the desired target device increase, complicating the entire operation. In a case where a plurality of types of target devices are operated by a single operation device, the operation efficiency of operating the individual target devices becomes practically low depending on the number of layers of display screen, in spite of the effectiveness of hierarchically organizing the display screens.

Based on these observations, the inventors have come up with the inventions with the following aspects according to the present disclosure.

An aspect of the present disclosure is

a method for controlling an information apparatus, the information apparatus having a display and being connected to a network, one or more target devices being controlled over the network,

the method causing a computer of the information apparatus to:

display on the display a display screen including one or more device type icons, each of the one or more device type icons representing each of the one or more target devices for each of device types;

when selection of any one of the one or more device type icons is sensed on the display screen, display a device screen for one or more target devices included in one device type corresponding to the selected one device type icon, the device screen including one or more first operation screens and a second operation screen, each of the one or more first operation screens being used for operating respective one of the one or more target devices, the second operation screen being used for turning off powers of all of the one or more target devices;

output a first control command to the network when a first operation is sensed using any one of the one or more first operation screens, the first control command controlling one target device corresponding to the one of the one or more first operation screens among the one or more target devices based on the first operation; and

output a second control command to the network when a second operation is sensed using the second operation screen, the second control command turning off powers of all of the one or more target devices based on the second operation.

This aspect first displays a display screen that includes one or more device type icons representing the one or more target devices for each of device types, each of the device types including the one or more target devices, a type of each of the one or more target devices corresponding to the included device type.

In other words, for example, instead of displaying on the display a device icon for each of the target devices such as four air conditioners and fifteen illumination devices, a display screen that includes one or more device type icons representing the one or more target devices for each of device types is displayed as a first layer of display screen. As to the air conditioners, for example, even when there exist four air conditioners, a single device type icon corresponding to the type called “air conditioner” is displayed on the first layer of display screen. As to the illumination devices, even when there exist fifteen illumination devices, a single device type icon corresponding to the type called “illumination device” is displayed on the first layer of display screen. Thus, when searching for a desired target device, a device type icon corresponding to the type of the desired target device may be searched for on the first layer of display screen. This facilitates the efficient operation of the desired target device.

Next, when it is judged that selection of any of the one or more device type icons is sensed, a device screen of a target device of the type corresponding to the selected one device type icon is displayed.

In other words, when the device type icon is selected, the device screen which is the second layer of display screen is displayed on the display from the first layer of display screen. Accordingly, each of the target devices corresponding to the selected device type icon can be operated promptly, without requiring a further operation between the first layer of display screen and the second layer of display screen. Therefore, even when operating a plurality of target devices of a plurality of types using a single operation device, the number of times of switching the display screen is reduced, and the efficiency of operating a desired target device can be increased.

Next, the device screen has one or more first operation screens for operating, in a case where there exist a plurality of target devices of a type corresponding to the selected one device type icon, the corresponding target devices respectively. The device screen has a second operation screen for turning, in a case where there exist a plurality of target devices of a type corresponding to the selected one device type icon, off the powers of all of the target devices.

Even when the third layer of display screen under the device screen, which is the second layer, is not selected, the device screen, which is the display screen on the same layer, enables to individually operate the target devices corresponding to the selected one device type icon, and to collectively turn off the power of all of the target devices.

In other words, when selecting a device type icon for the type corresponding to the desired target device, a user might wish to operate the target devices of this type individually or to turn off all of the target devices corresponding to this type. It is not necessarily the case that the former operation is carried out more frequently than the latter operation. It is also not necessarily the case that the latter operation is carried out more frequently than the former operation. For example, the user may be likely to operate the target devices individually more often when inside a room and may likely to collectively turn all the powers of the devices off when leaving home.

In a case where the device type icon is selected, suppose that only the one or more first operation screens for operating the corresponding target devices respectively are displayed on the display. In this case, in order to display the second operation screen for turning off all the powers of the plurality of target devices, the user is required to execute some kind of an operation to further display the third layer of display screen. Similarly, in a case where the device type icon is selected, suppose that only the second operation screen for turning off all the powers of the plurality of target devices is displayed on the display. In this case, the user is required to execute an operation for further displaying the third layer of display screen to display the one or more first operation screens for operating the corresponding target devices respectively.

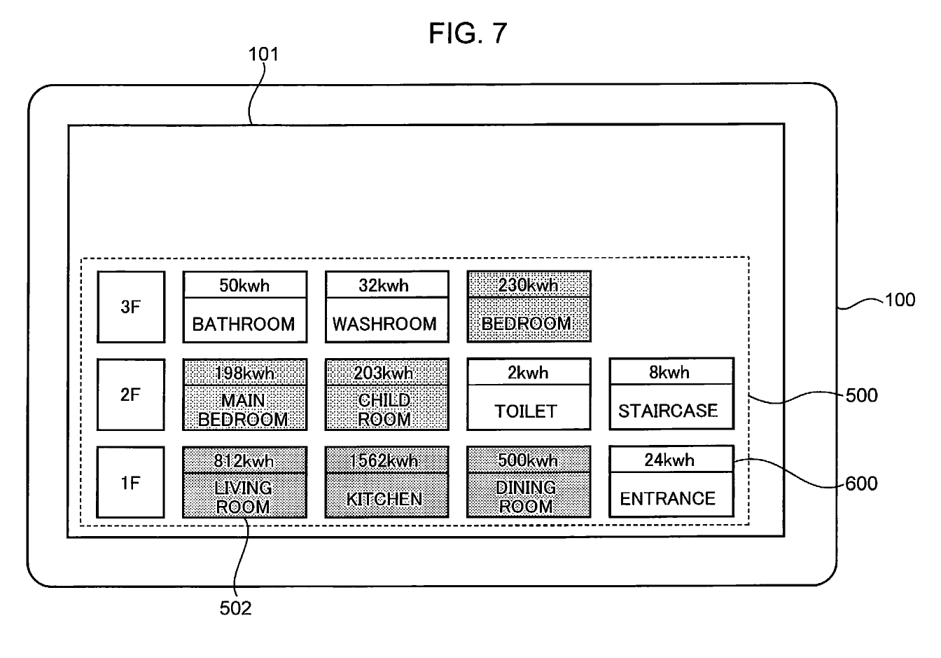

For instance, in Patent Document 2, on the second layer of display screen (FIG. 7), all the lights in the house are turned on or off by selecting a switch object that is operated as an “all lights off” switch or an “all lights on” switch of the entire house (paragraph [0049]). Also on the second layer of display screen (FIG. 7), when any of the plurality of illumination objects is double-clicked to call a sublevel screen, the individual lights are controlled using the sublevel screen (paragraph [0048]). In either case, the user is required to execute an operation for selecting the third layer of display screen from the second layer of display screen. For this reason, even when the device type icons categorized by the device types are displayed, the number of operations and time it takes to operate the desired target device increase, lowering the operation efficiency.

Note that Patent Document 1 is merely configured to turn off the powers of the target devices individually on the display screen for “operation menu”, which is the third layer of display screen. Patent Document 1 does not disclose that all the target devices corresponding to the type are collectively turned off.

According to this aspect, the first case in which the target devices corresponding to the type are operated individually and the second case in which the power of all the target devices corresponding to the type are collectively turned off can be realized by the same layer of display screen such as the device screen that is displayed as the second layer of display screen. Therefore, in order to operate a plurality of target devices of a plurality of types using a single operation device, an increase in the number of times to switch the display′ screens can be prevented and at the same time the efficiency of operating the desired target device can be improved.

The second operation screen is used to collectively turn off all the powers of the target devices of the type corresponding to the selected one device type icon. For example, when leaving home, this configuration enables to collectively turn off the power of the target devices of the same type installed in the building, without requiring the user to check which one of the target devices of a which type is on or off.

### Embodiment

An embodiment of the present disclosure is described hereinafter with reference to the drawings. Throughout the diagrams, the same components are denoted at the same reference numerals.

The present embodiment describes a home controller capable of controlling one or more devices by itself.

(Overall Configuration)

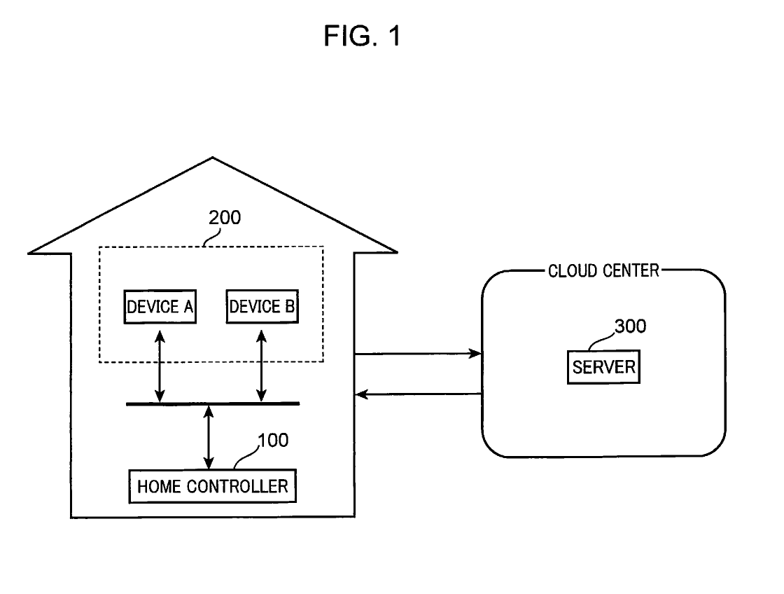

FIG. 1 is an overall configuration diagram of a home control system to which the home controller according to the present embodiment is applied. As shown in FIG. 1, the home control system has a home controller 100, a device 200 (an example of the target device), and a server 300.

The home controller 100 and one or more devices 200 (e.g., a device A 200, a device B 200) are placed in a house, and the server 300 is placed in a cloud center. The home controller 100, the devices 200, and the server 300 communicate with one another through a wired or wireless network. For instance, the devices 200 and the home controller 100 are connected communicably to each other by a wireless or wired home network, and the home controller 100, devices 200, and server 300 are connected communicably to one another by an external network such as the Internet.

Note that the home controller 100 does not always have to be placed inside the house and thus may be placed outside the house. In this case, a user controls one or more devices 200 from wherever the user has gone to.

A portable information terminal such as a smartphone or a tablet terminal is used as the home controller 100. This, however, is merely an example; thus, a touch-tone portable information terminal such as a cellular phone may be employed as the home controller 100.

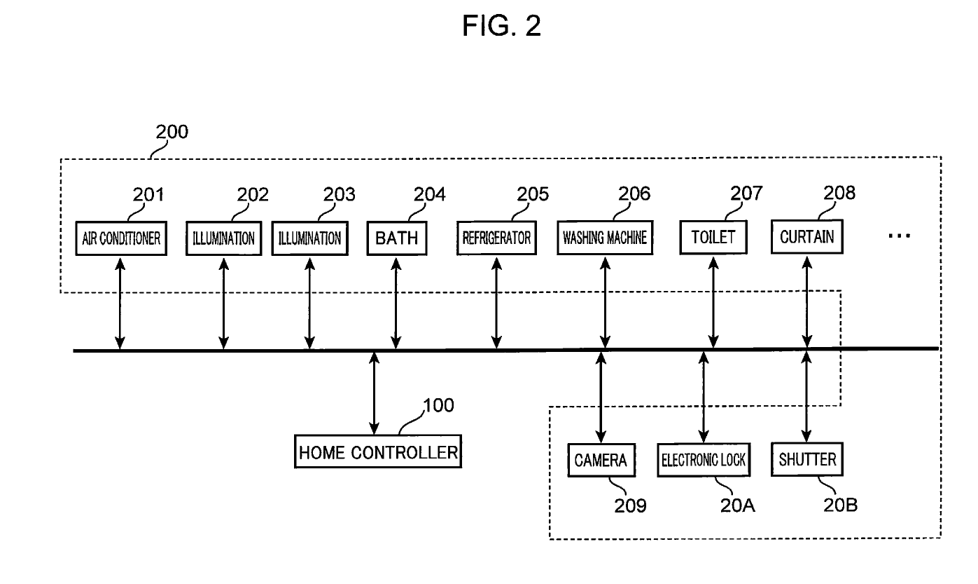

FIG. 2 is a diagram showing the primary devices 200 controlled by the home controller 100. The home controller 100 controls such devices 200 as an air conditioner 201, illumination devices 202, 203, a bath 204, a refrigerator 205, a washing machine 206, a toilet 207, an electric curtain device 208, a camera 209, an electronic lock 20A, and an electric shutter device 20B. Note that among the devices 200 controlled by the home controller 100 may be a plurality of devices 200 of the same type, such as the illumination device 202 and the illumination device 203.

The devices 200 such as the air conditioner 201 shown in FIG. 2 are merely exemplary, and television receivers (referred to as “TV”, hereinafter), Blu-ray recorders, audio devices and the like may be employed as the devices 200. In other words, any electronic devices capable of communicating with the home controller 100 can be employed as the devices 200. FIG. 2 shows the electronic devices for home use as the devices 200; however, the present embodiment is not limited thereto, and office devices used in offices and the like may be employed as well. Examples of the office devices include printers, personal computers, scanners, and copy machines.

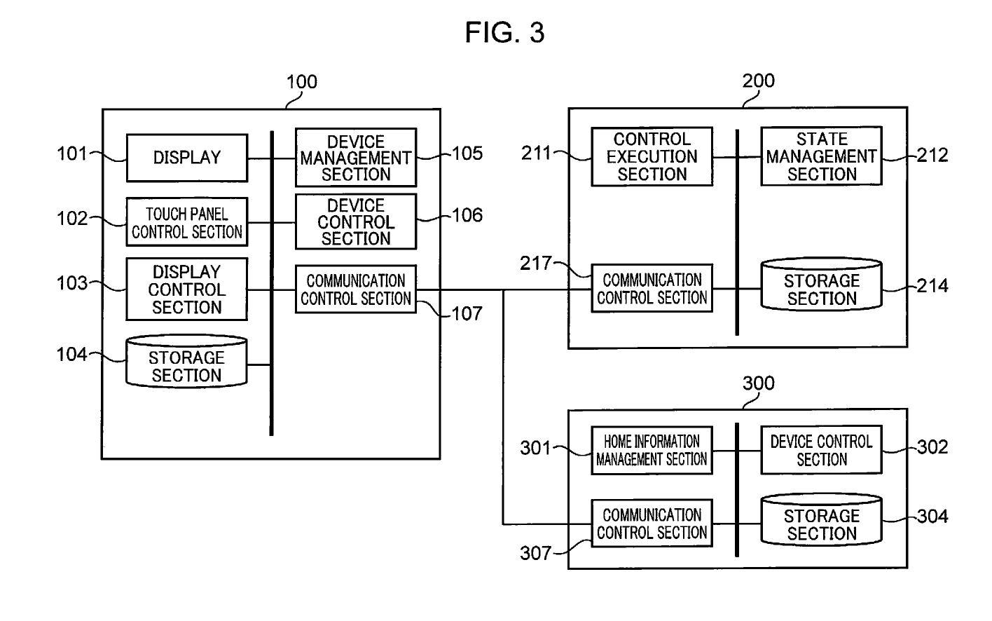

FIG. 3 is a block diagram showing the configurations of the home controller 100, one of the devices 200, and the server 300. As shown in FIG. 3, the home controller 100 has a display 101, a touch panel control section 102, a display control section 103, a storage section 104, a device management section 105, a device control section 106, and a communication control section 107.

The display 101 is configured by, for example, a touch panel display, and displays a user interface and the like for allowing the user to operate the home controller 100. The user can input various operations to the home controller 100 by touching the display 101.

Once recognizing a user operation on the display 101, the touch panel control section 102 interprets the content of the operation and sends the operation content to the other components. For example, in a case where there exists an object in a position on the display 101 tapped by the user, the touch panel control section 102 judges that the object is selected by the user. The object can be a button or various other types of GUI components for accepting user operations.

The display control section 103 generates a GUI (Graphical User Interface) for the home controller 100 and displays the GUI on the display 101. The storage section 104 stores information required to operate the home controller 100, such as a device list managed by the device management section 105.

The device management section 105 manages a control target device 200 using the device list stored in the storage section 104. Also, when there is a device 200 connected to the home network, the device management section 105 senses this device 200. Furthermore, the device management section 105 acquires home information 1300, described hereinafter, from the server 300 and stores and manages the acquired home information 1300 in the storage section 104. The device control section 106 issues a control command to the device 200. The communication control section 107 controls the communications between the home controller 100 and the device 200 and the communications between the home controller 100 and the server 300. The communication control section 107 also receives, from another block, a request for transmitting various data, transmits the request to the device 200 or the server 300, receives the data from the device 200 or the server 300, and delivers the data to a relevant block.

Note that the display 101 may not only be a touch panel display but also a normal display. In this case, the user may use an external input device such as a mouse, not shown, to move a pointer displayed on the display 101, and input an object selection instruction by clicking a desired object. Specifically, in the present embodiment, a series of operations that the user executes by touching the display 101 can be replaced with the operations for moving the pointer by using the external input device such as a mouse and clicking an object.

As shown in FIG. 3, each of the devices 200 has a control execution section 211, a state management section 212, a storage section 214, and a communication control section 217. The control execution section 211 receives a control command from the home controller 100 or server 300, and controls the relevant device 200 in response to the received control command. The details of the control performed on the device 200 by the control execution section 211 vary depending on the type of the device 200. For example, when the device 200 is an illumination device, the control execution section 211 turns the illumination device on/off. The control execution section 211 also transmits the result of the execution of the control command or the state of the device 200 to the home controller 100 or server 300.

The state management section 212 manages the state of the device 200. The details of the management performed on the device 200 by the state management section 212 vary depending on the type of the device 200. For example, when the device 200 is an illumination device, the state management section 212 manages the current ON state or OFF state of the illumination device. The storage section 214 stores information on the state of the device 200 managed by the state management section 212. The communication control section 217 controls the communications between the device 200 and the home controller 100 and the communications between the device 200 and the server 300. The communication control section 217 receives, from another block, a request for transmitting various data, transmits the request to the home controller 100 or server 300, receives the data from the home controller 100 or server 300, and delivers the data to a relevant block.

As shown in FIG. 3, the server 300 has a home information management section 301, a device control section 302, a storage section 304, and a communication control section 307. The home information management section 301 manages the home information 1300, described hereinafter, for each home or user account. The home information management section 301 transmits the home information 1300 to the home controller 100 in response to a request from the home controller 100. The home information management section 301 also acquires log information on the use history of the device 200 from the device 200 and information on the state of the device 200, and stores and manages these acquired information in the storage section 304.

The device control section 302 transmits a control command to the device 200 in response to a request from the home controller 100. The storage section 304 stores the home information 1300 managed by the home information management section 301, the information on the state of the device 200, and other information necessary for operating the server 300. As with the communication control section 107, the communication control section 307 controls the communications between the server 300 and the home controller 100 and the communications between the server 300 and the device 200. The communication control section 307 also receives, from another block, a request for transmitting various data, transmits the request to the home controller 100 or the device 200, receives the data from the home controller 100 or the device 200, and delivers the data to a relevant block.

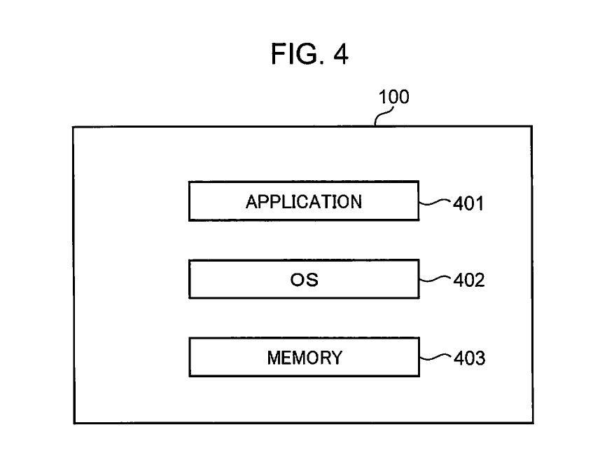

FIG. 4 is a diagram showing an example of the configuration of an implementation form of the home controller 100. As shown in FIG. 4, the home controller 100 has an application 401, an OS (Operating System) 402, a memory 403, and other hardware, not shown.

The application 401 is an application software for allowing a portable information terminal to function as the home controller 100 and is executed by a processor of the home controller 100. The home controller 100 may read the application 401 from a computer-readable recording medium or download the application 401 from a network, to implement the application 401. The OS 402 is a basic software of a portable information terminal and executed by the processor of the home controller 100. The memory 403 is configured by a memory unit such as a RAM and ROM of the home controller 100 and stores a group of data contained in the application 401. The processor of the home controller 100 executes the application 401 to realize the functions of the touch panel control section 102, the display control section 103, the storage section 104, the device management section 105, the device control section 106, and the communication control section 107, shown in FIG. 3. The processor of the home controller 100 also executes the application 401 to cause the memory 403 to function as the storage section 104.

However, in the present embodiment, the home controller 100 may be implemented by the application 401 alone, by the application 401 and the OS 402, by the application 401, the OS 402 and the memory 403, or by the application 401, the OS 402, the memory 403, and the other hardware that are not shown. The home controller 100 of the present embodiment can be realized in any of these implementation forms. Note, in the present embodiment, that a computer is configured by, for example, a processor and a memory unit that configure a portable information terminal. As the processor, a CPU, an FPGA, an ASIC, or a combination of two or more of these processors is employed. As the memory unit, for example, a ROM, a RAM, a hard disk, or a combination of two of more of these memory units is employed.

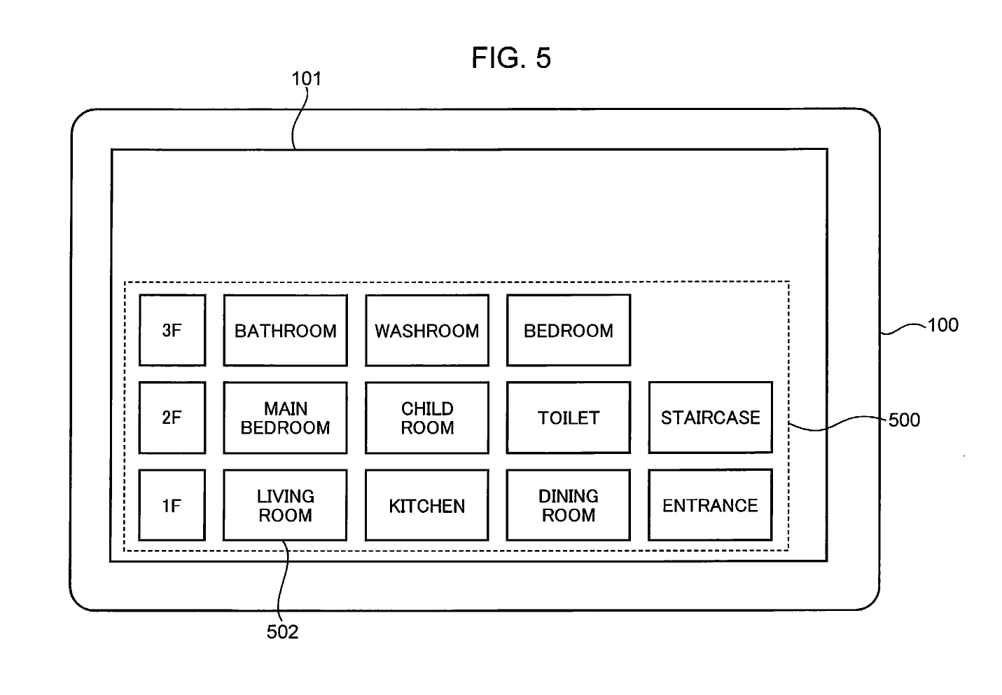

FIG. 5 is a diagram showing an example of a basic screen of the home controller 100. As shown in FIG. 5, the basic screen of the home controller 100 that is displayed on the display 101 has a floor plan 500. The floor plan 500 is a diagram that schematically shows an arrangement of one or more rooms configuring each floor of the house. The floor plan 500 includes room icons 502 representing the rooms. The room icons 502 are each expressed in the form of a square block to schematically represent each room. In the floor plan 500, the room icons 502 that represent the respective rooms of each floor are located in a matrix.

As shown in FIG. 5, the room icons 502 are in the form of blocks of the same size. The room icons 502 have names or abbreviations of rooms written thereon. Floor numbers are displayed in the vertical direction, and the room icons 502 that represent the rooms configuring a floor are arranged in a single horizontal row.

In the example shown in FIG. 5, this house is configured by three floors, a first floor to a third floor, wherein the room icons 502 for the rooms configuring the third floor are placed in the first row, the room icons 502 for the rooms configuring the second floor in the second row, and the room icons 502 for the rooms configuring the first floor in the third row. The floor numbers such as 1F, 2F and 3F are shown at the left edge of the respective rows.

In the present embodiment, the room icons 502 are in the form of blocks of the same size, as described above. Therefore, the floor plan 500 can be shared by buildings having different floor plans. Even when the user moves into a building having a different floor plan, the user can continuously use the room icons 502 shown in FIG. 5 by adjusting the correlation between the devices 200 used by the user and the rooms where the devices 200 are to be installed.

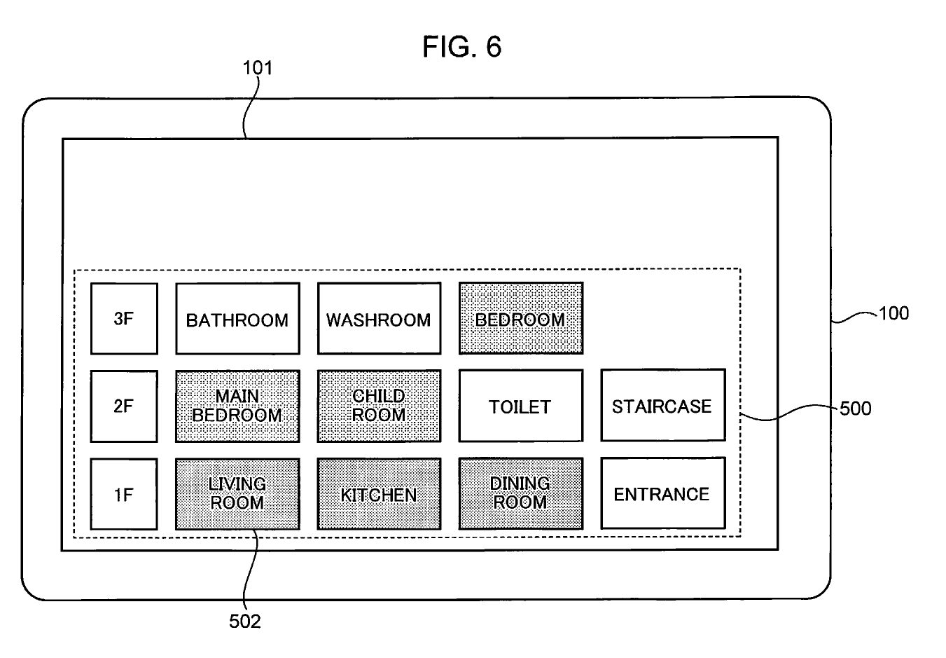

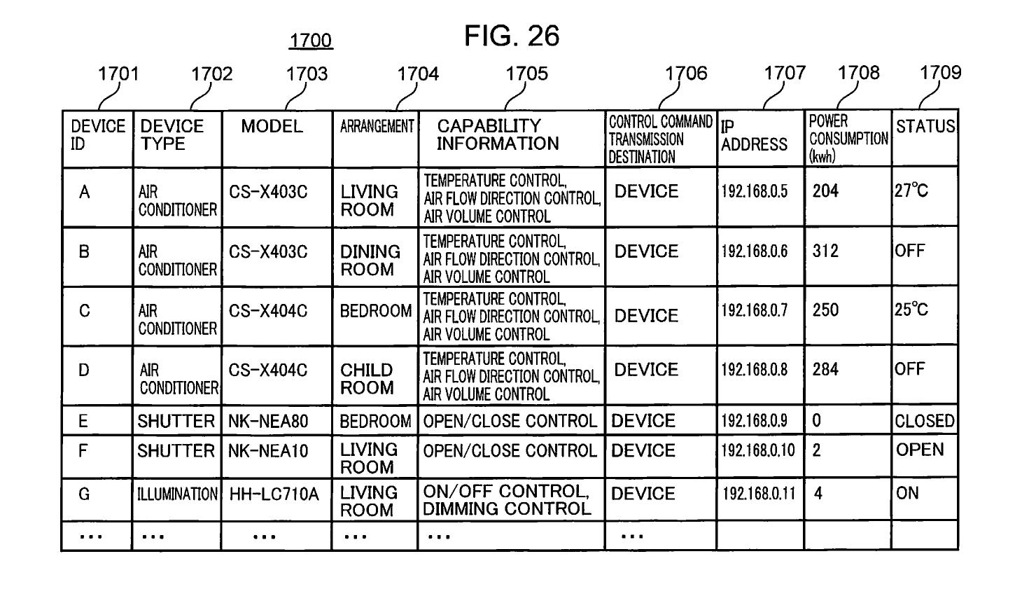

FIG. 6 is a diagram showing another example of the basic screen of the home controller 100. In the basic screen shown in FIG. 6, the display control section 103 displays the room icons 502 in different colors based on a status 1709 of a device list 1700 (FIG. 26) that is described hereinafter, the room icons 502 representing the rooms in which the devices 200 used are installed.

In the example shown in FIG. 6, the display control section 103 displays the room icons 502 for a main bedroom, child room, and bedroom, in different colors (e.g., orange). The display control section 103 also displays the room icons 502 for a living room, kitchen, and dining room, in different colors (e.g., red). Accordingly, among the devices 200 installed in these rooms, the number of devices 200 in use in the living room, kitchen, and dining room is greater than the number of devices 200 in use in the main bedroom, child room, and bedroom.

The display control section 103 also displays the room icons 502 for a bathroom, washroom, toilet, staircase, and entrance in a default color. This indicates that the devices 200 installed in the bathroom, washroom, toilet, staircase, and entrance are not in use.

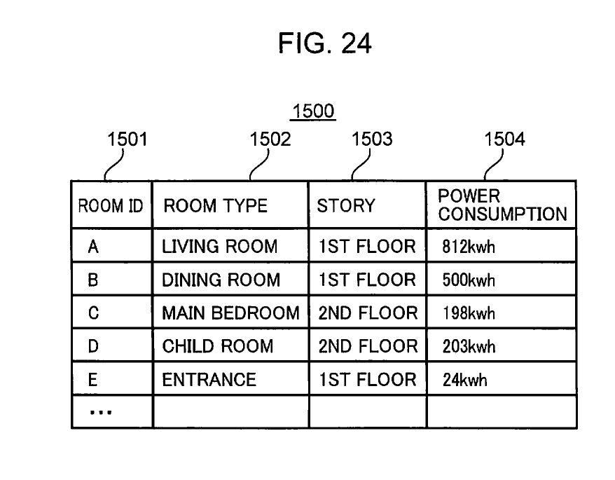

FIG. 7 is a diagram showing yet another example of the basic screen of the home controller 100. In this basic screen shown in FIG. 7, the room icons 502 include display boxes 600 for displaying the power consumption of the rooms respectively. Based on a power consumption 1504 of room information 1500 (FIG. 24) that is described hereinafter, the display control section 103 displays a total of the power consumption of the devices 200 installed in the rooms in each of these display boxes 600.

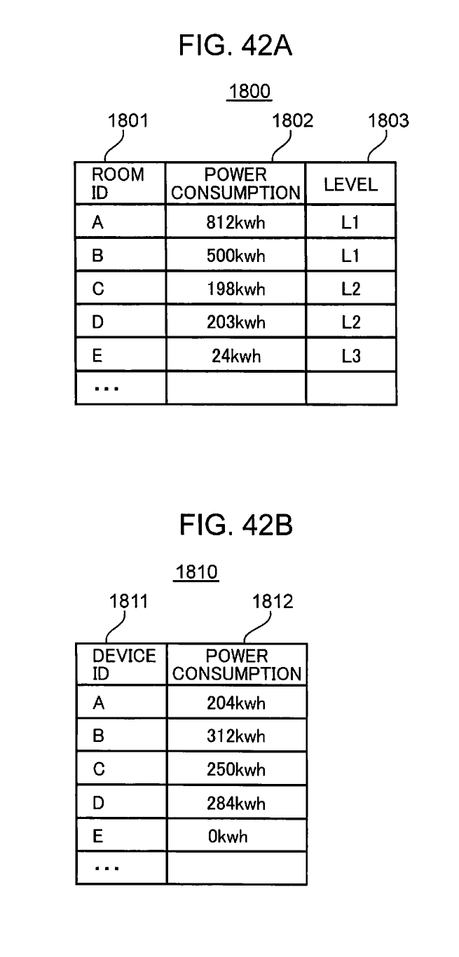

Also in the basic screen shown in FIG. 7, the display control section 103 displays the room icons 502 in different colors based on power consumption information 1800 (FIG. 42A) described hereinafter. In the example shown in FIG. 7, the display control section 103 displays the room icons 502 for the living room, kitchen, and dining room in a different first display color (e.g., red). This indicates that the power consumption of each of the devices 200 installed in the living room, kitchen, and dining room is at a level L1 (TH1≦L1). The threshold TH1 is, for example, 500 kWh.

The display control section 103 also displays the room icons 502 for the main bedroom, child room, and bedroom in a different second display color (e.g., orange). This indicates that the power consumption of each of the devices 200 installed in the main bedroom, child room, and bedroom is at a level L2 (TH2≦L2<TH1). The threshold TH2 is, for example, 100 kWh.

Furthermore, the display control section 103 displays the room icons 502 for the bathroom, washroom, toilet, staircase, and entrance in the default color. This indicates that the power consumption of each of the devices 200 installed in the bathroom, washroom, toilet, staircase, and entrance is at a level L3 (0≦L3<TH2).

The user can see the levels of the power consumptions of the rooms at a glance by changing the display colors of the room icons 502 in accordance with the power consumptions as shown in FIG. 7. Note that the thresholds TH1 and TH2 are equal to each other among the rooms in FIG. 7. Alternatively, the thresholds TH1 and TH2 may be set individually for each of the rooms. For instance, the thresholds TH1 and TH2 of a room having a large number of devices 200 may be increased, and the thresholds TH1 and TH2 of a room having a small number of devices 200 may be reduced.

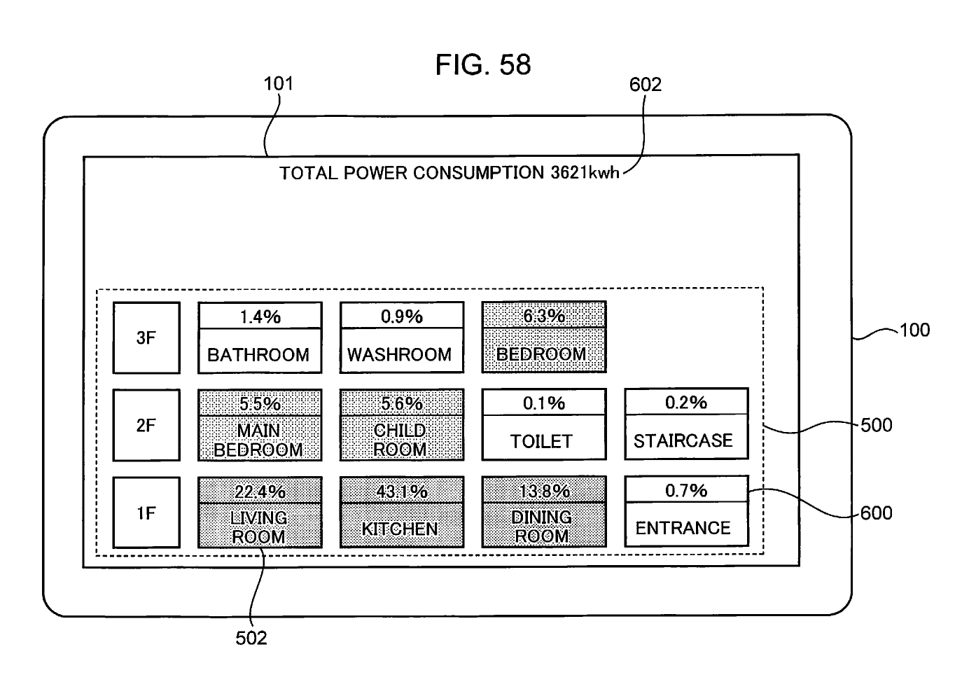

Note that, as shown in FIG. 58, the basic screen displayed on the display 101 may further be provided with a display box 602 for displaying the total power consumption of the house. In the basic screen shown in FIG. 58, the display box 600 of each room icon 502 shows the ratio of the power consumption of the corresponding room to the total power consumption. According to the basic screen shown in FIG. 58, the user can easily. understand the ratio of the power consumption of each room in the house.

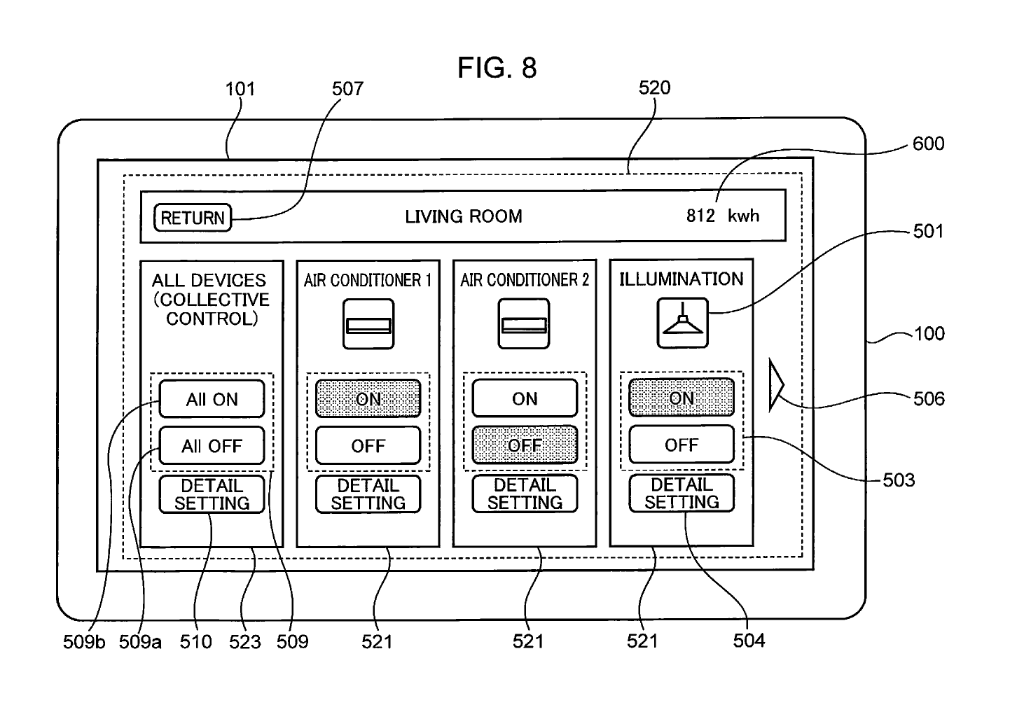

FIG. 8 is a diagram showing an example of a room screen 520 displayed on the display 101 of the home controller 100. In the basic screen shown in FIG. 5, when the user selects one of the room icons 502, the touch panel control section 102 senses this selection. Consequently, the display control section 103 displays the room screen 520 of the room represented by the selected room icon 502 on the display 101. FIG. 8 shows an example in which the room icon 502 representing the living room on the basic screen of FIG. 5 is selected by the user.

The room screen 520 includes the display box 600 for displaying the power consumption of a relevant room, a next page button 506, a return button 507, and operation screens 521, 523. The name or abbreviation of a room (“living room”, in FIG. 8) is written in the upper center of the room screen 520. The display control section 103 displays the power consumption of this room (living room, in FIG. 8) in the display box 600 based on the power consumption 1504 of the room information 1500 (FIG. 24).

When the touch panel control section 102 senses that the next page button 506 is selected by the user, the display control section 103 scrolls through the operation screens 521, 523 and displays on the display 101 the operation screen 521 for controlling the other devices 200 installed in the room.

The operation screen 523 shown at the left edge of FIG. 8 is an operation screen for controlling all the devices 200 installed in the room. This operation screen 523 reads “all devices (collective control)”. This operation screen 523 is described hereinafter.

The operation screens 521 shown to the right of the operation screen 523 are screens operated for controlling the devices 200. The name or abbreviation of a relevant device is written in the upper center of each of the operation screens 521. In FIG. 8, the operation screen 521 to the immediate right of the operation screen 523 is an operation screen for controlling a first air conditioner 201 installed in the room. This operation screen 521 reads “air conditioner 1”.

The second operation screen 521 from the right of FIG. 8 is an operation screen for controlling a second air conditioner 201 installed in the room. This operation screen 521 reads “air conditioner 2”. The operation screen 521 shown at the right edge of FIG. 8 is an operation screen for controlling an illumination device 202 installed in the room. This operation screen 521 reads “illumination”.

Each of the respective operation screens 521 for controlling the first air conditioner 201, the second air conditioner 201, and the illumination device 202 includes a device icon 501, a simple control button 503, and a detail setting button 504. The device icon 501 schematically represents a device 200 relevant thereto. The simple control button 503 is a button for turning the power of the device 200 on or off and thus includes an ON button and an OFF button.

The display control section 103 displays the ON button and the OFF button of the simple control button 503 in different colors in accordance with the status 1709 of the device list 1700 (described in FIG. 26) managed by the device management section 105. FIG. 8 shows that the first air conditioner is operated, that the second air conditioner is stopped, and that the illumination device is on. This allows the user to easily understand the status of each of the devices 200 installed in the room (living room, in FIG. 8).

When the user selects the simple control button 503 of one of the operation screens 521 while the operation screens 521 are displayed as shown in FIG. 8, the touch panel control section 102 senses this selection. Consequently, the device control section 106 generates a control command for controlling the ON/OFF state of the power of the device 200 corresponding to the selected simple control button 503. The device control section 106 transmits the generated control command to the device 200 via the communication control section 107 and the network. In addition, the display control section 103 changes the display states of the ON button and OFF button in response to the user's selection of the simple control button 503.

In FIG. 8, when the user selects the OFF button of the simple control button 503 of the operation screen 521 corresponding to the first air conditioner for example, the touch panel control section 102 senses this selection. Consequently, the device control section 106 generates a control command for stopping the power of the first air conditioner in the living room. The device control section 106 then transmits the generated control command to the first air conditioner in the living room via the communication control section 107 and the network. In addition, the display control section 103 changes the color of the ON button of the simple control button 503 on the operation screen 521 of the first air conditioner back to the default color, and changes the color of the OFF button.

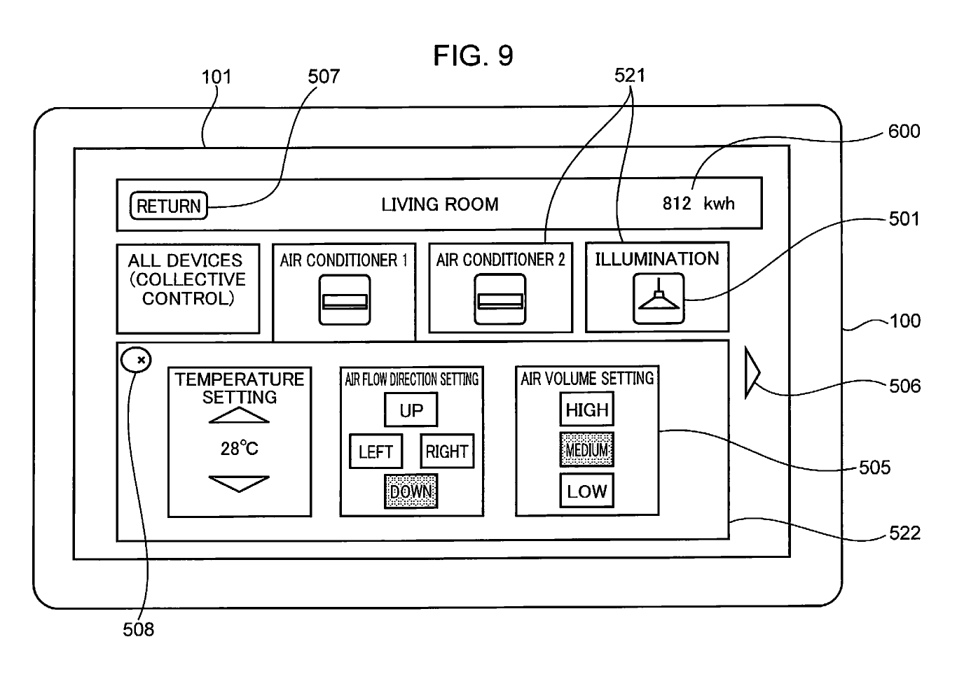

FIG. 9 is a diagram showing an example of a detail control screen 522 displayed on the display 101 of the home controller 100. When the user selects the detail setting button 504 of one of the operation screens 521 while the operation screens 521 are displayed on the display 101 as shown in FIG. 8, the touch panel control section 102 senses this selection. Consequently, the display control section 103 displays on the display 101 the detail control screen 522 of the device 200 corresponding to the selected operation screen 521.

For instance, when the user selects the detail setting button 504 on the operation screen 521 for the first air conditioner shown in FIG. 8, the touch panel control section 102 senses this selection. Consequently, the display control section 103 displays the detail control screen 522 for the first air conditioner on the display 101, as shown in FIG. 9.

As shown in FIG. 9, the detail control screen 522 includes detail control buttons 505 and a close button 508. The detail control buttons 505 are each a button for controlling the state of the device 200 in detail. In FIG. 9, the device 200 is an air conditioner. Therefore, the detail control screen 522 has a detail control button 505 for setting the temperature, a detail control button 505 for setting the wind direction, and a detail control button 505 for setting the air volume.

Furthermore, the display control section 103 controls the display states of the detail control buttons 505 in accordance with the status of the device 200 managed by the device management section 105. As shown in FIG. 9, the temperature of the first air conditioner is set at “28° C.”, the wind direction at “down”, and the air volume at “medium”. This allows the user to easily understand the current detailed status of the first air conditioner.

When the user selects one of the detail control buttons 505 on the detail control screen 522 displayed as shown in FIG. 9, the touch panel control section 102 senses this selection. Consequently, the device control section 106 generates a control command in response to the detail control button 505 selected by the user. The device control section 106 also transmits the generated control command to the first air conditioner in the living room via the communication control section 107 and the network. The display control section 103 changes the display state of the detail control button 505 in response to the user's selection of the detail control button 505.

Moreover, in FIG. 9, when the user selects an upward arrow button of the detail control button 505 for the temperature settings for example, the touch panel control section 102 senses this selection. Consequently, the device control section 106 generates a control command for increasing the set temperature by 1° C. The device control section 106 then transmits the generated control command to the first air conditioner in the living room via the communication control section 107 and the network. The display control section 103 then changes the temperature displayed on the detail control button 505 for the temperature settings to 29° C.

In FIG. 9, when the user selects an “up” button on the detail control button 505 for the wind direction settings for example, the touch panel control section 102 senses this selection. Consequently, the device control section 106 generates a control command for setting the wind direction at an upward direction. The device control section 106 then transmits the generated control command to the first air conditioner in the living room via the communication control section 107 and the network. The display control section 103 changes the color of a “down” button on the detail control button 505 for the wind direction settings back to the default color, and changes the color of the “up” button.

In addition, in FIG. 9, when the user selects a “low” button on, the detail control button 505 for the air volume settings for example, the touch panel control; section 102 senses this selection. Consequently, the device control section 106 generates a control command for lowering the air volume. The device control section 106 then transmits the generated control command to the first air conditioner in the living room via the communication control section 107 and the network. The display control section 103 changes the color of a “medium” button on the detail control button 505 for the air volume settings back to the default color, and changes the color of the “low” button.

Also in FIG. 9, when the user selects the close button 508 for example, the touch panel control section 102 senses this selection. Consequently, the display control section 103 recovers the display state of the display 101 and displays the room screen 520 on the display 101 as shown in FIG. 8.

As shown in FIG. 9, the display control section 103 displays the detail control screen 522 and the operation screen 521 for the first air conditioner in contact with each other. The display control section 103 also displays the operation screen 523 for all the devices, the operation screen 521 for the second air conditioner, and the operation screen 521 for the illumination device in such a manner that they are separated from the detail control screen 522. This display configuration allows the user to easily understand that the detail control screen 522 shown in FIG. 9 is the detail control screen 522 for the first air conditioner.

In the display state shown in FIG. 9, when the user selects an operation screen 521 other than the operation screen 521 for the first air conditioner for example, the touch panel control section 102 senses this selection. Consequently, the display control section 103 displays the detail control screen 522 for the corresponding device 200 on the display 101.

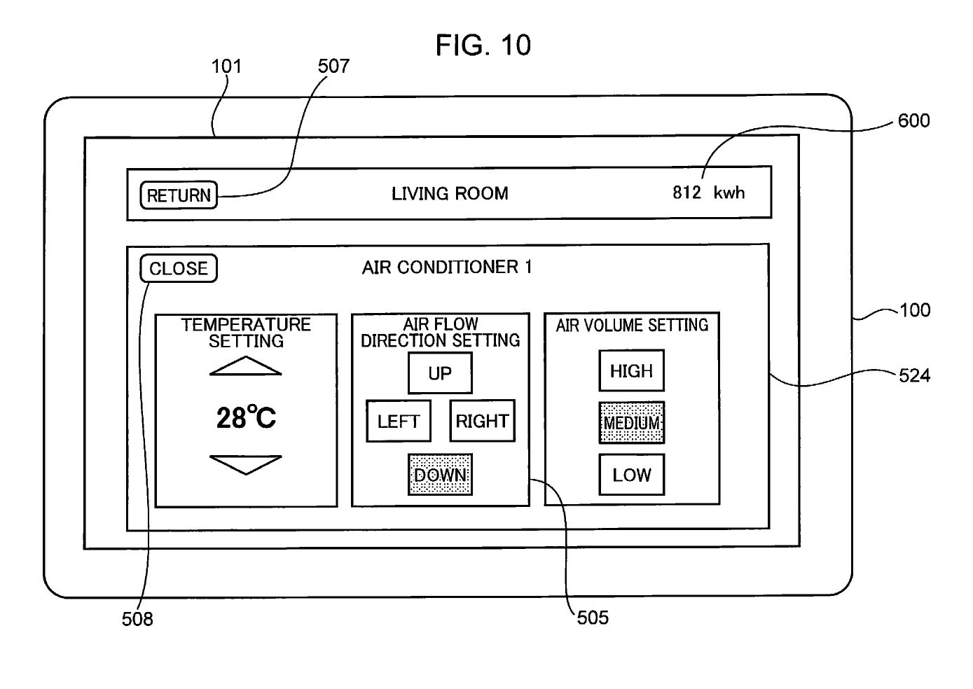

FIG. 10 is a diagram showing another example of the detail control screen displayed on the display 101 of the home controller 100. When the user selects the detail setting button 504 of the operation screen 521 for the first air conditioner, for example, while the operation screens 521 are displayed as shown in FIG. 8, the touch panel control section 102 senses this selection. Consequently, the display control section 103 displays the detail control screen 524 shown in FIG. 10 on the display 101, in place of the operation screen 521.

As with the detail control screen 522 shown in FIG. 9, the detail control screen 524 includes detail control buttons 505 and a close button 508. The name of a relevant device 200 (“air conditioner 1”, representing the first air conditioner, in FIG. 10) is written on the detail control screen 524. The functions of the detail control buttons 505 and close button 508 of the detail control screen 524 are the same as those of the detail control buttons 505 and close button 508 of the detail control screen 522 shown in FIG. 9.

Note that, unlike the detail control screen 522 shown in FIG. 9, the detail control screen 524 shown in FIG. 10 does not have the function of displaying the detail control screens of the other devices on the display 101 unless the user selects the close button 508.

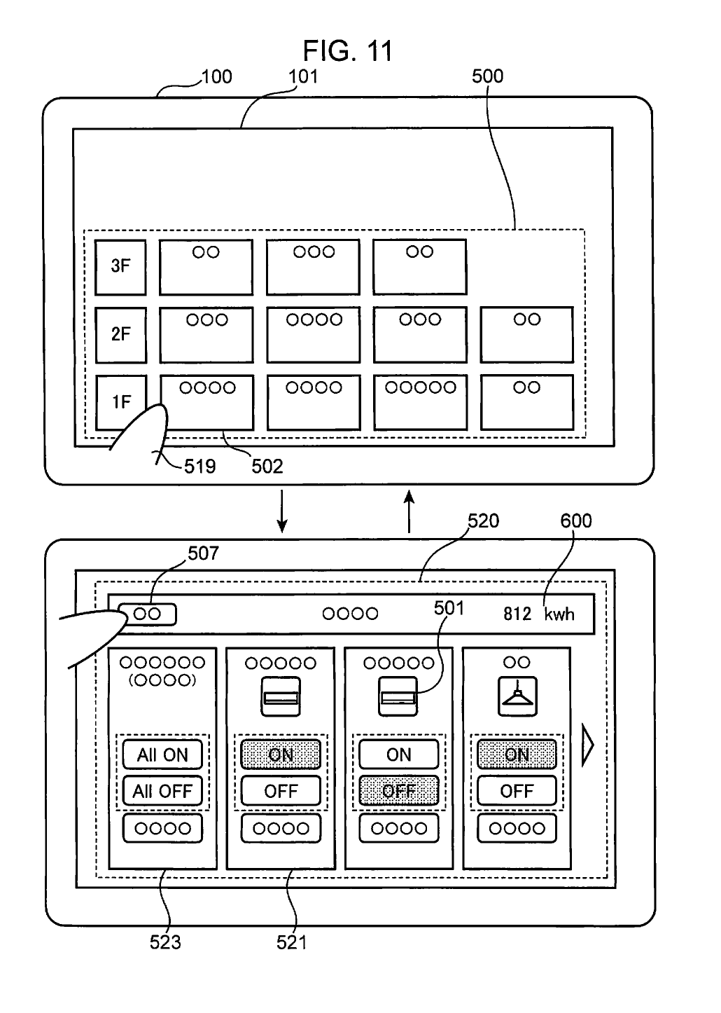

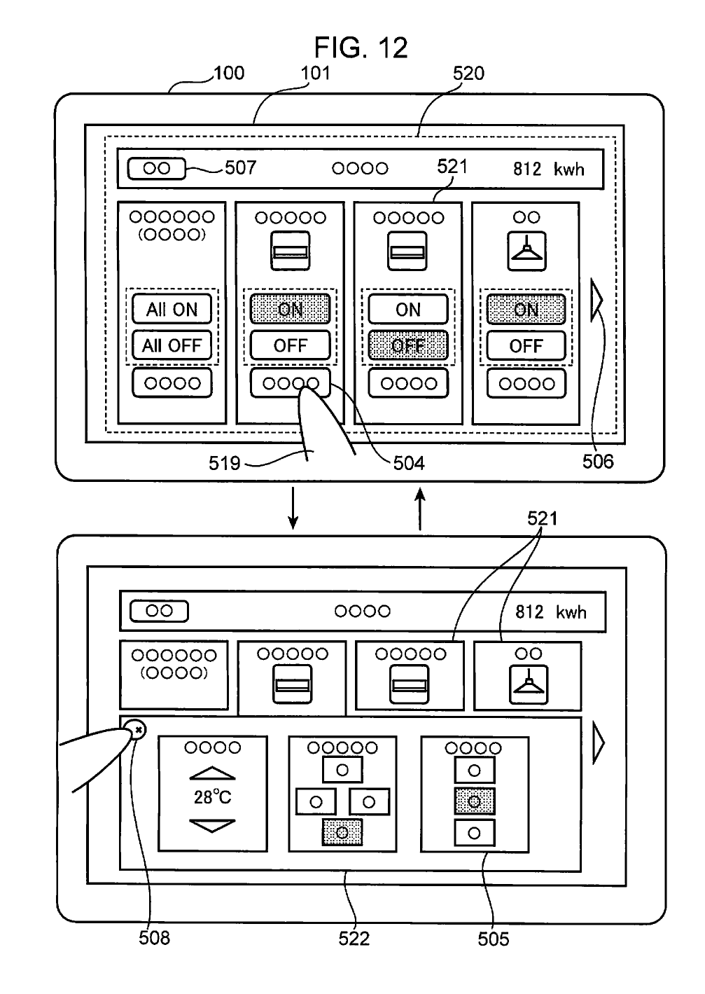

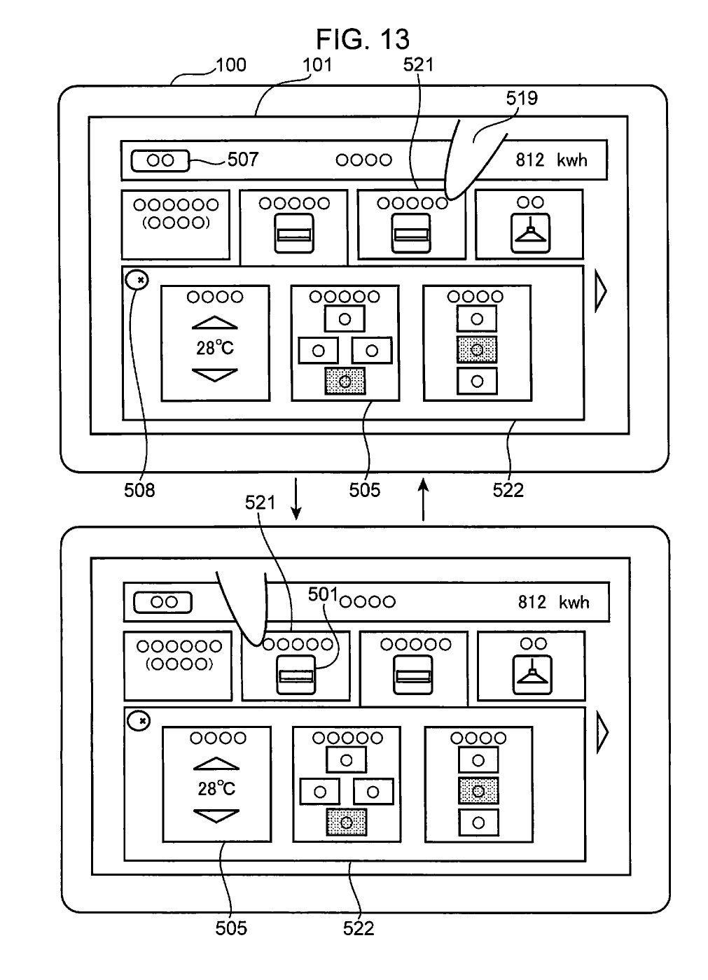

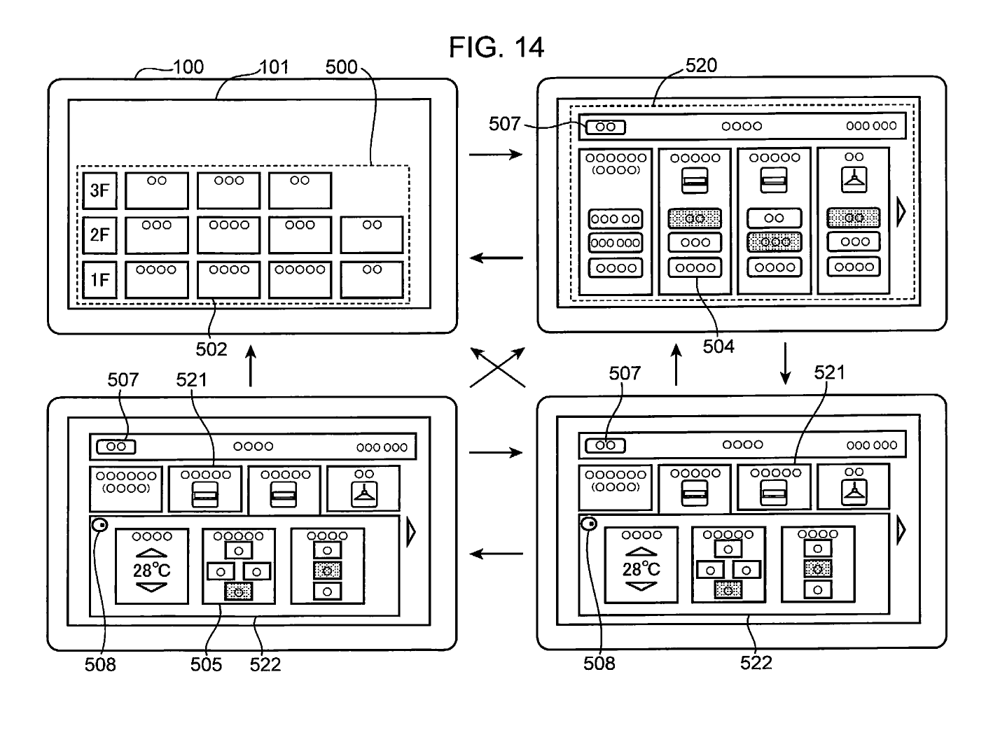

FIGS. 11 to 14 are diagrams each showing an example of transition of a display screen on the display 101 according to the present embodiment. The upper diagram of FIG. 11 is the basic screen shown in FIG. 5. The lower diagram of FIG. 11 is the display screen shown in FIG. 8. The upper diagram of FIG. 12 is the display screen shown in FIG. 8. The lower diagram of FIG. 12 is the display screen shown in FIG. 9. The upper diagram of FIG. 13 is the display screen shown in FIG. 9. The upper left diagram of FIG. 14 is the basic screen shown in FIG. 5. The upper right diagram of FIG. 14 is the display screen shown in FIG. 8. The lower right diagram of FIG. 14 is the display screen shown in FIG. 9. The lower left diagram of FIG. 14 is the display screen shown in the lower diagram of FIG. 13.

On the basic screen shown in the upper diagram of FIG. 11 (the upper left diagram of FIG. 14), when the user uses a contacting object (a finger of the user, for example) 519 to touch the room icon 502 for the room (the living room) in which a device 200 to be controlled is installed, the touch panel control section 102 senses this contact. Consequently, the display control section 103 displays the room screen 520 for the contacted room on the display 101, as shown in the lower diagram of FIG. 11 (the upper right diagram of FIG. 14). As a result, the display state of the basic screen shifts to the display state of the room screen 520.

On the other hand, when the user touches the return button 507 with the contacting object 519 during the display state of the room screen 520 for the living room shown in the lower diagram of FIG. 11 (the upper right diagram of FIG. 14), the touch panel control section 102 senses this contact. Consequently, the display control section 103 displays the basic screen on the display 101, as shown in the upper diagram of FIG. 11 (the upper left diagram of FIG. 14). As a result, the display state of the room screen 520 shifts to the display state of the basic screen.

Next, when the user touches the detail setting button 504 of the operation screen 521 for the first air conditioner with the contacting object 519 during the display state of the room screen 520 shown in the upper diagram of FIG. 12 (the upper right diagram of FIG. 14), the touch panel control section 102 senses this contact. Consequently, the display control section 103 displays the detail control screen 522 of the first air conditioner on the display 101, as shown in the lower diagram of FIG. 12 (the lower right diagram of FIG. 14). As a result, the display state of the room screen 520 shifts to the display state of the detail control screen 522.

When, on the other hand, the user touches the close button 508 with the contacting object 519 during the display state of the detail control screen 522 shown in the lower diagram of FIG. 12 (the lower right diagram of FIG. 14), the touch panel control section 102 senses this contact. Consequently, the display control section 103 displays the room screen 520 on the display 101, as shown in the upper diagram of FIG. 12 (the upper right diagram of FIG. 14). As a result, the display state of the detail control screen 522 shifts to the display state of the room screen 520.

Next, when the user touches the operation screen 521 for the second air conditioner with the contacting object 519 during the display state of the detail control screen 522 for the first air conditioner shown in the upper diagram of FIG. 13 (the lower right diagram of FIG. 14), the touch panel control section 102 senses this contact. Consequently, the display control section 103 displays the detail control screen 522 for the second air conditioner on the display 101, as shown in the lower diagram of FIG. 13 (the lower left diagram of FIG. 14). As a result, the display state of the detail control screen 522 for the first air conditioner shifts to the display state of the detail control screen 522 for the second air conditioner.

When, on the other hand, the user touches the operation screen 521 for the first air conditioner with the contacting object 519 during the display state of the detail control screen 522 for the second air conditioner shown in the lower diagram of FIG. 13 (the lower left diagram of FIG. 14), the touch panel control section 102 senses this contact. Consequently, the display control section 103 displays the detail control screen 522 for the first air conditioner on the display 101, as shown in the upper diagram of FIG. 13 (the lower right diagram of FIG. 14). As a result, the display state of the detail control screen 522 for the second air conditioner shifts to the display state of the detail control screen 522 for the first air conditioner.

Furthermore, on the display screens shown in the lower right and lower left diagrams of FIG. 14, when the user touches the return button 507 with the contacting object 519, the touch panel control section 102 senses this contact. Consequently, the display control section 103 displays the basic screen on the display 101, as shown in the upper left diagram of FIG. 14. As a result, the display state of the detail control screen 522 shifts to the display state of the basic screen.

Also, on the display screen shown in the lower left diagram of FIG. 14, when the user touches the close button 508 with the contacting object 519, the touch panel control section 102 senses this contact. Consequently, the display control section 103 displays the room screen 520 on the display 101, as shown in the upper right diagram of FIG. 14. As a result, the display state of the detail control screen 522 for the second air conditioner shifts to the display state of the room screen 520.

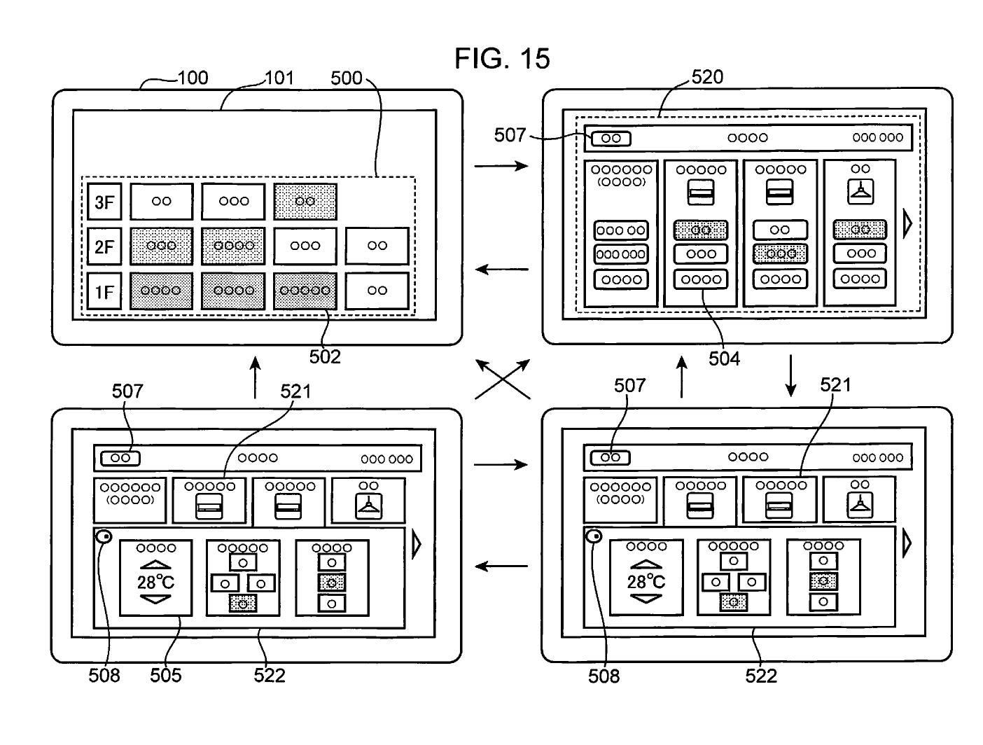

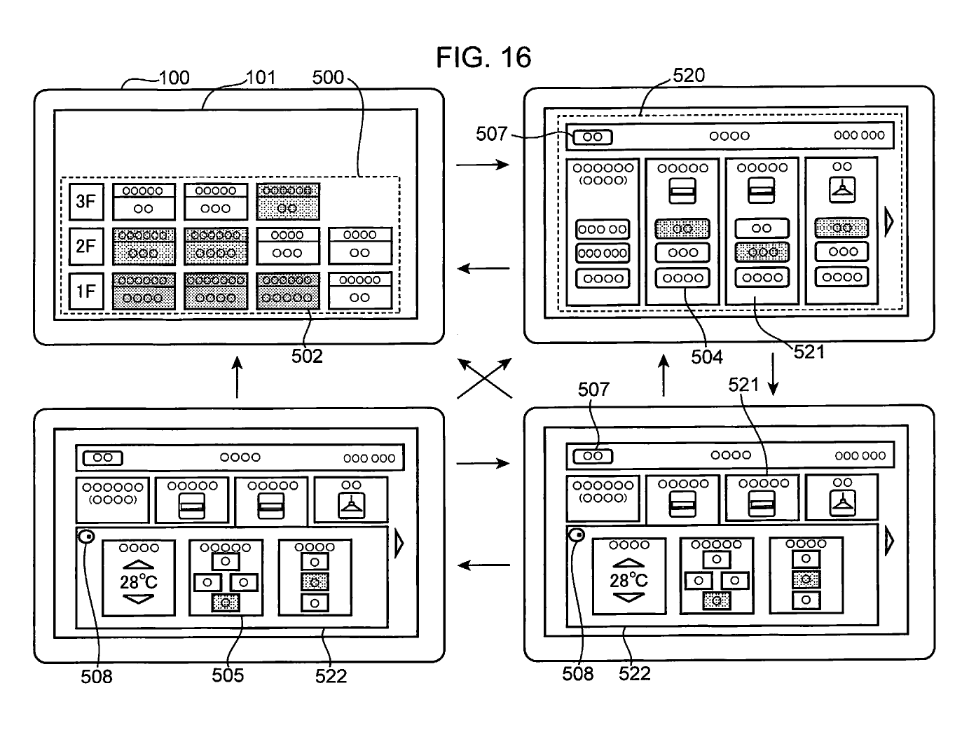

FIGS. 15 and 16 are diagrams each showing another example of transition of the display screen on the display 101 according to the present embodiment. The upper left diagram of FIG. 15 is the basic screen shown in FIG. 6. The upper right, lower right, and lower left diagrams of FIG. 15 are the same as the upper right, lower right, and lower left diagrams of FIG. 14, respectively. The upper left diagram of FIG. 16 is the basic screen shown in FIG. 7. The upper right, lower right, and lower left diagrams of FIG. 16 are the same as the upper right, lower right, and lower left diagrams of FIG. 14, respectively.

The diagrams in FIGS. 15 and 16 are identical with those of FIG. 14, except for the basic screens shown in the upper left diagrams of FIGS. 15 and 16. The display screens shown in FIGS. 15 and 16 shift in the same manner as those shown in FIG. 14.

Returning to FIG. 8, the operation screen 523 for controlling all the devices 200 will be described. This operation screen 523 includes a collective control button 509 and a collective control setting button 510. The collective control button 509 includes a collective OFF button 509a and a collective ON button 509b.

When the user selects the collective OFF button 509a while the room screen 520 is displayed as shown in FIG. 8, the touch panel control section 102 senses this selection. Consequently, the device control section 106 generates a control command for turning off the powers of all the devices 200 in the room (the living room, in FIG. 8). The device control section 106 then transmits the generated control command to all the devices 200 in the living room via the communication control section 107 and the network. The display control section 103 then changes the colors of the OFF buttons of the simple control buttons 503 on all the operation screens 521, and changes the colors of the ON buttons to the default color.

When the user selects the collective ON button 509b while the room screen 520 is displayed as shown in FIG. 8, the touch panel control section 102 senses this selection. Consequently, the device control section 106 generates a control command for turning on the powers of all the devices 200 in the room (the living room, in FIG. 8). The device control section 106 then transmits the generated control command to all the devices 200 in the living room via the communication control section 107 and the network. The display control section 103 changes the colors of the ON buttons of the simple control buttons 503 on all the operation screens 521, and changes the colors of the OFF buttons to the default color.

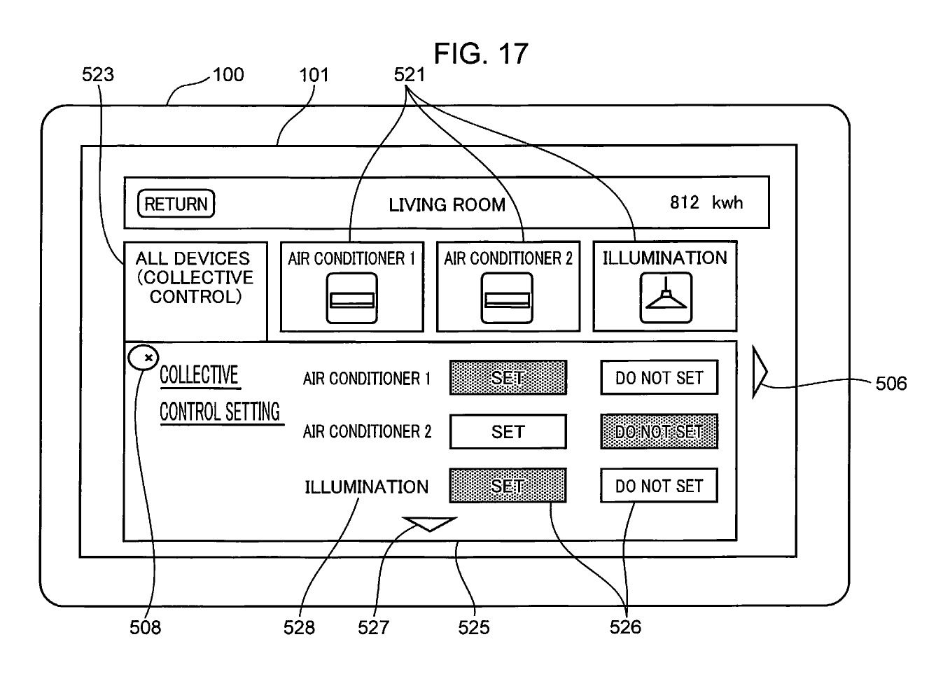

When the user selects the collective control setting button 510 while the room screen 520 is displayed as shown in FIG. 8, the touch panel control section 102 senses this selection. Consequently, the display control section 103 displays on the display 101 a collective control setting screen 525, shown in FIG. 17, as overlapped with the lower half portions of the operation screens 521, 523.

FIG. 17 is a diagram showing an example of the collective control setting screen 525 displayed on the display 101 of the home controller 100. The collective control setting screen 525 includes a setting button 526, a next page button 527, and a device name 528. The setting button 526 includes a “set” button and a “do not set” button. The left edge of the collective control setting screen 525 reads “collective control setting”, clearly stating that this screen is the collective control setting screen 525.

The section to the right of “collective control setting” has the device names 528. In the example shown in FIG. 17, the device names 528 read “air conditioner 1” representing the first air conditioner in the first row, “air conditioner 2” representing the second air conditioner in the second row, and “illumination” representing an illumination device in the third row. The setting buttons 526 are located in association with these device names 528 respectively.

As shown in FIG. 17, the display control section 103 displays the collective control setting screen 525 and the operation screen 523 for all the devices in a contacting manner. The display control section 103 also displays the collective control setting screen 525 and each of the operation screens 521 so as to be separated from each other. This display state allows the user to easily understand that the collective control setting screen 525 shown in FIG. 17 corresponds to the operation screen 523 for all the devices.

When the user selects the “do not set” button of the setting button 526 corresponding to the second air conditioner while the collective control setting screen 525 is displayed for example, the touch panel control section 102 senses this selection. Consequently, the display control section 103 changes the color of the “do not set” button of the setting button 526 corresponding to the second air conditioner, as shown in FIG. 17. In addition, the device control section 106 eliminates the second air conditioner from the control targets of the collective control buttons 509 shown in FIG. 8.

After the second air conditioner is eliminated from the control targets of the collective control buttons 509, the device control section 106 does not generate a control command for turning the power of the second air conditioner off even when the touch panel control section 102 senses the user's selection of the collective OFF button 509a. Similarly, even when the touch panel control section 102 senses the user's selection of the collective ON button 509b, the device control section 106 does not generate a control command for turning the power of the second air conditioner on.

When the touch panel control section 102 senses the user's selection of the next page button 527 while the collective control setting screen 525 is displayed as shown in FIG. 17, the display control section 103 scrolls through the device names 528 and the setting buttons 526, and displays on the display 101 a screen for controlling the settings of the other devices 200 installed in the room.

With the collective control setting screen 525 as described above, a device 200 such as the refrigerator 205 that is disrupted when the power thereof is turned off can be eliminated from the control targets of the collective control button 509.

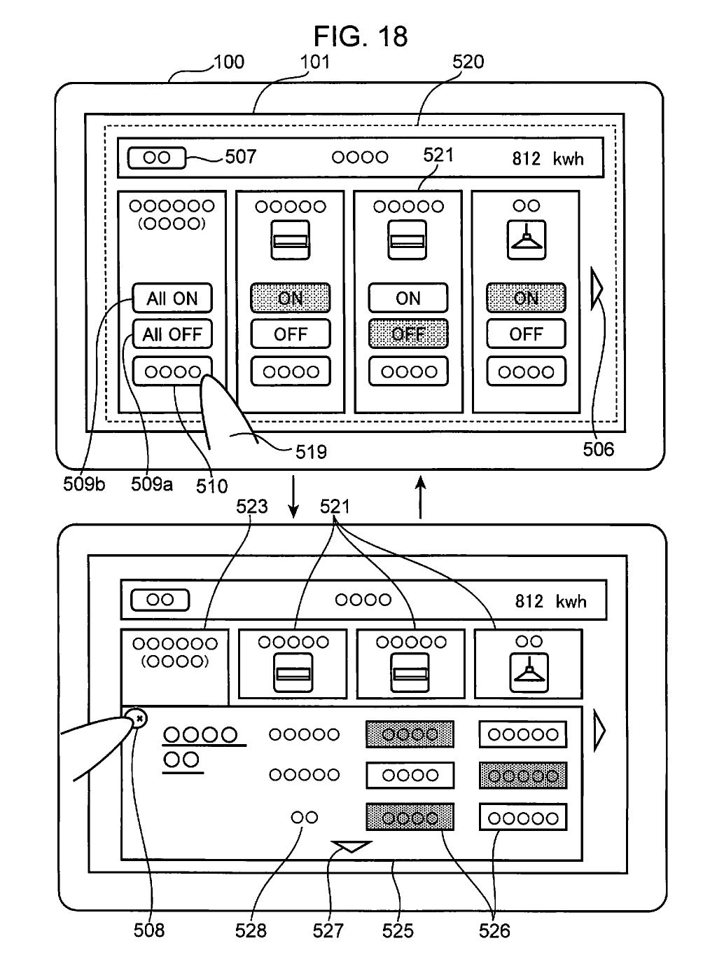

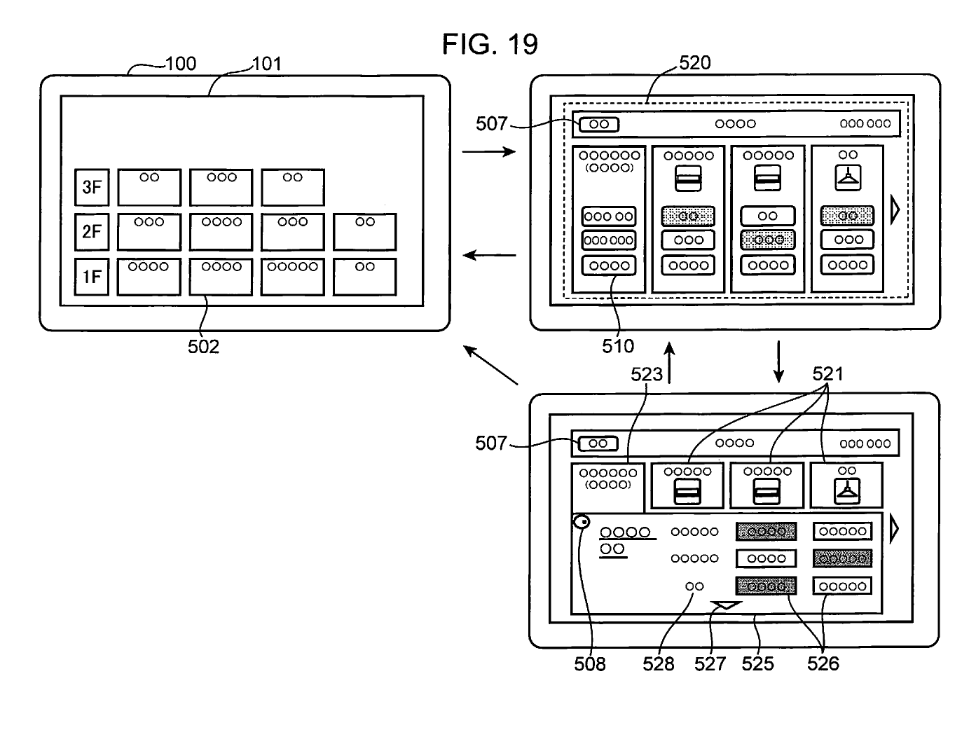

FIGS. 18 and 19 are diagrams each showing an example of transition of the display screen having the collective control setting screen 525, according to the present embodiment. The upper diagram of FIG. 18 is the display screen shown in FIG. 8, and the lower diagram of FIG. 18 is the display screen shown in FIG. 17. The upper left diagram of FIG. 19 is the basic screen shown in FIG. 5. The upper right diagram of FIG. 19 is the display screen shown in FIG. 8. The lower right diagram of FIG. 19 is the display screen shown in FIG. 17.

When the user selects a room icon 502 while the basic screen shown in the upper left diagram of FIG. 19 is displayed on the display 101, the display control section 103 displays the display screen shown in the upper diagram of FIG. 18 (the upper right diagram of FIG. 19) on the display 101. Here, the room screen 520 for the living room shown in FIG. 8 is displayed on the display 101.

When the user touches the collective control setting button 510 with the contacting object 519 while the room screen 520 for the living room shown in the upper diagram of FIG. 18 (the upper right diagram of FIG. 19) is displayed on the display 101, the touch panel control section 102 senses this contact. Consequently, the display control section 103 displays the collective control setting screen 525 on the display 101 as overlapped with the lower half portions of the operation screens 521, 523, as shown in the lower diagram of FIG. 18 (the lower right diagram of FIG. 19). As a result, the display state of the room screen 520 shifts to the display state of the collective control setting screen 525.

On the other hand, when the user touches the close button 508 with the contacting object 519 during the display state of the collective control setting screen 525 shown in the lower diagram of FIG. 18 (the lower right diagram of FIG. 19), the touch panel control section 102 senses this contact. Consequently, the display control section 103 changes the displayed screen back to the original and displays the room screen 520 on the display 101, as shown in the upper diagram of FIG. 18 (the upper right diagram of FIG. 19). As a result, the display state of the collective control setting screen 525 shifts to the display state of the room screen 520.

When the user touches the return button 507 with the contacting object 519 during the display state of the collective control setting screen 525 shown in the lower diagram of FIG. 18 (the lower right diagram of FIG. 19), the touch panel control section 102 senses this contact. Consequently, the display control section 103 changes the displayed screen back to the original and displays the basic screen on the display 101, as shown in the upper left diagram of FIG. 19. As a result, the display state of the collective control setting screen 525 shifts to the display state of the basic screen.

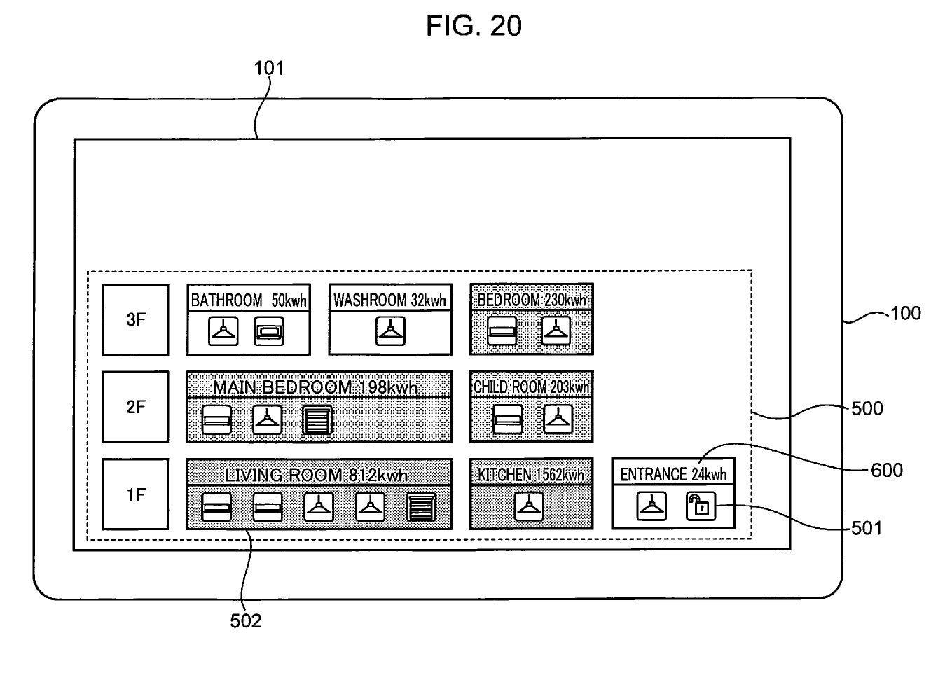

FIG. 20 is a diagram showing yet another example of the basic screen of the home controller 100. On the basic screen shown in FIG. 20, each of the room icons 502 includes a display box 600 for displaying the power consumption of the corresponding room, as with the basic screen shown in FIG. 7.

As with the basic screen shown in FIG. 7, on the basic screen shown in FIG. 20, the display control section 103 displays the room icons 502 in different colors based on the power consumption information 1800 (FIG. 42A), described hereinafter. In the example shown in FIG. 20, the display control section 103 displays the room icons 502 for the bathroom, washroom, and entrance in the default color. The display control section 103 also displays the room icons 502 for the main bedroom, child room, and bedroom in a different color (e.g., orange). The display control section 103 also displays the room icons 502 for the living room and kitchen in a different color (e.g., red).

Unlike the basic screen shown in FIG. 7, on the basic screen shown in FIG. 20, the room icons 502 are shown in different sizes. In other words, the display control section 103 changes the sizes of the square boxes representing the room icons 502 in accordance with the number of devices 200 installed in the rooms. In the example shown in FIG. 20, the sizes of the room icons 502 are classified into two sizes for the room icons 502 for “bathroom”, “washroom”, “bedroom”, “child room”, “kitchen”, and “entrance”, in each of which the number of devices 200 is two or less, and for the room icons 502 for “main bedroom” and “living room”, in each of which the number of devices 200 is three or more.

Furthermore, in the basic screen shown in FIG. 20, the room icons 502 each include a device icon 501. The device icon 501 schematically represents a device 200 relevant thereto. In the example shown in FIG. 20, each of the room icons 502 has as many device icons 501 as the devices 200 installed in the room represented by the corresponding room icon 502.

Note that each of the room icons 502 may have only one device icon 501 representing the relevant device 200. In this case, the device control section 106 may be able to control a plurality of devices 200 simultaneously by operating the single device icon 501 representing the relevant device 200.

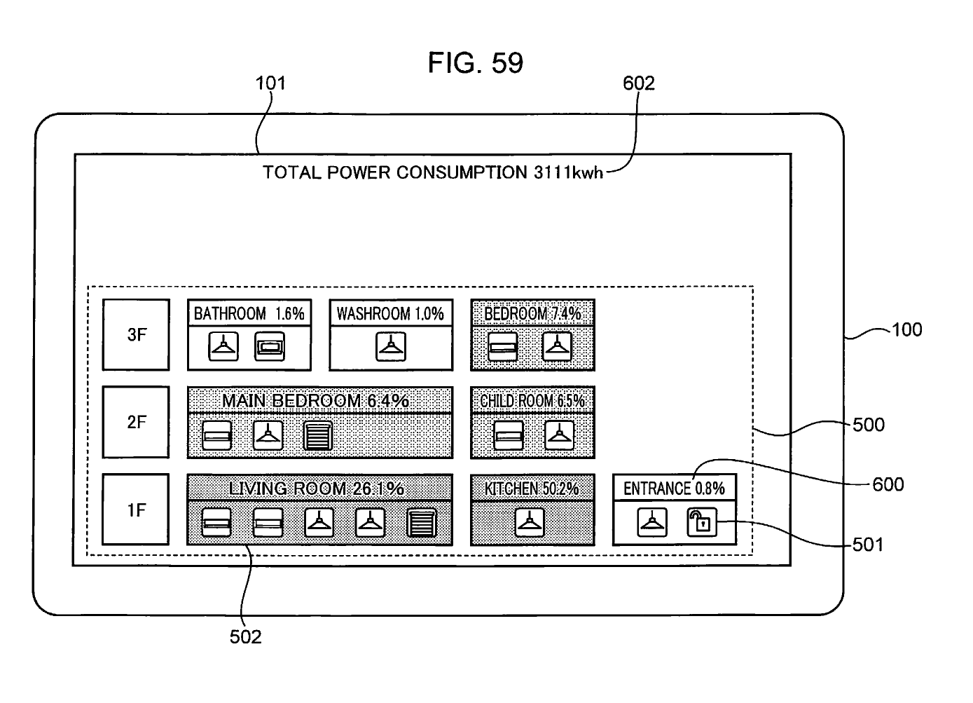

Also, as shown in FIG. 59, the basic screen displayed on the display 101 may further be provided with a display box 602 for displaying a total power consumption of the house. On the basic screen shown in FIG. 59, the display box 600 of each room icon 502 shows the ratio of the power consumption of the corresponding room to the total power consumption. According to the basic screen shown in FIG. 59, the user can easily understand the ratio of the power consumption of each room in the house.

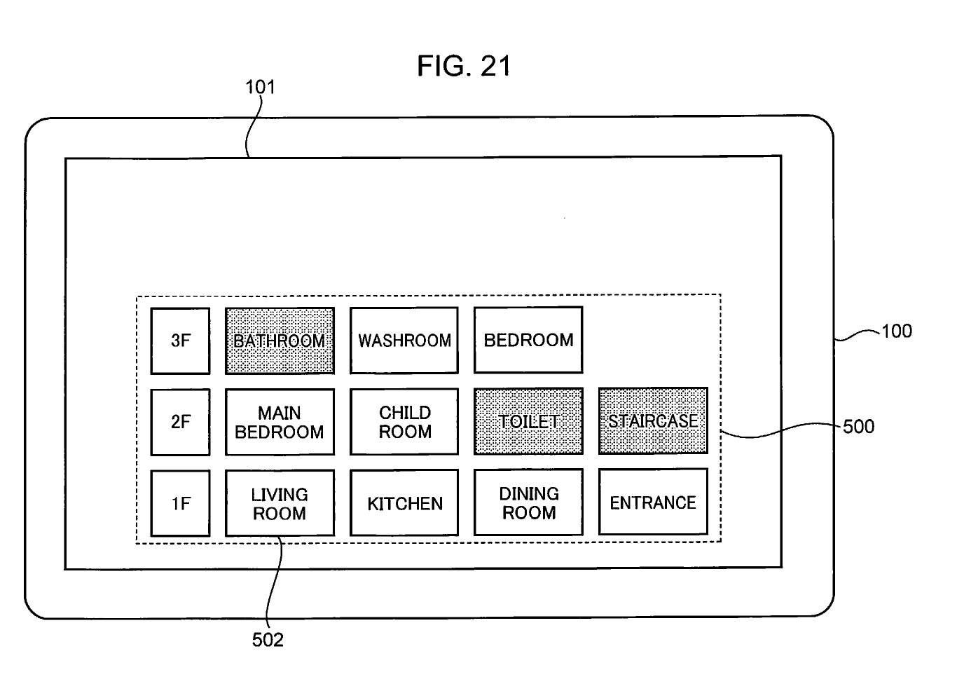

FIG. 21 is a diagram showing yet another example of the basic screen of the home controller 100. On the basic screen shown in FIG. 21, the display control section 103 displays the room icon 502 for a room in which the devices 200 controlled by the home controller 100 are not installed (i.e., a room that only has a device not associated with the home controller 100), in a display state different from those of the other room icons 502, based on the room information 1500 (FIG. 24) and the device list 1700 (FIG. 26).

In FIG. 21, the room icons 502 for “bathroom”, “toilet”, and “staircase” are displayed in a display state (e.g., in gray) different from those of the other room icons 502. This allows the user to easily understand that the devices 200 that can be controlled by the home controller 100 are not installed in “bathroom”, “toilet”, and “staircase”.

The display state shown in FIG. 21 can prevent the user from mistakenly selecting a room icon 502 that corresponds a room in which the devices that can be controlled by the home controller 100 do not exist.

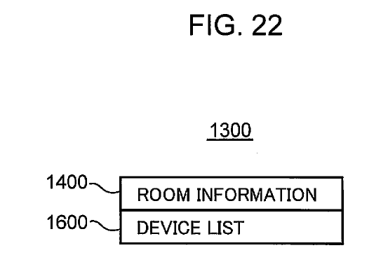

FIG. 22 is a diagram showing the configuration of the home information 1300. The home information 1300 is managed with respect to each house by the server 300. The home controller 100 controls the displaying of the basic screens, room icons 502 and the like based on the home information 1300 acquired from the server 300. As shown in FIG. 22, the home information 1300 has room information 1400 and a device list 1600 managed by the server 300.

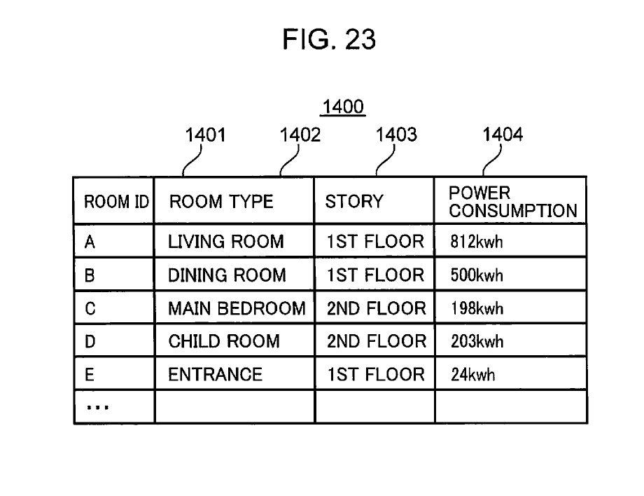

FIG. 23 is a diagram showing the configuration of the room information 1400 managed by the server 300. As shown in FIG. 23, the room information 1400 has a room ID 1401, room type 1402, story 1403, and power consumption 1404. The room ID 1401 is an identifier for identifying each room. The room type 1402 shows the type of each room. The story 1403 indicates which floor a room is on. The power consumption 1404 shows a total power consumption of the devices 200 installed in each room. For instance, FIG. 23 shows that the total power consumption of all the devices 200, including the air conditioner 201 and the illumination device 202, which are installed in the living room, is 812 kwh. A procedure in which the server 300 acquires power consumptions is described hereinafter.

FIG. 24 is a diagram showing the configuration of the room information 1500 managed by the home controller 100. As shown in FIG. 24, the room information 1500 has a room ID 1501, room type 1502, story 1503, and power consumption 1504, as with the room information 1400. The home controller 100 acquires the room information 1400 from the server 300 and manages the acquired room information 1400 as the room information 1500. A procedure in which the home controller 100 acquires power consumptions is described hereinafter.

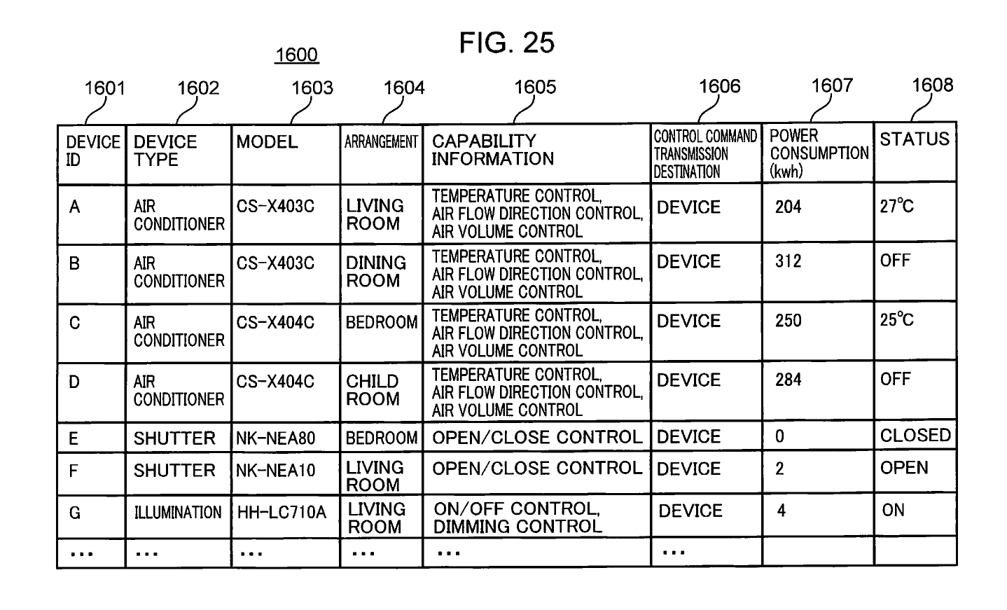

FIG. 25 is a diagram showing the configuration of the device list 1600 managed by the server 300. As shown in FIG. 25, the device list 1600 has a device ID 1601, device type 1602, model 1603, arrangement 1604, capability information 1605, control command transmission destination 1606, power consumption 1607, and status 1608.

The device ID 1601 is an identifier of each device 200. The device type 1602 shows the type of each device 200. The model 1603 shows the model number of each device 200. The arrangement 1604 shows a room in which a device 200 is installed.

The capability information 1605 shows the controllable contents of each device 200 and a state that can be acquired from each device 200. For example, for an air conditioner, the device ID of which is “A”, the temperature, wind direction, and air volume thereof can be controlled. The control command transmission destination 1606 shows a destination of a control command for controlling each device 200. For example, for the air conditioner, the device ID of which is “A”, a control command is transmitted from the home controller 100 directly to this device 200 because the control command transmission destination 1606 is a device. A control command is a command used for operating each device 200 or checking the state of each device 200.

The power consumption 1607 shows the power consumption of each device 200. For example, FIG. 25 shows that the power consumption of the device ID “A” is 204 kwh. The status 1608 shows the current state of each device 200. For example, FIG. 25 shows that the set temperature of the air conditioner with the device ID “A” is 27° C. and that an electric shutter device with a device ID “E” is closed.

Note that the device list 1600 managed by the server may be eliminated from the home information 1300. In this case, the home controller 100 may acquire the information corresponding to the device type 1602, model 1603, and capability information 1605 that are described in the device list 1600 managed by the server, directly from each device 200.

FIG. 26 is a diagram showing the configuration of the device list 1700 managed by the home controller 100. Based on the information of the device list 1700, the home controller 100 places the device icons 501 in the floor plan 500 on the basic screen and controls each device 200.

The device list 1700 has a device ID 1701, device type 1702, model 1703, arrangement 1704, capability information 1705, control command transmission destination 1706, IP address 1707, power consumption 1708, and status 1709. The device ID 1701 to the control command transmission destination 1706, the power consumption 1708, and the status 1709 have the same contents as those shown in FIG. 25.

In the device list 1700, the contents of the device type 1702, model 1703, arrangement 1704, capability information 1705, control command transmission destination 1706, power consumption 1708, and status 1709 can be acquired by causing the device management section 105 to transmit the device list 1600 from the server 300. The IP address 1707 is acquired from each device 200 by the device management section 105. However, when the device type 1702, the model 1703, the capability information 1705, the control command transmission destination 1706, the power consumption 1708, and the status 1709 can be directly acquired from the device 200, the device management section 105 may prioritize such contents.

Note that instead of acquiring the control command transmission destination 1706 from the server 300 or each device 200, contents that are defined in advance in the home control system may be employed, or the control command transmission destination 1706 may be determined automatically based on the state or the like of the network to which the home controller 100 is connected or may be set by the user.

As shown in FIGS. 23 and 24, in the present embodiment, the room information are managed by both the home controller 100 and the server 300. Alternatively, the room information may be managed by either the home controller 100 or the server 300. For example, the room information may be managed by the server 300 alone, and the home controller 100 may acquire the room information from the server 300 if necessary.

Similarly, as shown in FIGS. 25 and 26, in the present embodiment, the device lists are managed by both the home controller 100 and the server 300. Alternatively, the device lists may be managed by either the home controller 100 or the server 300. For example, the device lists may be managed by the server 300 alone, and the home controller 100 may acquire the device lists from the server 300 if necessary. In this case, the IP address 1707 of the device list 1700 managed by the home controller 100 may be managed by the server 300 as well.

Next, a flow in which the home controller 100 controls each device 200 is described with reference to the drawings.

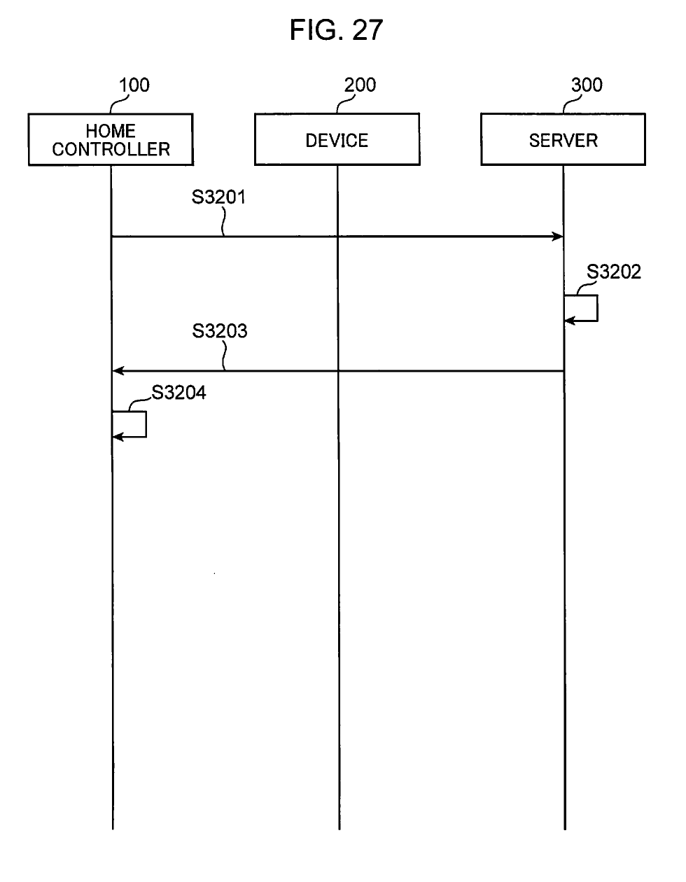

FIG. 27 is a sequence diagram showing a flow of processes in which the home controller 100 acquires the home information 1300 from the server 300. The home controller 100 acquires the home information 1300 from the server 300 at any time, such as when the home controller 100 is used for the first time or activated. Based on the acquired home information 1300, the home controller 100 updates the content displayed on the display 101, such as generation of the basic screen shown in FIG. 5.

First, the device management section 105 of the home controller 100 transmits a home information request to the server 300 (S3201). The home information request includes at least a home controller ID that indicates a user or house that uses the home controller 100. After receiving the home information request, the home information management section 301 of the server 300 searches the storage section 304 for the home information 1300 corresponding to the home controller ID (S3202), and transmits the home information 1300 to the home controller 100 (S3203). The device management section 105 of the home controller 100 stores the home information 1300 received from the server 300 in the storage section 104. Based on the home information 1300, the display control section 103 updates the display screen on the display 101, such as generating the basic screen and displaying the basic screen on the display 101 (S3204).

The update of the display screen on the display 101 includes updates of all kinds of information such as an update of the room icon 502 as a result of a change made to the layout due to renovation or the like, an update of power consumption, registration of a newly installed device 200 and an update of the room icon 502, and an update of a status of the device 200, for example. This description is also applicable to the update of a display screen in other sequence diagrams to be described later.

In addition, the display control section 103, for example, determines a room that does not have a device 200 that can be controlled by the home controller 100, by collating the room information 1400 (FIG. 23) of the home information 1300 (an example of the device information) acquired from the server 300 with the device list 1600 (FIG. 25).

The display control section 103 confirms that a bathroom, toilet, and entrance, for example, exist as the room types 1402 in the room information 1400. The display control section 103 also confirms that a bathroom, toilet, and entrance, for example, are not included as the locations 1604 in the device list 1600. Consequently, the display control section 103 determines that the devices 200 that can be controlled by the home controller 100 are not placed in, for example, the bathroom, toilet, and entrance.

The display control section 103 then displays, on the basic screen shown in FIG. 21, the room icons 502 representing the bathroom, toilet, and entrance where the devices 200 that can be controlled by the home controller 100 are not placed, in a display state (e.g., gray) different from the display state of the other room icons 502.

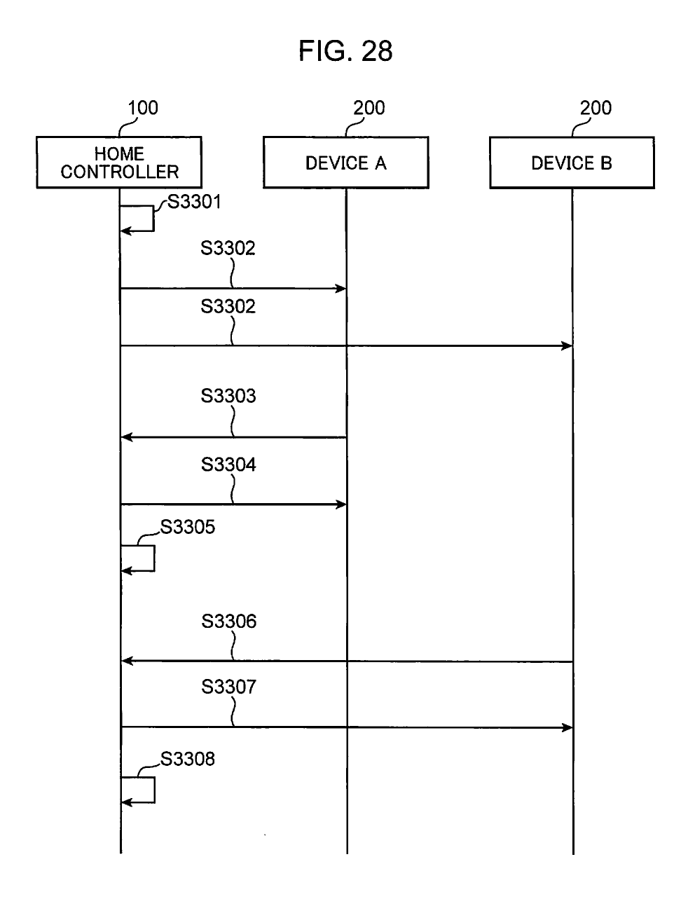

FIG. 28 is a sequence diagram showing a flow of processes in which the home controller 100 senses the devices 200 on the network after being connected to the network. In FIG. 28, a device A 200 with a device ID “A” and a device B 200 with a device ID “B”, which are shown in FIG. 26, are connected to the network.

When the home controller 100 is used for the first time or turned on and is therefore connected to the network (S3301), the device management section 105 of the home controller 100 broadcasts a device search request to all the devices 200 on the network (S3302). Upon reception of the device search request, the device A 200 returns a device search response to the home controller 100 (S3303). Upon reception of the device search response, the home controller 100 acquires the device information from the device A 200 (S3304) and updates the display screen (S3305).

Similarly, upon reception of the device search request, the device B 200 returns a device search response to the home controller 100 (S3306). Upon reception of the device search response, the home controller 100 acquires the device information from the device B 200 (S3307) and updates the display screen (S3308). The device information here means information such as the device type, model number, and capability information of the devices 200. Based on the device information, the device management section 105 of the home controller 100 generates the device list 1700 (see FIG. 26).

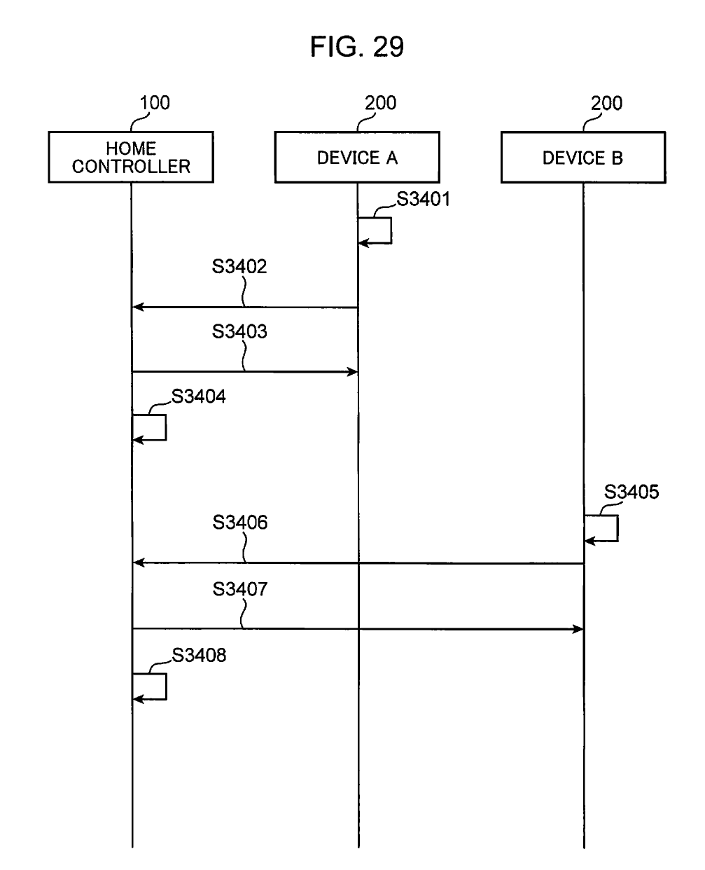

FIG. 29 is a sequence diagram showing a flow of processes in which the home controller 100 senses the devices 200 on the network when the devices 200 are connected to the network. When the device A 200 is used for the first time or turned on and thereby connected to the network (S3401), a network connection notification is broadcasted to all the home controllers 100 on the network (S3402). Upon reception of the network connection notification, the device management sections 105 of the home controllers 100 acquire the device information from the device A 200 (S3403), and the display control sections 103 update the display screens (S3404). The process that is executed when the device B 200 is connected to the network is the same as that of the device A 200 (S3405 to S3408).

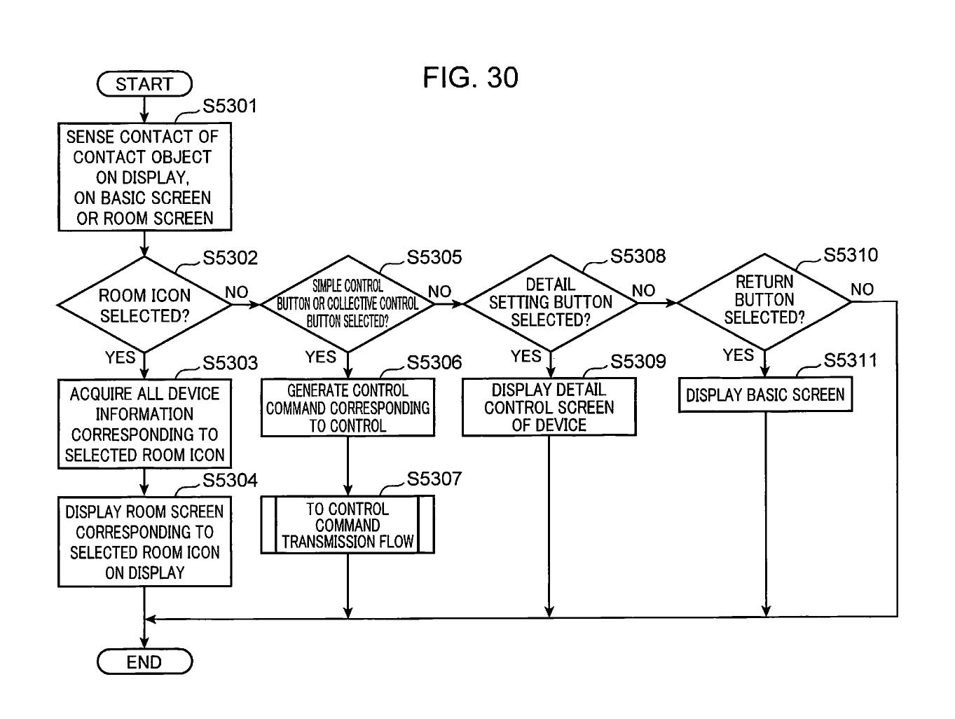

FIG. 30 is a flowchart showing a flow of processes in which the home controller 100 controls the devices 200 when the basic screen (FIG. 5) or the room screen 520 (FIG. 8) is displayed on the display 101 in the embodiment of the present disclosure.

First, the touch panel control section 102 senses that the user touches the basic screen or the room screen 520 on the display 101 with the contacting object 519 (S5301). Next, the touch panel control section 102 judges whether a room icon 502 is selected by the user (S5302). When a room icon 502 is selected by the user (YES in S5302), the display control section 103 acquires all the device information of the devices 200 installed in the room corresponding to the selected room icon 502 (S5303).

Subsequently, based on the acquired device information, the display control section 103 displays the room screen 520 corresponding to the selected room icon 502 on the display 101 (S5304), and then this process is ended.

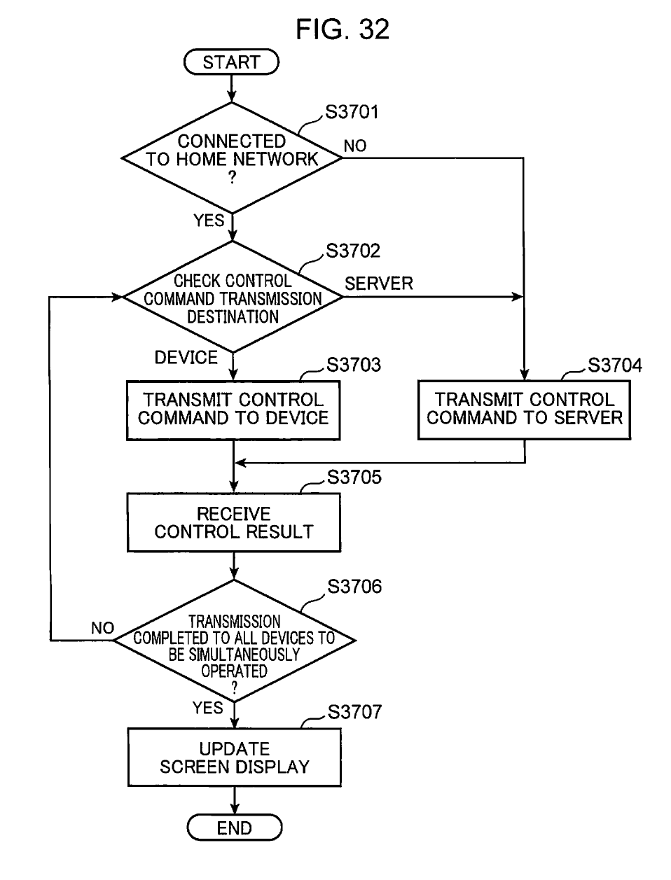

When, on the other hand, it is judged in S5302 that a room icon 502 is not selected by the user (NO in S5302), the touch panel control section 102 judges whether the simple control button 503 or collective control button 509 on the room screen 520 is selected by the user (S5305). When the simple control button 503 or collective control button 509 is selected by the user (YES in S5305), the device control section 106 generates a control command for controlling the selected simple control button 503 or collective control button 509 (S5306). Next, the device control section 106 executes a control command transmission flow (S5307), described hereinafter with reference to FIG. 32, and then this process is ended.

However, when it is judged in S5305 that the simple control button 503 or collective control button 509 is not selected by the user (NO in S5305), the touch panel control section 102 judges whether the detail setting button 504 is selected by the user (S5308). When the detail setting button 504 is selected by the user (YES in S5308), the display control section 103 displays the detail control screen 522 of the device 200 on the display 101 (S5309), and then this process is ended.

When it is judged in S5308 that the detail setting button 504 is not selected by the user (NO in S5308), the touch panel control section 102 judges whether the return button 507 is selected by the user (S5310). When the return button 507 is selected by the user (YES in S5310), the display control section 103 displays the basic screen on the display 101 (S5311), and then this process is ended. However, when it is judged in S5310 that the return button 507 is not selected by the user (NO in S5310), this process is ended.

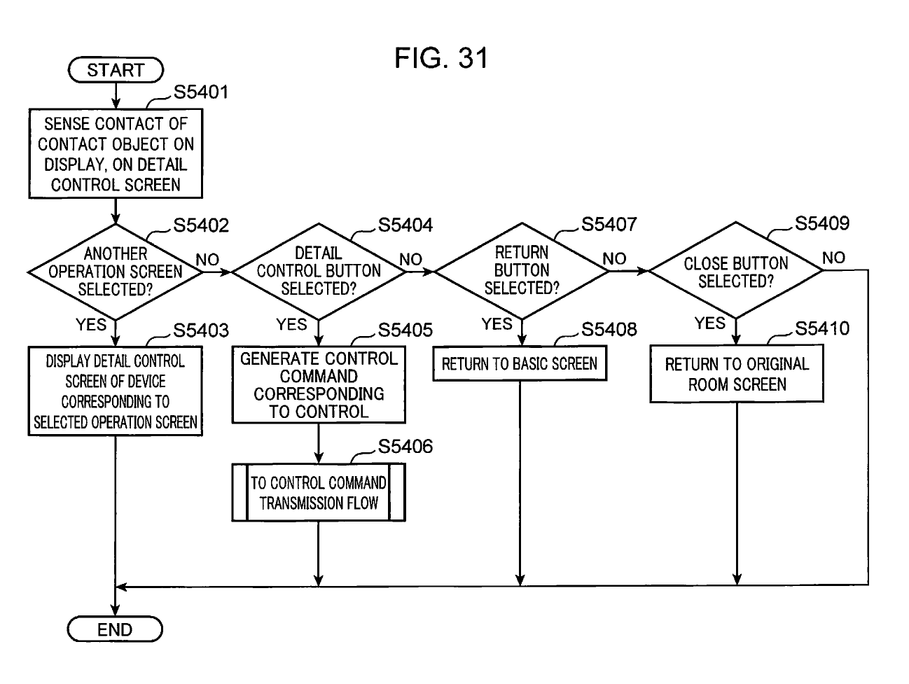

FIG. 31 is a flowchart showing a flow of processes in which the home controller 100 controls the devices 200 when the detail control screen 522 is displayed on the display 101 in the embodiment of the present disclosure.

First, the touch panel control section 102 senses that the user touches the detail control screen 522 on the display 101 with the contacting object 519 (S5401). Next, the touch panel control section 102 judges whether another operation screen 521 is selected by the user (S5402). When another operation screen 521 is selected by the user (YES in S5402), the display control section 103 displays the detail control screen 522 for the device 200 corresponding to the selected operation screen 521 on the display 101 (S5403), and this process is ended.

When, on the other hand, it is judged in S5402 that another operation screen 521 is not selected by the user (NO in S5402), the touch panel control section 102 judges whether the detail control button 505 is selected by the user (S5404). When the detail control button 505 is selected by the user (YES in S5404), the device control section 106 generates a control command for controlling the selected detail control button 505 (S5405). Next, the device control section 106 executes the control command transmission flow (S5406), described hereinafter with reference to FIG. 32, and this process is ended.

However, when it is judged in S5404 that the detail control button 505 is not selected by the user (NO in S5404), the touch panel control section 102 judges whether the return button 507 is selected by the user (S5407). When the return button 507 is selected by the user (YES in S5407), the display control section 103 displays the basic screen on the display 101 (S5408), and this process is ended.

When it is judged in S5407 that the return button 507 is not selected by the user (NO in S5407), the touch panel control section 102 judges whether the close button 508 is selected by the user (S5409). When the close button 508 is selected by the user (YES in S5409), the display control section 103 displays the original room screen 520 on the display 101 (S5410), and this process is ended. However, when it is judged in S5409 that the close button 508 is not selected by the user (NO in S5409), this process is ended.

FIG. 32 is a flowchart showing the details of the control command transmission flow executed in S5307 of FIG. 30 and S5406 of FIG. 31. First, the device control section 106 judges whether the home controller 100 is being connected to the home network (S3701). When the home controller 100 is being connected to the home network (YES in S3701), the device control section 106 checks a transmission destination of a control command based on the content of the control command transmission destination 1706 of the device list 1700 (S3702). The home network here is the network provided in the house of the user. Therefore, in a case where the home controller 100 is operated by the user outside the house, it is judged that the result of S3701 is NO. In a case where the home controller 100 is operated by the user at home, it is judged that the result of S3701 is YES.

When it is judged in S3702 that the control command transmission destination is “device”, the device control section 106 transmits the control command to the relevant device 200 (S3703). However, when it is judged in S3702 that the control command transmission destination is “server”, the device control section 106 transmits the control command to the server 300 (S3704).

For instance, because the control command transmission destination 1706 for an air conditioner is described as “device” in the device list 1700, the device control section 106 transmits a control command to the air conditioner. Moreover, even when it is judged in S3701 that the home controller 100 is not connected to the home network (NO in S3701), the process of S3704 is executed.

In S3705, the device control section 106 receives the control result from the device 200. Next, in a case where transmission of the control command to all the devices 200 that are operated simultaneously is completed (YES in S3706), the device control section 106 advances the process to S3707. However, in a case where transmission of the control command to all the devices 200 that are operated simultaneously is not completed (NO in S3706), the device control section 106 brings the process back to S3702 to repeat the process of S3702 and the subsequent processes.

For example, in a case where two illumination devices are installed in a single room and are set to be operated simultaneously, the device control section 106 transmits a control command to each of these two illumination devices. Note that the result for a device 200 that is not operated together with the other devices 200 simultaneously is not “NO” in S3706.

Thereafter, the display control section 103 updates the screen displayed on the display 101 (S3707). For example, if the set temperature of the air conditioner is changed, the temperature of the air conditioner is displayed in a flashing manner until the set temperature of the air conditioner is changed by a control command. Then, once the set temperature of the air conditioner is changed by the control command, the detail control screen 522 (e.g., FIG. 9) is updated so that the displayed temperature stops flashing. Also, in a case where, for example, the first air conditioner in the living room is turned off, the display control section 103 changes the color of the ON button of the simple control button 503 on the operation screen 521 for the first air conditioner in the room screen 520 of the living room shown in FIG. 8, back to the default color, and changes the color of the OFF button.

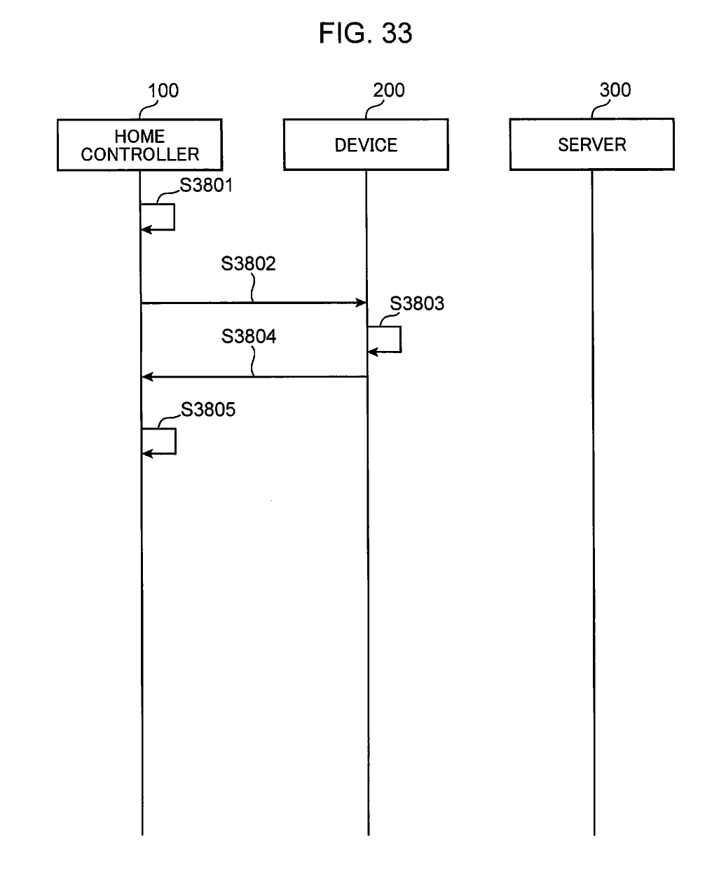

FIG. 33 is a sequence diagram showing a flow of processes in which the home controller 100 directly controls a device 200. First, the touch panel control section 102 of the home controller 100 senses a user operation on the simple control button 503 or detail control screen 522 (S3801). Next, the device control section 106 of the home controller 100 generates a control command corresponding to the user operation and transmits the control command to the device 200 (S3802).

Upon reception of the control command, the device 200 executes the control command (S3803) and transmits a control result to the home controller 100 (S3804). Upon reception of the control result, the display control section 103 of the home controller 100 updates the display screen in accordance with the control result (S3805).

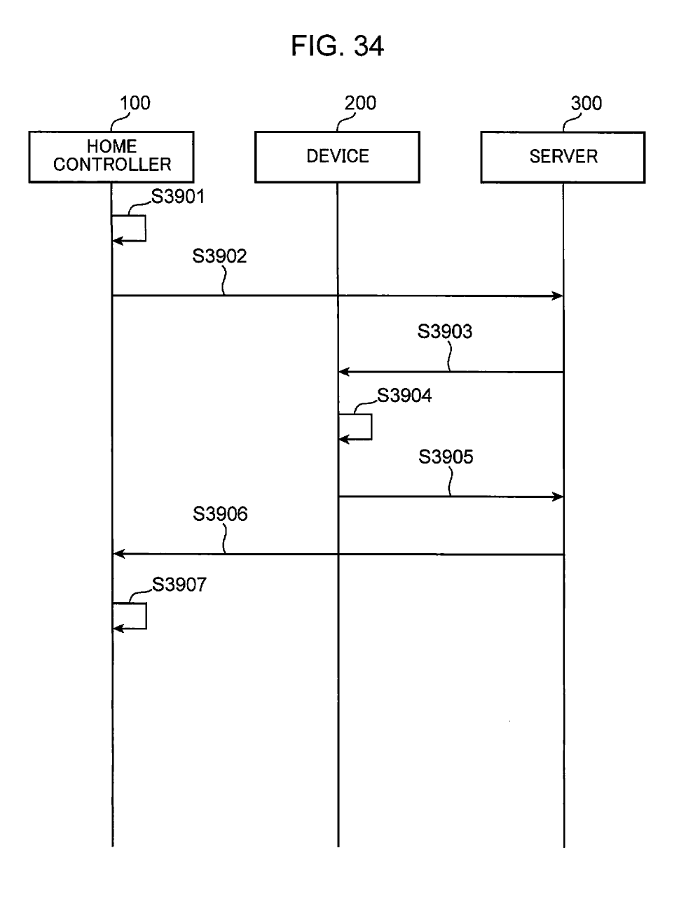

FIG. 34 is a sequence diagram showing a flow of processes in which the home controller 100 controls the device 200 through the server 300. First, the touch panel control section 102 of the home controller 100 senses a user operation on the simple control button 503 or detail control screen 522 (S3901). Next, the device control section 106 of the home controller 100 generates a control command corresponding to the user operation and transmits the control command to the server 300 (S3902).

Upon reception of the control command, the server 300 transmits this control command to the device 200 (S3903). Upon reception of the control command, the device 200 executes the control command (S3904) and transmits a control result to the server 300 (S3905). Upon reception of the control result, the server 300 transmits this control result to the home controller 100 (S3906). Upon reception of the control result, the display control section 103 of the home controller 100 updates the display screen based on the control result (S3907).

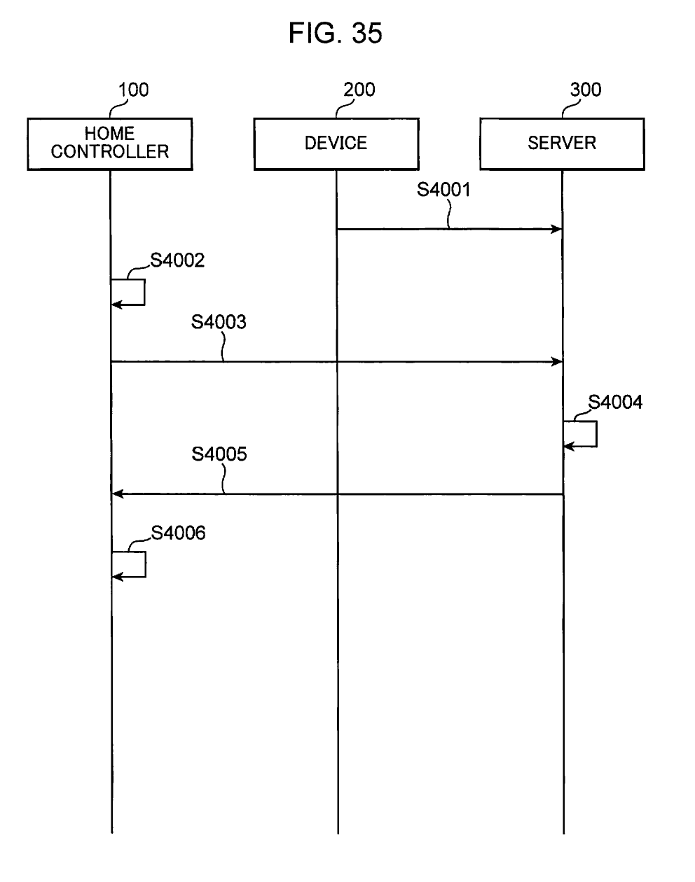

FIG. 35 is a sequence diagram showing a flow of processes in which the home controller 100 acquires the state of a device 200 through the server 300. First, the device 200 transmits a current device state thereof to the server 300 (S4001). In so doing, the device 200 transmits the device state to the server 300 when turned on/off, when the device state thereof is changed, or on a regular basis, and then causes the server 300 to store the device state. Note that the process of S4001 may be executed asynchronously with the processes from S4002 to S4006.

Next, the touch panel control section 102 of the home controller 100 senses a user operation on the simple control button 503 or detail control screen 522 (S4002). Subsequently, the device control section 106 of the home controller 100 generates a control command corresponding to the user operation and transmits the control command to the server 300 (S4003). This control command is generated to confirm the device state of the device 200.

Upon reception of the control command, the server 300 searches for the current device state of the relevant device 200 (S4004), and transmits the device state of this device 200 as a control result to the home controller 100 (S4005). Upon reception of the control result, the display control section 103 of the home controller 100 updates the display screen based on the control result (S4006). For example, when the room screen 520 is displayed on the display 101, the displayed contents of the simple control button 503 on the operation screen 521 on the room screen 520 are updated according to the control result.

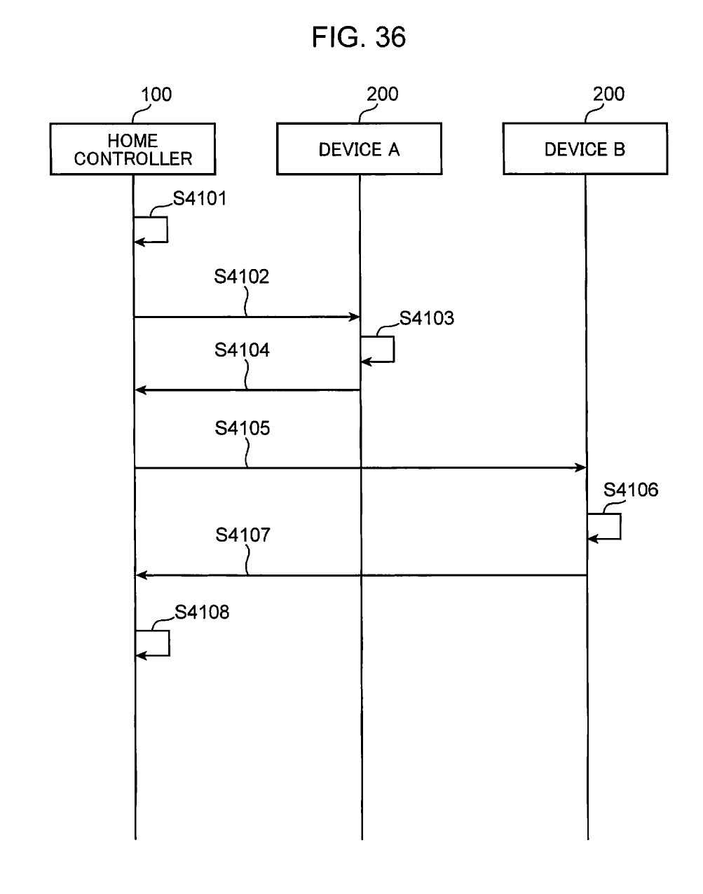

FIG. 36 is a sequence diagram showing a flow of processes in which the home controller 100 directly controls a plurality of devices 200 when controlling the plurality of devices 200 by a single operation. An example in which the home controller 100 controls the device A 200 and the device B 200 is described. The devices A 200, B 200 are installed in a single room and controlled by operating the collective control button 509 of the operation screen 523 on the room screen 520 (FIG. 8).

First, the touch panel control section 102 of the home controller 100 senses a user operation on the collective control button 509 of the operation screen 523 on the room screen 520 (S4101). Next, the device control section 106 of the home controller 100 generates a control command corresponding to the user operation and transmits the control command to the device A 200 (S4102).

Upon reception of the control command, the device A 200 executes the control command (S4103) and transmits a control result to the home controller 100 (S4104).

Next, the device control section 106 of the home controller 100 transmits the same control command as the control command transmitted to the device A 200, to the device B 200 (S4105). Upon reception of the control command, the device B 200 executes the control command (S4106) and transmits a control result to the home controller 100 (S4107).

Upon reception of the control result, the display control section 103 of the home controller 100 updates the display screen based on the control result (S4108). In this case, when the operation screens 521 of the room screens 520 for the devices A 200, B 200 are displayed on the display 101 for example, the displayed contents of the simple control buttons 503 on the operation screens 521 of the devices A 200, B 200 are updated according to the control result.

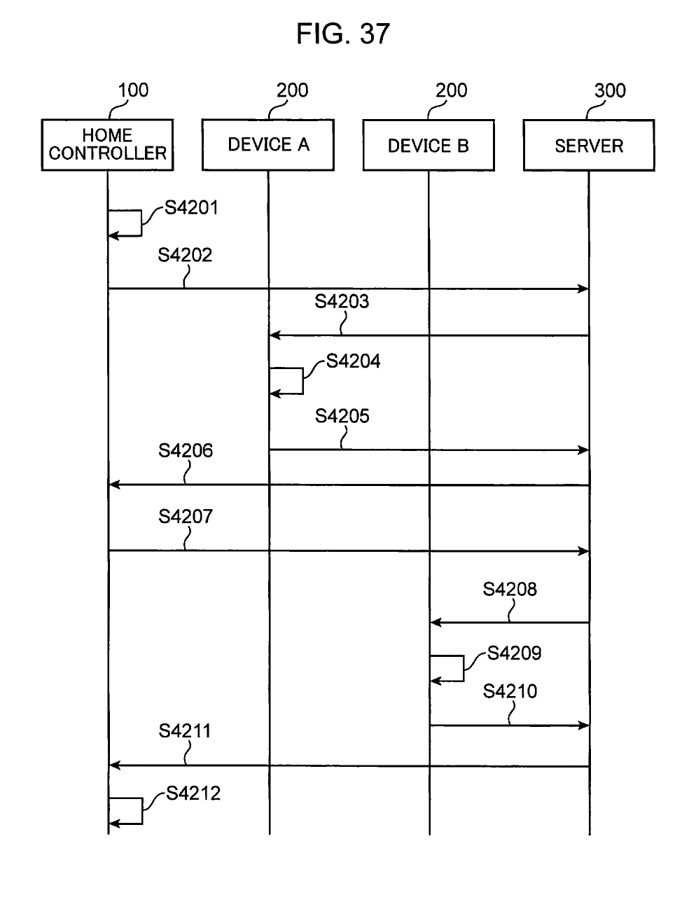

FIG. 37 is a sequence diagram showing a flow of processes in which the home controller 100 controls a plurality of devices 200 through the server 300 when controlling the plurality of devices 200 by a single operation. An example in which the home controller 100 controls the device A 200 and the device B 200 is described. The devices A 200, B 200 are installed in a single room and controlled by operating the collective control button 509 of the operation screen 523 on the room screen 520 (FIG. 8).

First, the touch panel control section 102 of the home controller 100 senses a user operation on the collective control button 509 of the operation screen 523 on the room screen 520 (S4201).

Next, the device control section 106 of the home controller 100 generates a control command of the device A 200 corresponding to the user operation and transmits the control command to the server 300 (S4202).

Upon reception of the control command of the device A 200, the server 300 transmits the control command to the device A 200 (S4203). Upon reception of the control command, the device A 200 executes the control command (S4204) and transmits a control result to the server 300 (S4205). Upon reception of the control result, the server 300 transmits this control result to the home controller 100 (S4206).

Similarly, the device control section 106 of the home controller 100 generates a control command of the device B 200 corresponding to a user operation thereon and transmits the control command to the server 300 (S4207).

Upon reception of the control command, the server 300 transmits the control command to the device B 200 (S4208). Upon reception of the control command, the device B 200 executes the control command (S4209) and transmits a control result to the server 300 (S4210). Upon reception of the control result, the server 300 transmits this control result to the home controller 100 (S4211).

Then, the display control section 103 of the home controller 100 updates the display screen based on the control result (S4212).

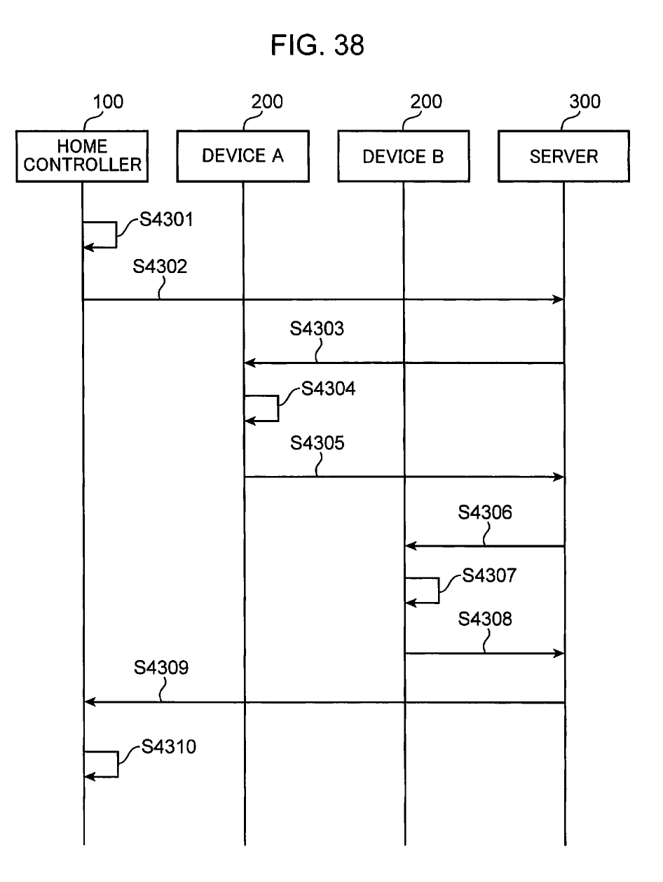

FIG. 38 is a sequence diagram showing a flow of processes in which the home controller 100 controls a plurality of devices 200 through the server 300 when controlling the plurality of devices 200 by a single operation. An example in which the home controller 100 controls the device A 200 and the device B 200 is described. The devices A 200, B 200 are installed in a single room and controlled by operating the collective control button 509 of the operation screen 523 in the room screen 520 (FIG. 8).

First, the touch panel control section 102 of the home controller 100 senses a user operation on the collective control button 509 on the operation screen 523 on the room screen 520 (S4301).

Next, the device control section 106 of the home controller 100 generates a control command of the devices A 200, B 200 in response to the user operation and transmits the control command to the server 300 (S4302).

Upon reception of the control command, the server 300 transmits the control command to the device A 200 (S4303). Upon reception of the control command, the device A 200 executes the control command (S4304) and transmits a control result to the server 300 (S4305).

Similarly, the server 300 transmits the control command to the device B 200 (S4306). Upon reception of the control command, the device B 200 executes the control command (S4307) and transmits a control result to the server 300 (S4308). Upon reception of the control results of the device A 200 and the device B 200, the server 300 transmits the control results to the home controller 100 (S4309).

Then, the display control section 103 of the home controller 100 updates the display screen based on the control results (S4310).

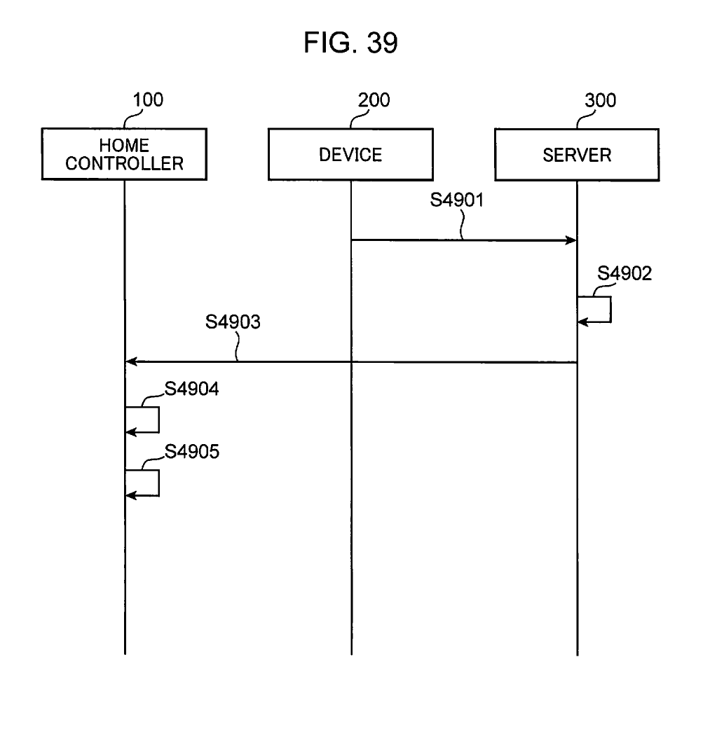

FIG. 39 is a sequence diagram showing an example of a process for updating the device lists of the home controller 100 and server 300. A device 200 transmits its own current device state to the sever 300 (S4901). The device 200 may transmit the device state thereof on a regular basis or when the state is changed. The server 300 updates the device list 1600 in accordance with the content of the received device state (S4902). In a case where the information on the device 200 does not exist in the device list 1600, the server 300 adds the information on the device 200 as a new device. The server 300 then transmits a device list update notification to the home controller 100 (S4903).

The device management section 105 of the home controller 100 updates the device list 1700 in accordance with the content of the received device list update notification (S4904). In a case where the information on the device 200 does not exist in the device list 1700, the device management section 105 adds the information on the device 200 as a new device. Consequently, the display control section 103 of the home controller 100 updates the display screen (S4905). When the information on a new device 200 is added for example, the update of the display screen includes updating the room screen 520 corresponding to the room in which the new device 200 is installed, and updating status display executed through the use of the simple control button 503 of the operation screen 521 on the room screen 520, and the like.

When the state of the device 200 is changed, the server 300 is notified of this change in the state, as described above. This allows the server 300 to monitor the changes in the state of the device 200. In addition, the server 300, after receiving the device state from the device 200, notifies the home controller 100 of the change of the state. Accordingly, the home controller 100 can recognize the current state of the device 200. Furthermore, in a case where the new device 200 is connected to the home network, the server 300 and the home controller 100 can add information on the new device, preventing the difference between the actual state of the device 200 and the state of the device 200 recognized by the home controller 100.

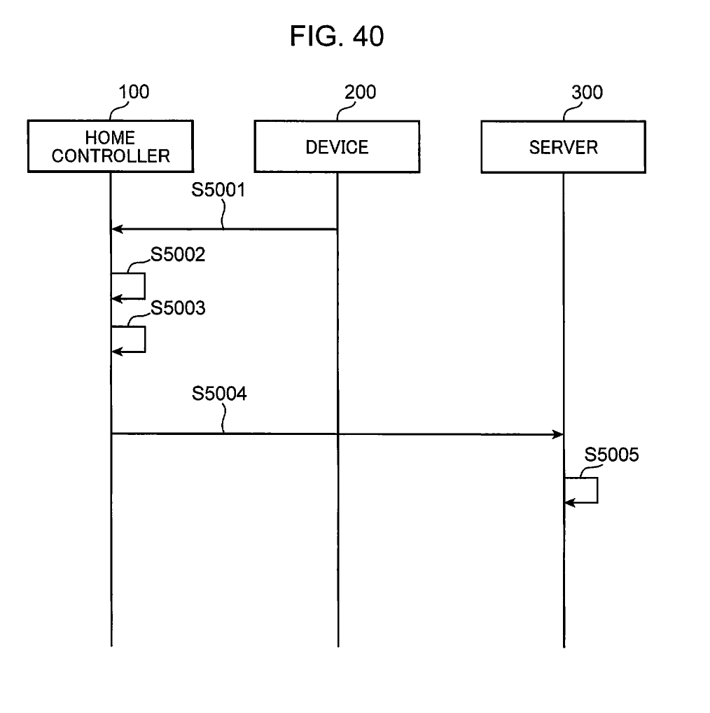

FIG. 40 is a sequence diagram showing another example of the process for updating the device lists of the home controller 100 and server 300. A device 200 transmits the device state thereof to the home controller 100 (S5001). The device 200 may transmit the device state thereof on a regular basis or when the state is changed.

The device management section 105 of the home controller 100 updates the device list 1700 in accordance with the content of the received device state (S5002). In a case where the information on the device 200 does not exist in the device list 1700, the device management section 105 adds the information on the device 200 as a new device. Consequently, the display control section 103 updates the display screen (S5003).

Next, the device management section 105 of the home controller 100 transmits a device list update notification to the server 300 (S5004). The server 300 updates the device list 1600 in accordance with the received device list update notification (S5005). In a case where the information on the device 200 does not exist in the device list 1600, the server 300 adds the information on the device 200 as a new device.

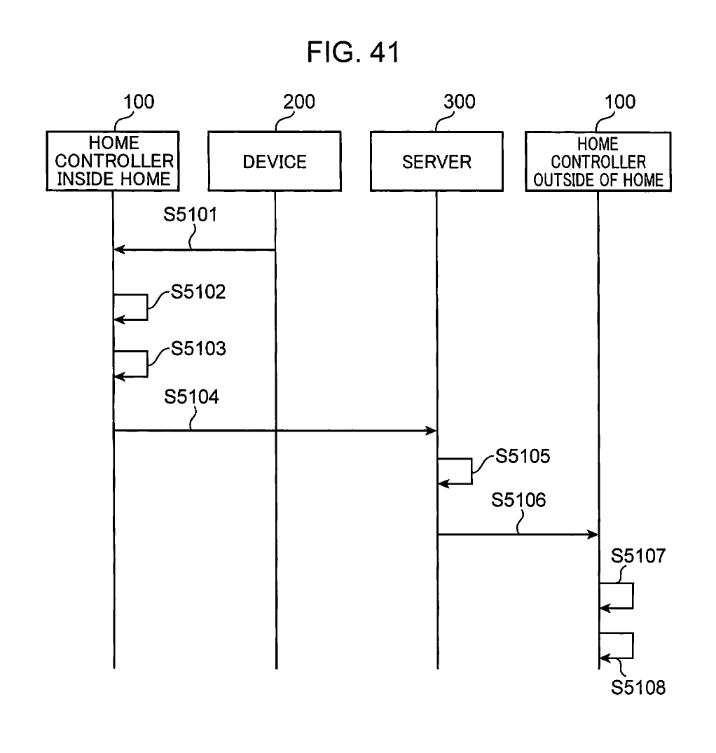

FIG. 41 is a sequence diagram showing yet another example of the process for updating the device lists of the home controller 100 and server 300. FIG. 41 illustrates an example in which the user possesses two home controllers 100: a home controller 100 for use at home and a home controller 100 for outside the home. The home controller 100 for outside the house is a home controller 100 that is taken out by the user to wherever the user has gone to, whereas the home controller 100 for use at home is a home controller 100 that the user leaves in the house.

A device 200 transmits the device state thereof to the home controller 100 for use at home (S5101). The home controller 100 for use at home updates the device list 1700 in accordance with the content of the received device state (S5102). In a case where the information on the device 200 does not exist in the device list 1700, the device management section 105 adds the information on the device 200 as a new device. Consequently, the display control section 103 of the home controller 100 for use at home updates the display screen (S5103). The home controller 100 for use at home transmits a device list update notification to the server 300 (S5104).

The server 300 updates the device list 1600 in accordance with the content of the received device list update notification (S5105). In a case where the information on the device 200 does not exist in the device list 1600, the server 300 adds the information on the device 200 as a new device. The server 300 then transmits a device list update notification to the home controller 100 for outside the house (S5106).

The home controller 100 for outside the house updates the device list 1700 in accordance with the content of the received device list update notification (S5107). In a case where the information on the device 200 does not exist in the device list 1700, the device management section 105 of the home controller 100 for outside the house adds the information on the device 200 as a new device. Consequently, the display control section 103 of the home controller 100 for outside the house updates the display screen (S5108).

According to this example, even when one of the home controllers 100 is located outside the house and the other home controller 100 inside the house, the states of the device 200 recognized by both of the home controllers 100 can be prevented from differing from each other.

Note that the sequences and process flows described above are merely exemplary, wherein the order of the steps may be changed or some of the steps may be omitted so long as the intended processes can be realized. For instance, the control commands corresponding to the device A 200 and the device B 200 may be transmitted asynchronously.

FIGS. 42A and 42B are diagrams each showing the configuration of power consumption information transmitted by the home controller 100 or the server 300. The power consumption information 1800 shown in FIG. 42A has a room ID 1801, power consumption 1802, and level 1803. Power consumption information 1810 shown in FIG. 42B has a device ID 1811 and power consumption 1812.

The home controller 100 or the server 300 generates the level 1803 based on the power consumption 1802. The level 1803 represents the level of power consumption. The level L1 is equal to or greater than TH1, i.e., TH1≦L1. The threshold TH1 is, for example 500 kWh. The level L2 is equal to or greater than TH2 but less than TH1, i.e., TH2≦L2<TH1. The threshold TH2 is, for example, 100 kWh. The level L3 is equal to or greater than 0 but less than TH2, i.e., 0≦L3<TH2.

In the present embodiment, the home controller 100 or the server 300 transmits both the power consumption information 1800 shown in FIG. 42A and the power consumption information 1810 shown in FIG. 42B. The threshold TH1 corresponds to an example of the reference value.

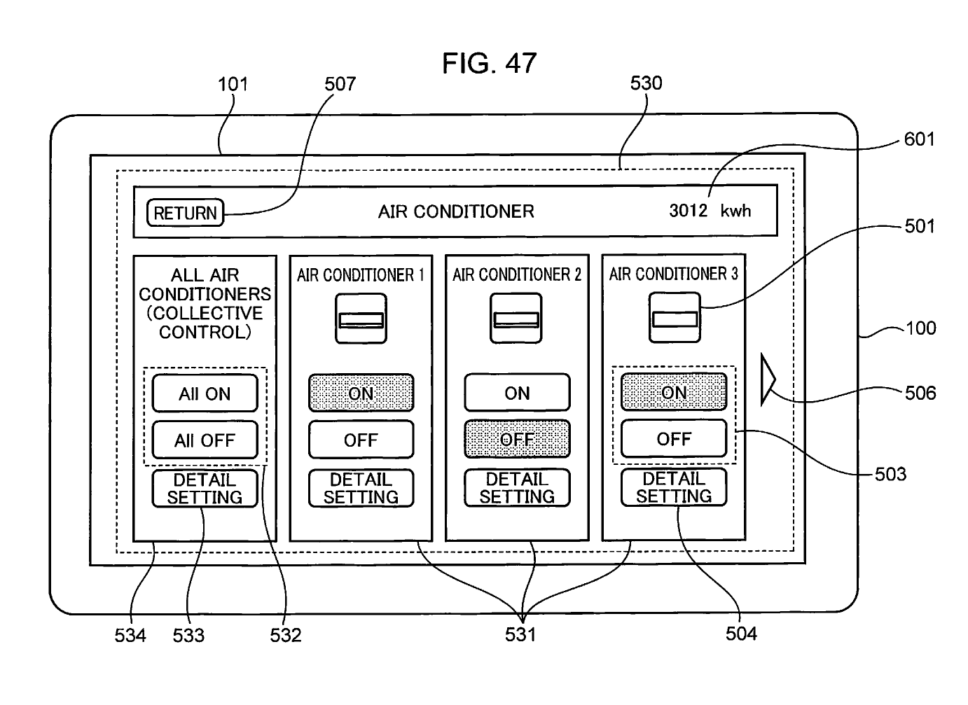

The power consumption information 1800 shown in FIG. 42A enables displaying of the power consumption in the home controller 100 in units of rooms shown in FIG. 7. In addition, the power consumption information 1810 shown in FIG. 42B enables displaying of the power consumption in the home controller 100 in units of devices shown in FIG. 47 (described hereinafter).

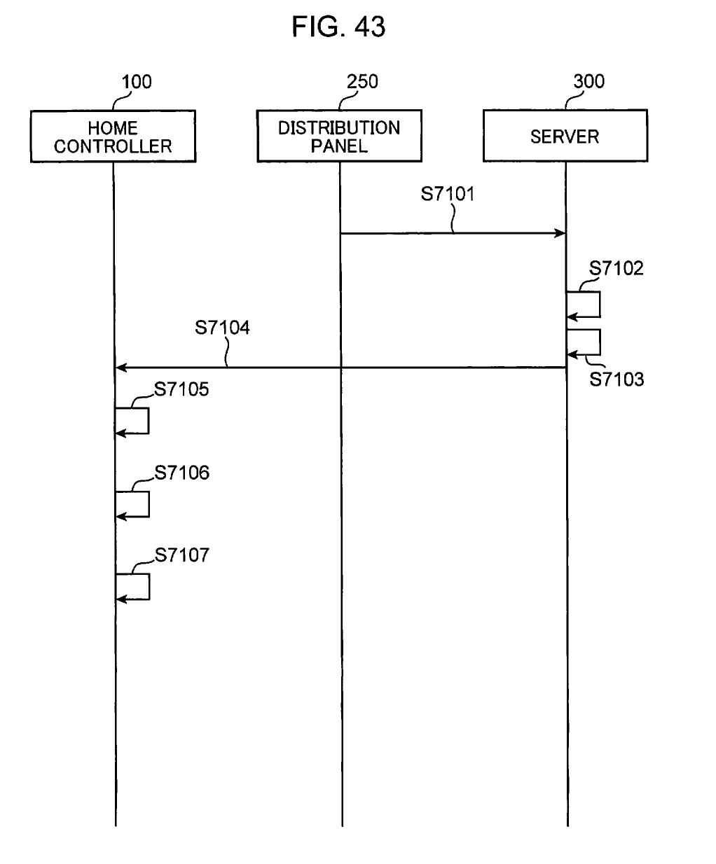

FIG. 43 is a sequence diagram showing an example of a process in which the home controller 100 and the server 300 acquire the power consumptions. A distribution panel 250 functions to measure power consumption for each wiring connected to a device 200. The distribution panel 250 transmits the power consumption of each device to the server 300 (S7101). The distribution panel 250 may transmit the power consumption of each device on a regular basis or when the power consumption of each device changes by a certain value or more.

The server 300 updates the device list 1600 according to the received power consumptions (S7102). The server 300 also calculates the power consumption of each room from the power consumption of each device, and updates the room information 1400 (S7103). The server 300 then generates the power consumption information 1800, 1810 based on the received power consumptions. The server 300 then transmits the generated power consumption information 1800, 1810 to the home controller 100 (S7104).

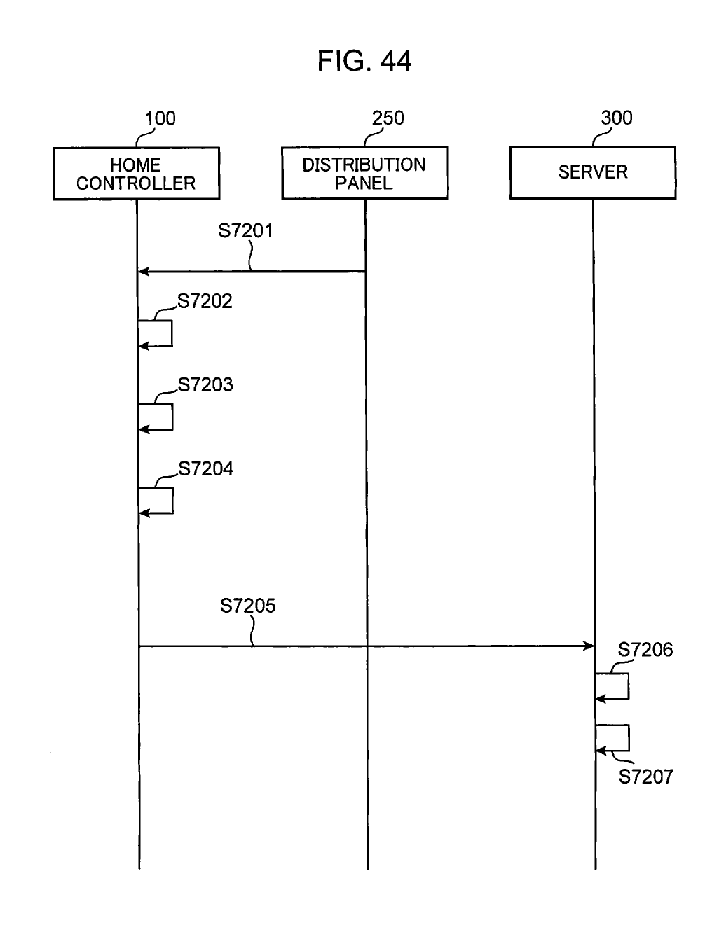

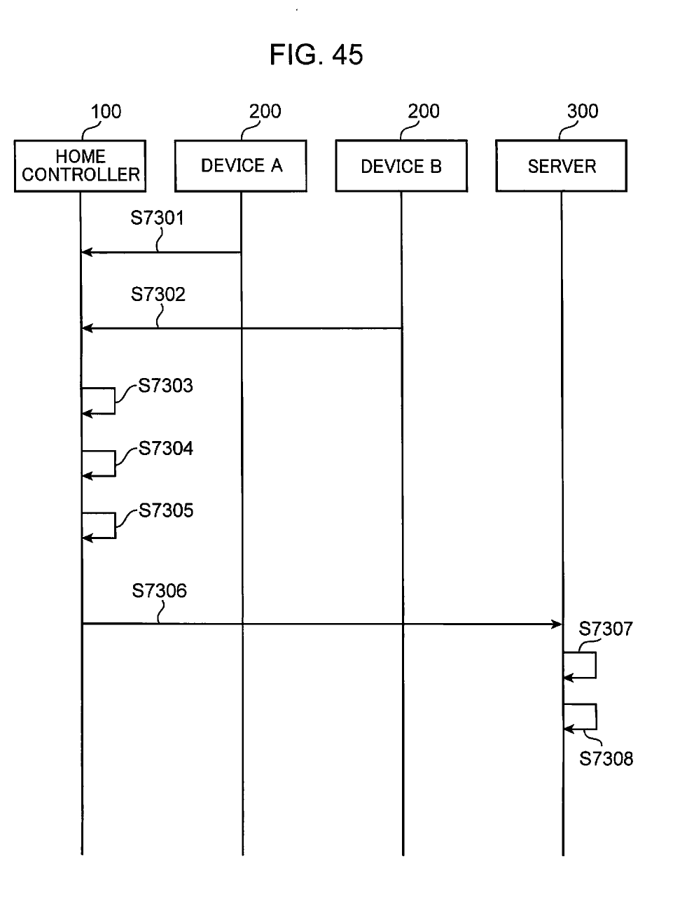

The device management section 105 of the home controller 100 updates the device list 1700 in accordance with the content of the received power consumption information 1810 (S7105). The home controller 100 also updates the room information 1500 in accordance with the content of the received power consumption information 1800 (S7106). The display control section 103 of the home controller 100 updates the display screen (S7107). The update of the display screen includes, for example, update of the display colors of the room icons 502 shown in FIG. 7, update of the power consumption of each room displayed in the display box 600 of each room icon 502, and update of the power consumption of each device displayed in the display box 601 of a device screen 530 shown in FIG. 47 (to be described hereinafter). The same applies to S7204 shown in FIG. 44 and S7305 shown in FIG. 45, as described hereinafter.

In this manner, the server 300 is notified of the power consumption of each device 200. The server 300 can therefore monitor the power consumption of each device 200. Moreover, the server 300, after receiving the power consumption of each device 200, notifies the home controller 100 of the power consumption. Consequently, the home controller 100 can recognize the current power consumption of each device 200. In the power consumption information 1800 transmitted from the server 300 to the home controller 100, the level L1 corresponds to an example of the first information and the level L2 corresponds to an example of the second information.

FIG. 44 is a sequence diagram showing another example of the process in which the home controller 100 and the server 300 acquire the power consumptions. The distribution panel 250 transmits a power consumption to the home controller 100 (S7201). In so doing, the distribution panel 250 may transmit the power consumption on a regular basis or when the power consumption changes by a certain value or more.

The device management section 105 of the home controller 100 updates the device list 1700 in accordance with the received power consumptions (S7202). The home controller 100 calculates the power consumption of each room from the power consumption of each device in the device list 1700, and updates the room information 1500 (S7203). Then, the display control section 103 of the home controller 100 updates the display screen (S7204).

Next, the device management section 105 of the home controller 100 generates the power consumption information 1800, 1810 based on the received power consumptions. The device management section 105 transmits the generated power consumption information 1800, 1810 to the server 300 (S7205). The server 300 updates the device list 1600 in accordance with the received power consumption information 1810 (S7206). The server 300 also updates the room information 1400 in accordance with the received power consumption information 1800 (S7207).

FIG. 45 is a sequence diagram showing yet another example of the process in which the home controller 100 and the server 300 acquire the power consumptions. Here, each device 200 functions to measure the power consumption thereof. The device A 200 transmits the power consumption thereof to the home controller 100 (S7301). The device B 200 transmits the power consumption thereof to the home controller 100 (S7302). In so doing, the device A 200 and the device B 200 may transmit the power consumptions thereof on a regular basis or when the power consumptions each change by a certain value or more.

The device management section 105 of the home controller 100 updates the device list 1700 in accordance with the received power consumptions (S7303). The home controller 100 also calculates the power consumption of each room from the power consumption of each device in the device list 1700, and updates the room information 1500 (S7304). The display control section 103 of the home controller 100 updates the display screen (S7305).

Next, the device management section 105 of the home controller 100 generates the power consumption information 1800, 1810 based on the received power consumptions. The device management section 105 transmits the generated power consumption information 1800, 1810 to the server 300 (S7306). The server 300 updates the device list 1600 in accordance with the received power consumption information 1810 (S7307). The server 300 also updates the room information 1400 in accordance with the received power consumption information 1800 (S7308). Note that the level 1803 may be omitted when the home controller 100 transmits the power consumption information 1800 to the server 300 in FIGS. 44 and 45.

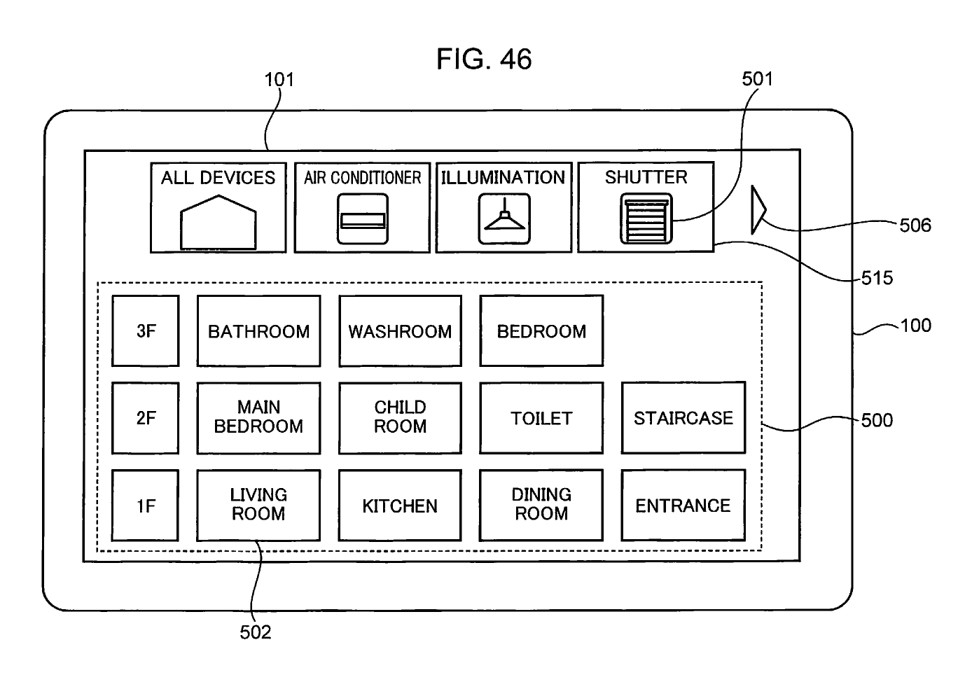

FIG. 46 is a diagram showing yet another example of the basic screen of the home controller 100. On the basic screen shown in FIG. 46, the display control section 103 displays device type icons 515 and the next page button 506 on the display 101 in addition to the floor plan 500 that includes the room icons 502.

The device type icons 515 represent the types of the devices 200. The device type icons 515 are prepared according to the types of the devices 200. The device type icons 515 include the device icons 501 that schematically show the devices representing the types of the devices 200. The device type icons 515 each read the name or abbreviation of a device.

For example, the display control section 103 arranges the device type icons 515 in a single horizontal line in the upper part of the floor plan 500, as shown in the example in FIG. 46. As shown in FIG. 46, the display control section 103 displays, starting from the left, the device type icon 515 representing all the devices, the device type icon 515 representing an air conditioner, the device type icon 515 representing an illumination device, and the device type icon 515 representing an electric shutter device, on the display 101.

On the basic screen shown in FIG. 46, when the user selects the next page button 506, the touch panel control section 102 senses this selection. Consequently, the display control section 103 scrolls through the device type icons 515 arranged and displayed on the display 101, and displays another device type icon 515 on the display 101.

On the basic screen shown in FIG. 46, when the user selects a room icon 502, the touch panel control section 102 senses this selection. Consequently, the display control section 103 displays the room screen 520 of the room represented by the selected room icon 502 on the display 101, as in the case of the basic screen shown in FIG. 5. For example, on the basic screen shown in FIG. 46, when the user selects the room icon 502 for the living room, the display control section 103 displays the room screen 520 of the living room shown in FIG. 8 on the display 101.

When the user selects a device type icon 515 on the basic screen shown in FIG. 46, the touch panel control section 102 senses this selection. Consequently, the display control section 103 displays the device screen 530 (FIG. 47) representing the device 200 of the type corresponding to the selected device type icon 515, on the display 101. In other words, the first layer of display screen (the basic screen) is switched to the second layer of display screen (the device screen 530).

FIG. 47 is a diagram showing an example of the device screen 530 displayed on the display 101 of the home controller 100. As described above, when the user selects a device type icon 515 on the basic screen shown in FIG. 46, the touch panel control section 102 senses this selection. Consequently, the display control section 103 displays the device screen 530 representing the device 200 of the type corresponding to the selected device type icon 515, on the display 101. FIG. 47 illustrates an example in which the device type icon 515 for the air conditioner on the basic screen shown in FIG. 46 is selected by the user.

As shown in FIG. 47, the device screen 530 includes the display box 601 displaying the power consumption of the corresponding device, the next page button 506, the return button 507, and operation screens 531, 534. The upper center of the device screen 530 reads the name or abbreviation of the relevant device (“air conditioner”, in FIG. 47). The display control section 103 calculates the total power consumption of the devices (air conditioners, in FIG. 47) based on the power consumption 1708 of the device list 1700 (FIG. 26), and displays the calculated power consumption of all the devices in the display box 601.

When the user selects the next page button 506, the touch panel control section 102 senses this selection. Consequently, the display control section 103 scrolls through the operation screens 531, 534, and displays on the display 101 the operation screen 531 for controlling another air conditioner installed in the house.

The operation screens 531, 534 are each a screen for controlling the devices 200 (air conditioners, in FIG. 47). The upper center of each of the operation screens 531, 534 reads the name or abbreviation of the relevant device. In FIG. 47, the operation screen 534 shown at the left edge (an example of the second operation screen) is an operation screen for controlling all the air conditioners installed in the house. This operation screen 534 reads “all air conditioners (collective control)”. The operation screen 531 to the right of the operation screen 534 is an operation screen for controlling the first air conditioner installed in the house. This operation screen 531 reads “air conditioner 1”.

The second operation screen 531 from the right of FIG. 47 is an operation screen for controlling the second air conditioner installed in the house. This operation screen 531 reads “air conditioner 2”. The operation screen 531 shown at the right edge of FIG. 47 is an operation screen for controlling the third air conditioner installed in the house. This operation screen 531 reads “air conditioner 3”. The operation screens 531 (an example of the first operation screen) for controlling the first to third air conditioners each include a device icon 501.

The operation screen 534 for controlling all the air conditioners includes a collective control button 532 for collectively controlling the device type (air conditioners, in FIG. 47), and a detail setting button 533 for displaying a detail setting screen for each device type. The collective control button 532 includes a collective OFF button and a collective ON button. Each of the operation screens 531 for controlling the first to third air conditioners includes a simple control button 503 and a detail setting button 504. The simple control button 503 and detail setting button 504 here are the same as the simple control button 503 and detail setting button 504 shown in FIG. 8.

When the user selects the simple control button 503 on one of the operation screens 531 while the device screen 530 is displayed as shown in FIG. 47, the touch panel control section 102 senses this selection. Consequently, the device control section 106 generates a control command for controlling the ON/OFF state of the power of the device 200 corresponding to the selected simple control button 503 (an example of the first control command). The device control section 106 transmits the generated control command to the corresponding device 200 via the communication control section 107 and the network. Furthermore, the display control section 103 changes the display states of the ON button and OFF button in response to the user's selection of the simple control button 503.

In FIG. 47, when the user selects the OFF button of the simple control button 503 on the operation screen 531 for the first air conditioner for example, the touch panel control section 102 senses this selection. Consequently, the device control section 106 generates an OFF control command for stopping the power of the first air conditioner in the living room (an example of the first control command). The device control section 106 transmits the generated OFF control command to the first air conditioner in the living room via the communication control section 107 and the network. In addition, the display control section 103 changes the color of the ON button of the simple control button 503 on the operation screen 531 of the first air conditioner back to the default color, and changes the color of the OFF button.

When the user selects the collective OFF button of the collective control button 532 on the operation screen 534 while the device screen 530 is displayed as shown in FIG. 47, the touch panel control section 102 senses this selection. Consequently, the device control section 106 generates an OFF control command for turning off the powers of all the air conditioners 201 installed in the house (an example of the second control command). The device control section 106 also transmits the generated OFF control command to all the air conditioners 201 installed in the house via the communication control section 107 and the network. The display control section 103 changes the color of the OFF buttons of the simple control buttons 503 on all the operation screens 531, and changes the color of the ON buttons to the default color.

When the user selects the collective ON button of the collective control button 532 on the operation screen 534 while the device screen 530 is displayed as shown in FIG. 47, the touch panel control section 102 senses this selection. Consequently, the device control section 106 generates an ON control command for turning on the powers of all the air conditioners 201 installed in the house. The device control section 106 also transmits the generated ON control command to all the air conditioners 201 installed in the house via the communication control section 107 and the network. The display control section 103 changes the color of the ON buttons of the simple control buttons 503 on all the operation screens 531, and changes the color of the OFF buttons to the default color.

When the user selects the detail setting button 533 on the operation screen 534 while the device screen 530 is displayed as shown in FIG. 47, the touch panel control section 102 senses this selection. Consequently, the display control section 103 displays, on the display 101, the detail control screen 522 for controlling the settings of all the air conditioners 201 installed in the house.

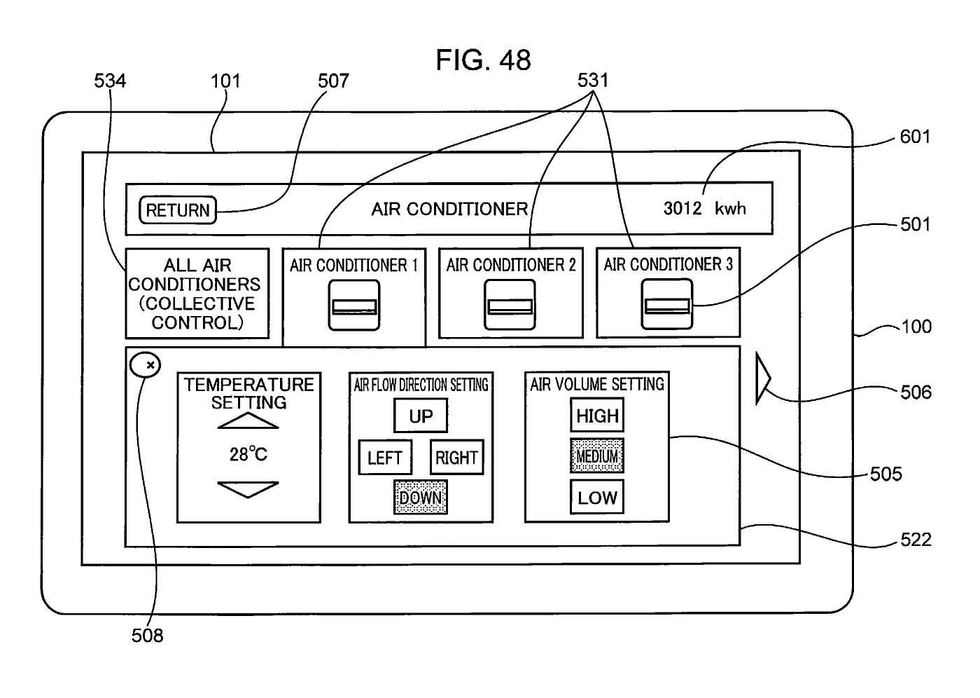

FIG. 48 is a diagram showing an example of the detail control screen 522 displayed on the display 101 of the home controller 100. When the user selects the detail setting button 504 on one of the operation screens 531 or the detail setting button 533 on the operation screen 534 while the device screen 530 is displayed on the display 101 as shown in FIG. 47, the touch panel control section 102 senses this selection. Consequently, the display control section 103 displays the detail control screen 522 corresponding to the selected operation screen 531, 534 on the display 101.

For example, in FIG. 47, when the user selects the detail setting button 504 (an example of the operation button) on the operation screen 531 of the first air conditioner, the touch panel control section 102 senses this selection. Consequently, the display control section 103 displays the detail control screen 522 of the first air conditioner (an example of the extended operation screen) on the display 101, as shown in FIG. 48.

The detail control screen 522 shown in FIG. 48 is the same as the detail control screen 522 shown in FIG. 9. As shown in FIG. 48, the display control section 103 displays such that the detail control screen 522 is in contact with the operation screen 531 for the first air conditioner. The display control section 103 also displays such that the detail control screen 522 is separated from the operation screen 534 for all the air conditioners, the operation screen 531 for the second air conditioner, and the operation screen 531 for the third air conditioner. With this display, the user can easily understand that the detail control screen 522 shown in FIG. 48 is the detail control screen 522 for the first air conditioner.

Then, in FIG. 48, when the user selects an operation screen 531 other than the operation screen 531 for the first air conditioner or the operation screen 534 for example, the touch panel control section 102 senses this selection. Consequently, the display control section 103 displays the detail control screen 522 corresponding to the selected operation screen on the display 101.

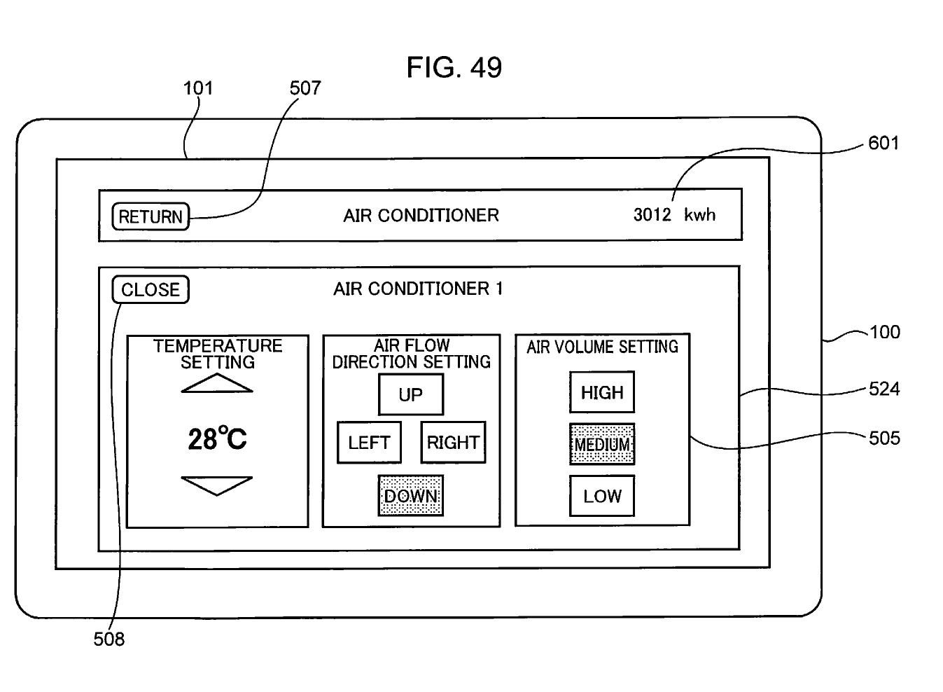

FIG. 49 is a diagram showing another example of the detail control screen displayed on the display 101 of the home controller 100. When the user selects the detail setting button 504 on the operation screen 531 for the first air conditioner while the device screen 530 is displayed on the display 101 as shown in FIG. 47 for example, the touch panel control section 102 senses this selection. Consequently, the display control section 103 displays the detail control screen 524 shown in FIG. 49 (an example of the extended operation screen) in place of the device screen 530, on the display 101. The detail control screen 524 shown in FIG. 49 is the same as the detail control screen 524 shown in FIG. 10.

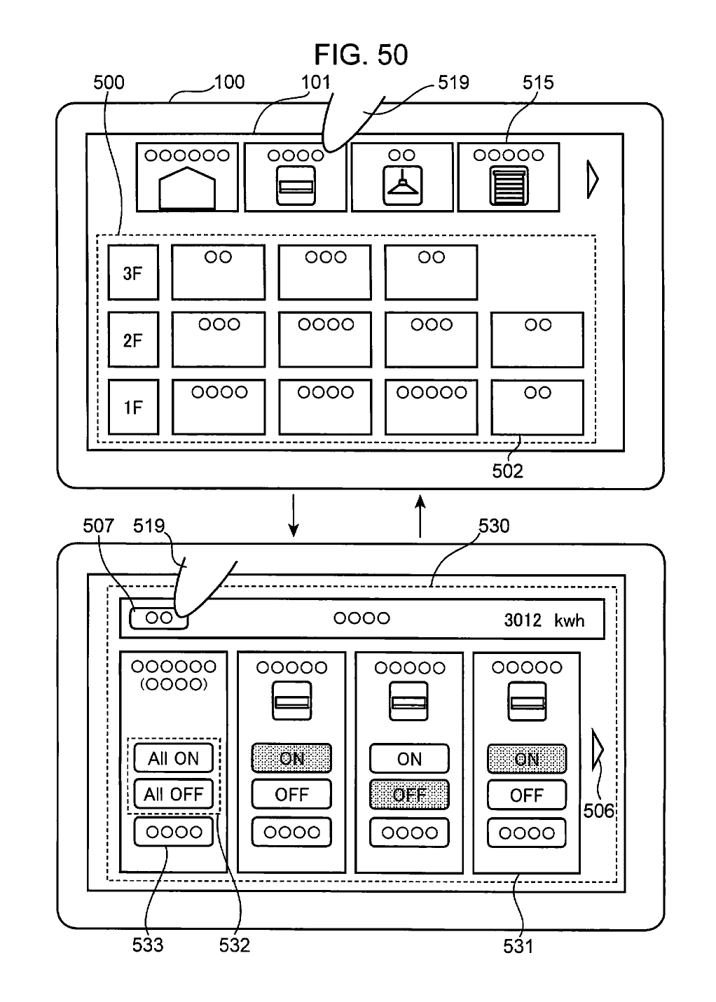

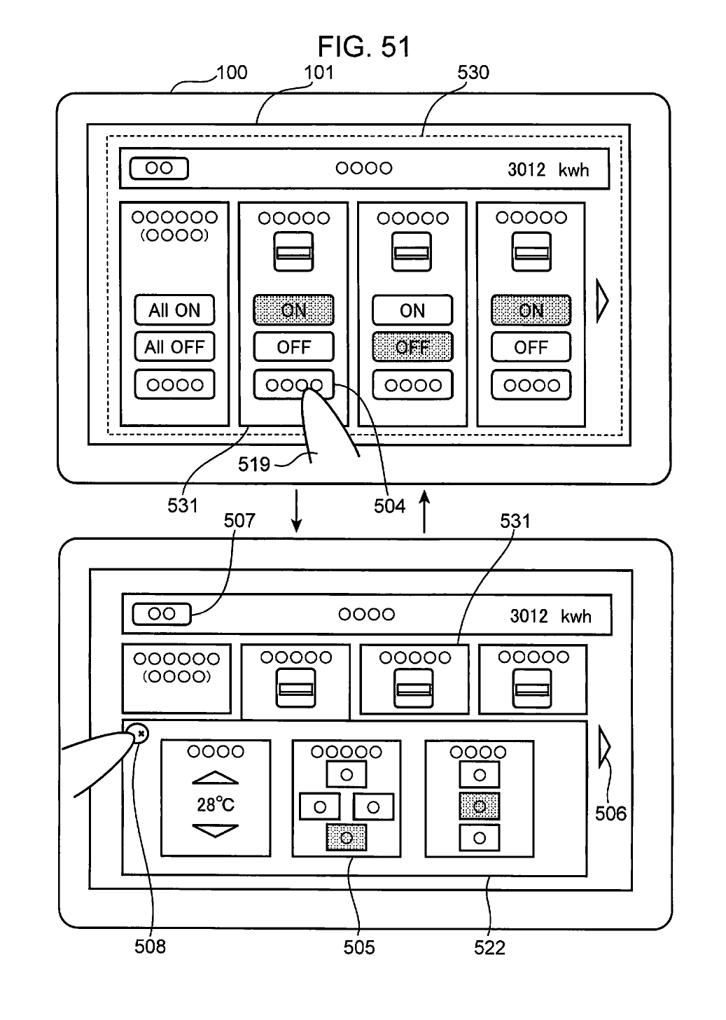

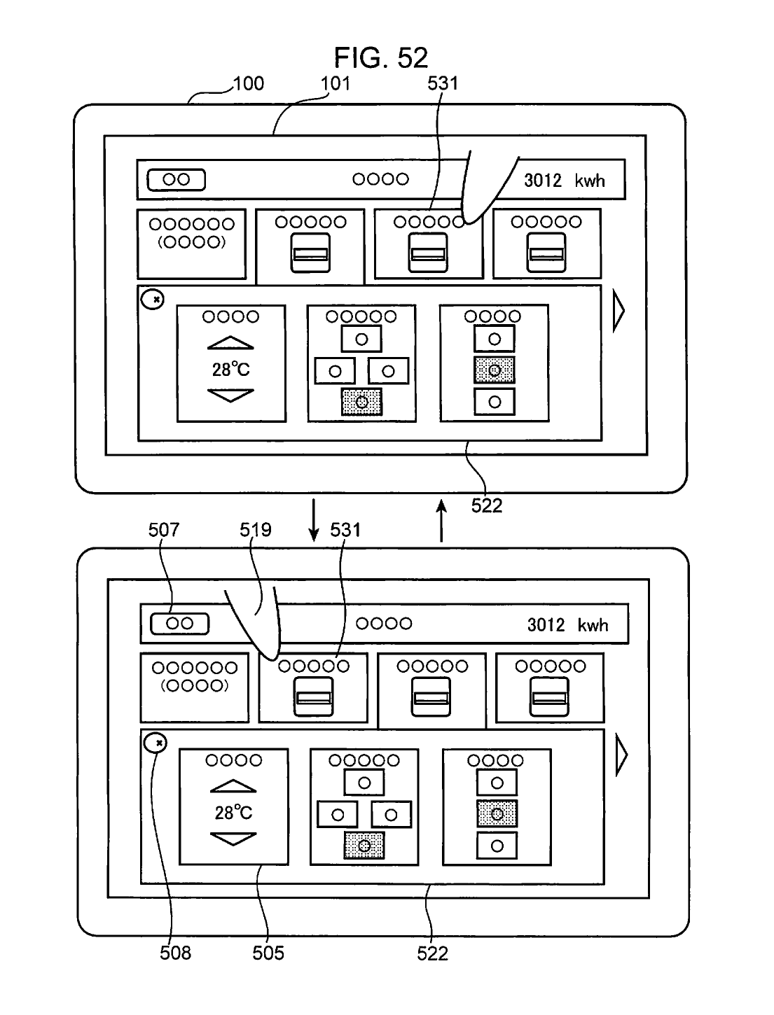

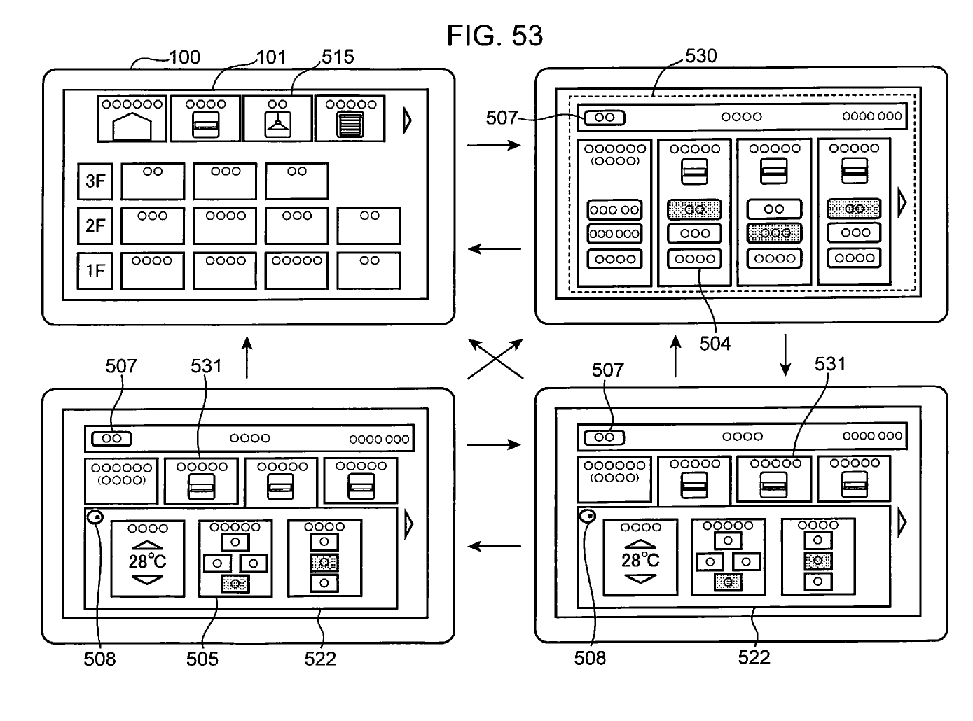

FIGS. 50 to 53 are diagrams each showing an example of transition of the display screen on the display 101 when the display screen is the basic screen shown in FIG. 46. The upper diagram of FIG. 50 is the basic screen shown in FIG. 46, and the lower diagram of FIG. 50 is the display screen shown in FIG. 47. The upper diagram of FIG. 51 is the display screen shown in FIG. 47, and the lower diagram of FIG. 51 is the display screen shown in FIG. 48. The upper diagram of FIG. 52 is the display screen shown in FIG. 48. The upper left diagram of FIG. 53 is the basic screen shown in FIG. 46, and the upper right diagram of FIG. 53 is the display screen shown in FIG. 47. The lower right diagram of FIG. 53 is the display screen shown in FIG. 48, and the lower left diagram of FIG. 53 is the display screen shown in the lower diagram of FIG. 52.

On the basic screen shown in the upper diagram of FIG. 50 (the upper left diagram of FIG. 53), when the user uses the contacting object 519 to select the device type icon 515 for a device 200 that the user wishes to control (an air conditioner, in FIG. 50), the touch panel control section 102 senses this selection. Consequently, as shown in the lower diagram of FIG. 50 (the upper right diagram of FIG. 53), the display control section 103 displays the device screen 530 of the device 200 corresponding to the selected device type icon 515 on the display 101. As a result, the display state of the basic screen shifts to the display state of the device screen 530. In other words, the first layer of display screen (the basic screen) is switched to the second layer of display screen (the device screen 530).

On the other hand, when the user touches the return button 507 with the contacting object 519 during the display state of the device screen 530 shown in the lower diagram of FIG. 50 (the upper right diagram of FIG. 53), the touch panel control section 102 senses this contact. Consequently, as shown in the upper diagram of FIG. 50 (the upper left diagram of FIG. 53), the display control section 103 displays the basic screen on the display 101. As a result, the display state of the device screen 530 shifts to the display state of the basic screen. In other words, the second layer of display screen (the device screen 530) is switched to the first layer of display screen (the basic screen).

Next, when the user touches the detail setting button 504 of the operation screen 531 of the first air conditioner with the contacting object 519 during the display state of the device screen 530 shown in the upper diagram of FIG. 51 (the upper right diagram of FIG. 53), the touch panel control section 102 senses this contact. Consequently, as shown in the lower diagram of FIG. 51 (the lower right diagram of FIG. 53), the display control section 103 displays the detail control screen 522 for the first air conditioner on the display 101. As a result, the display state of the device screen 530 shifts to the display state of the detail control screen 522. In other words, the second layer of display screen (the device screen 530) is switched to the third layer of display screen (the detail control screen 522).

However, when the user touches the close button 508 with the contacting object 519 during the display state of the detail control screen 522 shown in the lower diagram of FIG. 51 (the lower right diagram of FIG. 53), the touch panel control section 102 senses this contact. Consequently, as shown in the upper diagram of FIG. 51 (the upper right diagram of FIG. 53), the display control section 103 displays the device screen 530 on the display 101. As a result, the display state of the detail control screen 522 shifts to the display state of the device screen 530. In other words, the third layer of display screen (the detail control screen 522) is switched to the second layer of display screen (the device screen 530).

Next, when the user touches the operation screen 531 of the second air conditioner with the contacting object 519 during the display state of the detail control screen 522 of the first air conditioner shown in the upper diagram of FIG. 52 (the lower right diagram of FIG. 53), the touch panel control section 102 senses this contact. Consequently, as shown in the lower diagram of FIG. 52 (the lower left diagram of FIG. 53), the display control section 103 displays the detail control screen 522 of the second air conditioner on the display 101. As a result, the display state of the detail control screen 522 of the first air conditioner shifts to the display state of the detail control screen 522 of the second air conditioner.

On the other hand, when the user touches the operation screen 531 of the first air conditioner with the contacting object 519 during the display state of the detail control screen 522 of the second air conditioner shown in the lower diagram of FIG. 52 (the lower left diagram of FIG. 53), the touch panel control section 102 senses this contact. Consequently, as shown in the upper diagram of FIG. 52 (the lower right diagram of FIG. 53), the display control section 103 displays the detail control screen 522 of the first air conditioner on the display 101. As a result, the display state of the detail control screen 522 of the second air conditioner shifts to the display state of the detail control screen 522 of the first air conditioner.

Furthermore, when the user touches the return button 507 on the display screens of the lower right and lower left diagrams of FIG. 53 with the contacting object 519, the touch panel control section 102 senses this contact. Consequently, as shown in the upper left diagram of FIG. 53, the display control section 103 recovers the display state of the basic screen. As a result, the display state of the detail control screen 522 shifts to the display state of the basic screen.

Moreover, when the user touches the close button 508 on the display screen of the lower left diagram of FIG. 53 with the contacting object 519, the touch panel control section 102 senses this contact. Consequently, as shown in the upper right diagram of FIG. 53, the display control section 103 recovers the display state of the device screen 530. As a result, the display state of the detail control screen 522 shifts to the display state of the device screen 530.

As described above, when the user selects a device type icon 515 on the basic screen shown in FIG. 46, the device screen 530 (FIG. 47) is displayed on the display 101. The device screen 530 (FIG. 47) includes the operation screens 531 corresponding to the individual devices 200, and the operation screen 534 corresponding to all the devices 200 of the same type.

The user can select the simple control button 503 of an operation screen 531 to control the ON/OFF state of the power of the device 200 corresponding to this operation screen 531. The user can also select the collective control button 532 of the operation screen 534 to control the ON/OFF state of the powers of all the devices 200 of the same type. Therefore, turning the powers of the individual devices 200 on/off and turning on/off the powers of all the devices 200 of the same type, can be controlled on the display screen (the device screen 530) of the same layer (the second layer). As a result, even in a case where the user wishes to put priority on turning the powers of the individual devices 200 on/off or to put priority on turning the powers of all devices 200 of the same type on/off, turning on/off these devices 200 can appropriately be controlled on the second layer of display screen (the device screen 530).

Also when the user selects the detail setting button 504 of an operation screen 531 on the device screen 530, the detail control screen 522 (FIG. 48) of the device 200 corresponding to the operation screen 531 is displayed on the display 101. The user, therefore, can execute detail control on the device 200, other than turning the power thereof on or off, on the third layer of display screen (the detail control screen 522).

The device screen 530 shown in FIG. 47 includes three operation screens 531. In a case where the house shown in FIG. 1 has one device 200 of the type corresponding to one of the device type icons 515, the device screen 530 has one operation screen 531. For example, suppose that one electric shutter device 20B (FIG. 2) is installed in the house shown in FIG. 1. In this case, when the device type icon 515 corresponding to the electric shutter device 20B on the basic screen shown in FIG. 46 is selected (when the device type icon 515 shown at the right edge of FIG. 46 is selected), the device screen 530 displayed on the display 101 includes one operation screen 531 for operating the electric shutter device 20B.

In this way, in a case where one electric shutter device 20B (FIG. 2) is installed in the house shown in FIG. 1, the device screen 530 may include the operation screen 534 for operating all the electric shutter devices 20B. In this case, regardless of whether the user operates the corresponding operation screen 531 or the operation screen 534, the user can control one electric shutter device 20B in the same way.

On the other hand, in a case where one electric shutter device 20B (FIG. 2) is installed in the house shown in FIG. 1, all the electric shutter devices 20B are treated the same way as one electric shutter device 20B. In such a case, the device screen 530 may not include the operation screen 534 for operating all the electric shutter devices 20B. Even when the device screen 530 does not include the operation screen 534, the user can favorably control the single electric shutter device 20B by operating the corresponding single operation screen 531 of the device screen 530.

Note that the sequences that are carried out by the home controller 100, the devices 200, and the server 300 on the basic screen shown in FIG. 46 and the device screen 530 shown in FIG. 47 are the same as those carried out on the basic screen shown in FIG. 5 and the room screen 520 shown in FIG. 8 described above.

For instance, in S4101 shown in FIG. 36, the user selects the collective OFF button of the collective control button 532 on the operation screen 534, while the device screen 530 shown in FIG. 47 is displayed on the display 101. Consequently, in S4102, the device control section 106 generates a second control command for turning off the powers of all the devices corresponding to the selected type. The device control section 106 also outputs an OFF control command for turning the powers off, as the second control command, to the device A 200 and the device B 200.

For example, in S4101 shown in FIG. 36, the user selects the collective ON button of the collective control button 532 on the operation screen 534, while the device screen 530 shown in FIG. 47 is displayed on the display 101. Consequently, in S4102, the device control section 106 generates a control command for turning on the powers of all the devices corresponding to the selected type. The device control section 106 also outputs an ON control command for turning the powers on, as the control command, to the device A 200 and the device B 200.

For example, in S4301 shown in FIG. 38, the user selects the collective OFF button of the collective control button 532 on the operation screen 534, while the device screen 530 shown in FIG. 47 is displayed on the display 101. Consequently, in S4302, the device control section 106 generates a second control command for turning off all the powers of the devices corresponding to the selected type. The device control section 106 also outputs a collective OFF control command for turning off the powers of all the devices corresponding to the selected type, as the second control command, to the server 300.

For instance, in S4301 shown in FIG. 38, the user selects the collective ON button of the collective control button 532 on the operation screen 534, while the device screen 530 shown in FIG. 47 is displayed on the display 101. Consequently, in S4302, the device control section 106 generates a control command for turning on the powers of all the devices corresponding to the selected type. The device control section 106 also outputs a collective ON control command for turning on the powers of all the devices corresponding to the selected type, as the control command, to the server 300.

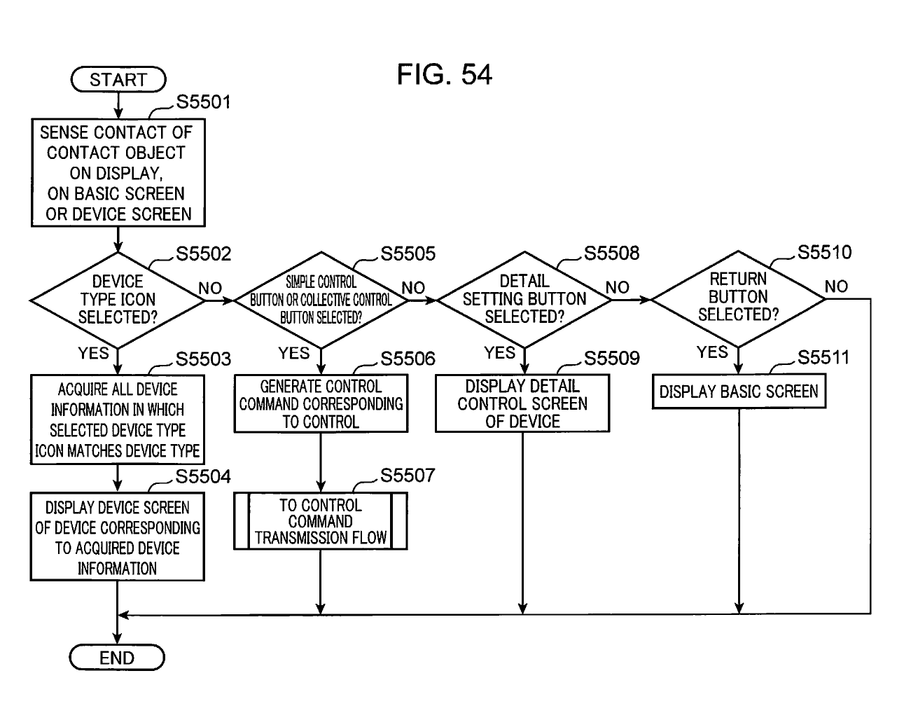

FIG. 54 is a flowchart showing a flow of processes in which the home controller 100 controls the device 200 when the basic screen shown in FIG. 46 or the device screen 530 shown in FIG. 47 is displayed on the display 101.

First, the touch panel control section 102 senses that the user touches the basic screen or the device screen 530 on the display 101 with the contacting object 519 (S5501). Next, the touch panel control section 102 judges whether a device type icon 515 is selected by the user (S5502).

When a device type icon 515 is selected by the user (YES in S5502), the display control section 103 acquires all the device information of the device 200, the device type of which matches the selected device type icon 515 (S5503). When the device type icon 515 for air conditioners is selected by the user for example, the display control section 103 acquires the information on the air conditioner, whose device type 1702 reads “air conditioner”, as the device information from the device list 1700 (FIG. 26). Next, the display control section 103 displays the device screen 530 corresponding to the selected device type icon 515 on the display 101 (S5504), and this process is ended.

However, when a device type icon 515 is not selected by the user in S5502 (NO in S5502), the touch panel control section 102 judges whether the simple control button 503 or the collective control button 532 on the device screen 530 is selected by the user (S5505). When the simple control button 503 or the collective control button 532 is selected by the user (YES in S5505), the device control section 106 generates a control command for controlling the selected simple control button 503 or collective control button 532 (S5506). Next, the device control section 106 executes the control command transmission flow (S5507) shown in FIG. 32, and this process is ended.

However, when the simple control button 503 or the collective control button 532 is not selected by the user in S5505 (NO in S5505), the touch panel control section 102 judges whether the detail setting button 504 or the detail setting button 533 is selected by the user (S5508). When the detail setting button 504 or the detail setting button 533 is selected by the user (YES in S5508), the display control section 103 displays the detail control screen 522 of the corresponding device 200 on the display 101 (S5509), and this process is ended.

However, when the detail setting button 504 or the detail setting button 533 is not selected by the user in S5508 (NO in S5508), the touch panel control section 102 judges whether the return button 507 is selected by the user (S5510). When the return button 507 is selected by the user (YES in S5510), the display control section 103 displays the basic screen on the display 101 (S5511), and this process is ended. When the return button 507 is not selected by the user in S5510 (NO in S5510), this process is ended.

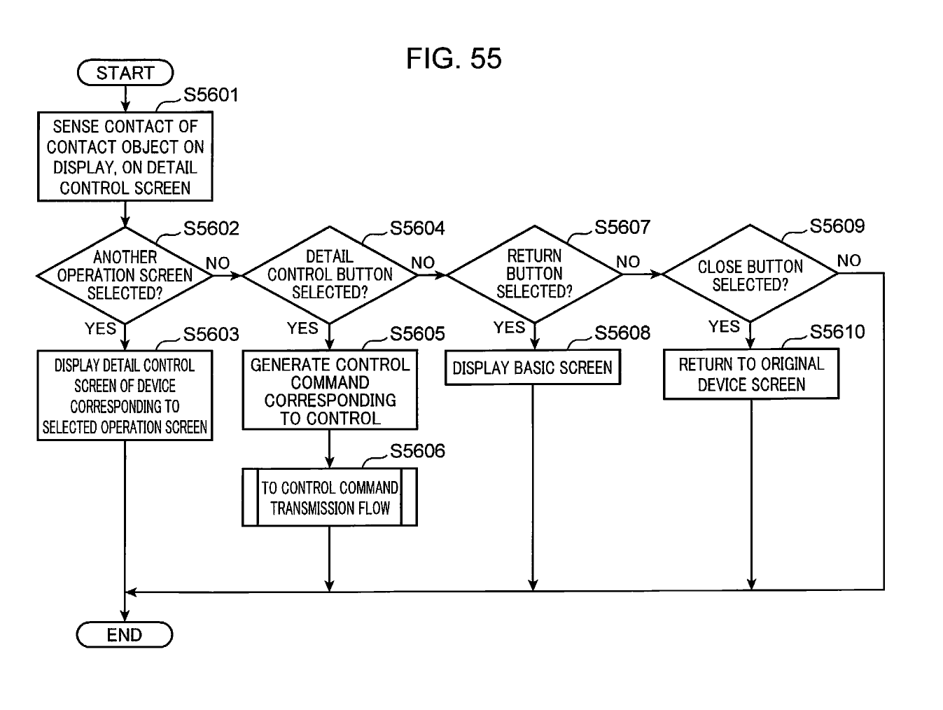

FIG. 55 is a flowchart showing a flow of processes in which the home controller 100 controls the device 200 when the detail control screen 522 shown in FIG. 48 is displayed on the display 101.

First, the touch panel control section 102 senses that the user touches the detail control screen 522 on the display 101 with the contacting object 519 (S5601). Next, the touch panel control section 102 judges whether another operation screen 531, 534 is selected by the user (S5602). When another operation screen 531, 534 is selected by the user (YES in S5602), the display control section 103 displays the detail control screen 522 of the device 200 corresponding to the selected operation screen 531, 534 on the display 101 (S5603), and this process is ended.

However, when another operation screen 531, 534 is not selected by the user in S5602 (NO in S5602), the touch panel control section 102 judges whether the detail control button 505 is selected by the user (S5604). When the detail control button 505 is selected by the user (YES in S5604), the device control section 106 generates a control command for controlling the selected detail control button 505 (S5605). The device control section 106 then executes the control command transmission flow (S5606) shown in FIG. 32, and this process is ended.

On the other hand, when the detail control button 505 is not selected by the user in S5604 (NO in S5604), the touch panel control section 102 judges whether the return button 507 is selected by the user (S5607). When the return button 507 is selected by the user (YES in S5607), the display control section 103 displays the basic screen shown in FIG. 46 on the display 101 (S5608), and this process is ended.

However, when the return button 507 is not selected by the user in S5607 (NO in S5607), the touch panel control section 102 judges whether the close button 508 is selected by the user (S5609). When the close button 508 is selected by the user (YES in S5609), the display control section 103 displays the original device screen 530 on the display 101 (S5610), and this process is ended. When, on the other hand, the close button 508 is not selected by the user in S5609 (NO in S5609), this process is ended.

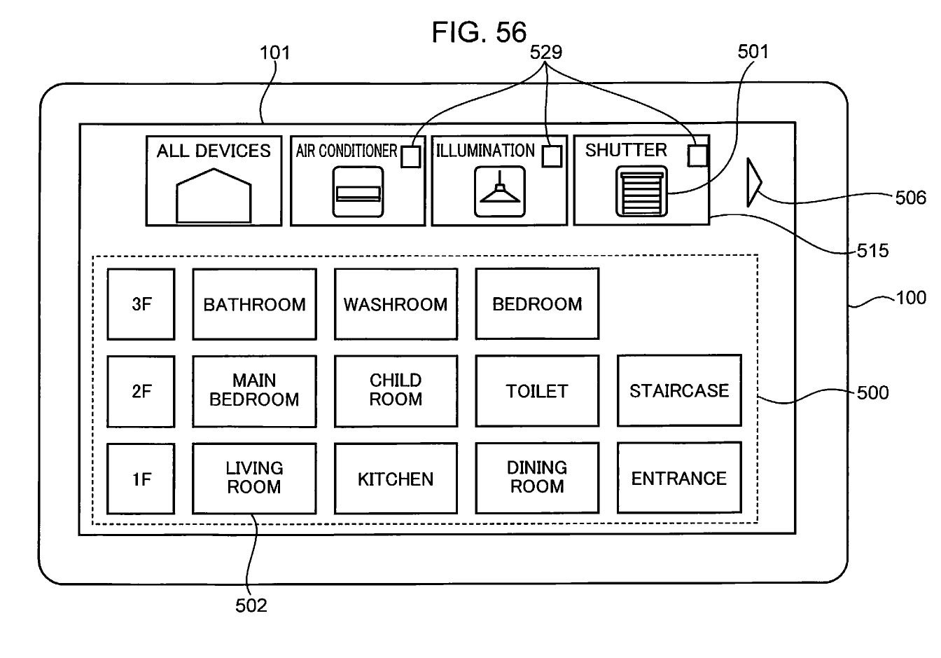

FIG. 56 is a diagram showing yet another example of the basic screen of the home controller 100. On the basic screen shown in FIG. 56, the display control section 103 displays the device type icons 515 and the next page button 506 on the display 101, in addition to the floor plan 500 including the room icons 502. The device type icons 515 each include′ a device type collective control button 529 in addition to the device icons 501, as shown in the example in FIG. 56. The device type collective control buttons 529 are each used to collectively turn on/off the powers of the devices 200 corresponding to the relevant device type icon 515.

On the basic screen shown in FIG. 56, when the user selects the device type collective control button 529 of any of the device type icons 515, the touch panel control section 102 senses this selection. Consequently, the device control section 106 judges whether all the devices 200 of the type corresponding to the device type icon 515 with the selected device type collective control button 529 are already turned off as a result of the selection of the device type collective control button 529. When the devices 200 are not yet turned off, the device control section 106 generates a control command for turning off the powers of all the devices 200 of the type corresponding to the device type icon 515 having the selected device type collective control button 529.

On the other hand, in a case where all the devices 200 of the type corresponding to the device type icon 515 with the selected device type collective control button 529 are already turned off as a result of the selection of the device type collective control button 529, the device control section 106 generates a control command for turning on the powers of all the devices 200 of the type corresponding to the device type icon 515 having the selected device type collective control button 529. The device control section 106 then transmits the generated control command to all the devices 200 corresponding to the device type icon 515 via the communication control section 107 and the network.

For example, when the basic screen shown in FIG. 56 is displayed on the display 101, and when the user first selects the device type collective control button 529 of the device type icon 515 for air conditioners, the device control section 106 generates a control command for turning off the powers of all the air conditioners installed in the house. Subsequently, when the user selects the device type collective control button 529 of the device type icon 515 for illumination devices, the device control section 106 generates a control command for turning off the powers of all the illumination devices installed in the house. Thereafter, when the user selects the device type collective control button 529 of the device type icon 515 for air conditioners, the device control section 106 generates a control command for turning on the powers of all the air conditioners installed in the house.

Note that, in the present embodiment, the display control section 103 and the device control section 106 do not operate even when a region outside the device type collective control button 529 in a device type icon 515 is selected. In other words, on the basic screen shown in FIG. 56, the touch panel control section 102 judges whether any of the device type collective control buttons 529 is selected or not, and whether any of the room icons 502 is selected or not.

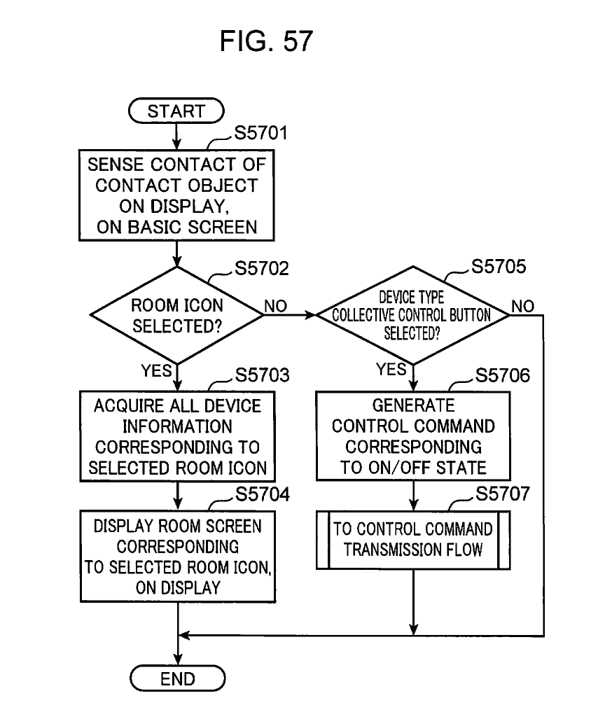

FIG. 57 is a flowchart showing a flow of processes in which the home controller 100 controls the device 200 when the basic screen shown in FIG. 56 is displayed on the display 101.

First, the touch panel control section 102 senses that the user touches the display 101 with the contacting object 519 when the basic screen shown in FIG. 56 is displayed on the display 101 (S5701). Subsequent steps S5702 to S5704 are the same as S5302 to S5304 shown in FIG. 30. Note that the control flow that is implemented when the room screen 520 is displayed on the display 101 is the same as that shown in FIG. 30.

When the room icon 502 is not selected by the user in S5702 (NO in S5702), the touch panel control section 102 judges whether the device type collective control button 529 is selected by the user (S5705).

When the device type collective control button 529 is selected by the user in S5705 (YES in S5705), the device control section 106 generates a control command for turning on or off the powers of all the devices 200 of the type corresponding to the selected device type collective control button 529, in accordance with the ON/OFF states of the devices 200 of the type corresponding to the selected device type collective control button 529 (S5706).

Next, the device control section 106 executes the control command transmission flow (S5707) shown in FIG. 32, and this process is ended. When the device type collective control button 529 is not selected by the user in S5705 (NO in S5705), this process ends.

The embodiment described above mainly includes the following aspects of the present disclosure.

An aspect of the present disclosure is

a method for controlling an information apparatus, the information apparatus having a display and being connected to a network, one or more target devices being controlled over the network,

the method causing a computer of the information apparatus to:

display on the display a display screen including one or more device type icons 515, each of the one or more device type icons 515 representing each of the one or more target devices for each of device types;

when selection of any one of the one or more device type icons 515 is sensed on the display screen, display a device screen 530 for one or more target devices included in one device type corresponding to the selected one device type icon 515, the device screen 530 including one or more first operation screens 531 and a second operation screen 534, each of the one or more first operation screens 531 being used for operating respective one of the one or more target devices, the second operation screen 534 being used for turning off powers of all of the one or more target devices;

output a first control command to the network when a first operation is sensed using any one of the one or more first operation screens 531, the first control command controlling one target device corresponding to the one of the one or more first operation screens 531 among the one or more target devices based on the first operation; and

output a second control command to the network when a second operation is sensed using the second operation screen 534, the second control command turning off powers of all of the one or more target devices based on the second operation.

This aspect first displays a display screen that includes one or more device type icons 515 representing the one or more target devices for each of device types, each of the device types including the one or more target devices, a type of each of the one or more target devices corresponding to the included device type.

In other words, for example, instead of displaying on the display a device icon for each of the target devices such as four air conditioners and fifteen illumination devices, a display screen that includes one or more device type icons 515 representing the one or more target devices for each of device types is displayed as a first layer of display screen. As to the air conditioners, for example, even when there are four air conditioners, a single device type icon 515 corresponding to the type called “air conditioner” is displayed on the first layer of display screen. As to the illumination devices, even when there are fifteen illumination devices, a single device type icon 515 corresponding to the type called “illumination device” is displayed on the first layer of display screen. Thus, when searching for a desired target device, a device type icon 515 corresponding to the type of the desired target device may be searched for on the first layer of display screen. This facilitates the efficient operation of the desired target device.

Next, when it is judged that selection of any of the one or more device type icons 515 is sensed, a device screen 530 of a target device of the type corresponding to the selected one device type icon 515 is displayed.

In other words, when the device type icon 515 is selected, the device screen 530 which is the second layer of display screen is displayed on the display from the first layer of display screen. Accordingly, each of the target devices corresponding to the selected device type icon 515 can be operated promptly, without requiring a further operation between the first layer of display screen and the second layer of display screen. Therefore, even when operating a plurality of target devices of a plurality of types using a single operation device, the number of times of switching the display screen is reduced, and the efficiency of operating a desired target device can be increased.

Next, the device screen 530 has one or more first operation screens 531 for operating, in a case where there are a plurality of target devices of a type corresponding to the selected one device type icon 515, the corresponding target devices respectively. The device screen 530 has a second operation screen 534 for turning, in a case where there are a plurality of target devices of a type corresponding to the selected one device type icon 515, off the powers of all of the target devices.

Even when the third layer of display screen under the device screen 530, which is the second layer, is not selected, the device screen 530, which is the display screen on the same layer, enables to individually operate the target devices corresponding to the selected one device type icon 515, and to collectively turn off the power of all of the target devices.

In other words, when selecting a device type icon 515 for the type corresponding to the desired target device, a user might wish to operate the target devices of this type individually or to turn off all of the target devices corresponding to this type. It is not necessarily the case that the former operation is carried out more frequently than the latter operation. It is also not necessarily the case that the latter operation is carried out more frequently than the former operation. For example, the user may be likely to operate the target devices individually more often when inside a room and may likely to collectively turn all the powers of the devices off when leaving home.

In a case where the device type icon 515 is selected, suppose that only the one or more first operation screens 531 for operating the corresponding target devices respectively are displayed on the display. In this case, in order to display the second operation screen 534 for turning off all the powers of the plurality of target devices, the user is required to execute some kind of an operation to further display the third layer of display screen. Similarly, in a case where the device type icon 515 is selected, suppose that only the second operation screen 534 for turning off all the powers of the plurality of target devices is displayed on the display. In this case, the user is required to execute an operation for further displaying the third layer of display screen to display the one or more first operation screens 531 for operating the corresponding target devices respectively.

For instance, in Patent Document 2, on the second layer of display screen (FIG. 7), all the lights in the house are turned on or off by selecting a switch object that is operated as an “all lights off” switch or an “all lights on” switch of the entire house (paragraph [0049]). Also on the second layer of display screen (FIG. 7), when any of the plurality of illumination objects is double-clicked to call a sublevel screen, the individual lights are controlled using the sublevel screen (paragraph [0048]). In either case, the user is required to execute an operation for selecting the third layer of display screen from the second layer of display screen. For this reason, even when the device type icons 515 categorized by the device types are displayed, the number of operations and time it takes to operate the desired target device increase, lowering the operation efficiency.

Note that Patent Document 1 is merely configured to turn off the powers of the target devices individually on the display screen for “operation menu”, which is the third layer of display screen. Patent Document 1 does not disclose that all the target devices corresponding to the type are collectively turned off.

According to this aspect, the first case in which the target devices corresponding to the type are operated individually and the second case in which the power of all the target devices corresponding to the type are collectively turned off can be realized by the same layer of display screen such as the device screen 530 that is displayed as the second layer of display screen. Therefore, in order to operate a plurality of target devices of a plurality of types using a single operation device, an increase in the number of times to switch the display screens can be prevented and at the same time the efficiency of operating the desired target device can be improved.

The second operation screen 534 is used to collectively turn off all the powers of the target devices of the type corresponding to the selected one device type icon 515. For example, when leaving home, this configuration enables to collectively turn off the power of the target devices of the same type installed in the building, without requiring the user to check which one of the target devices of a which type is on or off.

In the aspect described above, for example,

when the second control command is output to the network for turning off the powers of all of the target devices, an OFF control command for turning off a power may be output to each of the one or more target devices as the second control command.

In other words, when turning the powers off collectively, the OFF control command may be output to the target devices individually.

In the aspect described above, for example,

when the second control command is output to the network for turning off the powers of all of the one or more target devices, a collective OFF control command for turning off the powers of all of the one or more target devices may be output to the network as the second control command.

In other words, when turning the powers off collectively, the collective OFF control command for turning off the powers of all the corresponding target devices may be output. In such a case, for example, the server may receive the collective OFF control command and output the OFF control command to the target devices individually.

In the aspect described above, for example,

the second operation screen 534 may be used to collectively turn on the powers of the one or more target devices included in the one device type corresponding to the selected one device type icon.

In the aspect described above, for example,

each of the one or more first operation screens 531 may be used to turn off the power of respective one of the one or more target devices.

In the aspect described above, for example,

each of the one or more first operation screens 531 may be used to turn the power of respective one of the one or more target devices on or off,

each of the one or more first operation screens 531 may include an operation button 504 for displaying an extended operation screen 522, the extended operation screen 522 being for operating an instruction other than an instruction operable by each of the one or more first operation screens 531, and

the extended operation screen 522 may be displayed on the display when it is judged that selection of the operation button 504 is sensed.

According to this aspect, once a device type icon 515 for the type corresponding to the desired target device is selected on the first layer of display screen, the first operation screen 531 of the target device corresponding to the type is displayed on the second layer of display screen.

However, the area for displaying the device screen 530 is limited. For this reason, the area for displaying the first operation screen 531 is also limited. Thus, in some cases all the operations for controlling the target device cannot be displayed on the first operation screen 531. Especially, in the above aspect, the device screen 530 includes one or more first operation screens and a second operation screen, the one or more first operation screens being, in a case where there are target devices of the type corresponding to the selected one device type icon 515, for operating the corresponding target devices respectively, the second operation screen being, in a case where there are target devices of the type corresponding to the selected one device type icon 515, for turning off powers of all of the target devices;

On the other hand, a method may be considered that, when the device type icon is selected on the first layer of display screen, a device icon for selecting each of the target devices of the type corresponding to the device type icon is selected on the second layer of display screen, and then an operation screen corresponding to the selected device icon is displayed on the third layer of display screen. In this case, however, the user is forced to execute a few more steps of switching the display screen until operating the desired device icon as described above. This increases the number of operations and time it takes to control the desired target device, lowering the operation efficiency. In addition, not all the operations for controlling the target device are executed at the same frequency.

Therefore, when a device type icon 515 of the type corresponding to the desired target device is selected on the first layer of display screen, the first operation screens 531 for turning on or off the individual powers of the target devices of the type are once displayed on the second layer of display screen. For the operations that are not displayed on the first operation screens 531, the extended operation screen 522 may accordingly be displayed on the display, if necessary.

As a result, the effective use of each of the first operation screens 531 with a limited display area can eliminate the constant need to display another lower layer of display screen between when the device type icon 515 is selected and when the desired target device is operated. Accordingly, the efficiency of operating the desired target device can be improved.

In the aspect described above, for example,

in a case where one target device is included in the one device type corresponding to the selected one device type icon 515, the device screen 530 may include one first operation screen 531 as the one or more first operation screens 531, and the device screen 530 may include the second operation screen 534.

In the aspect described above, for example,

in a case where one target device is included in the one device type corresponding to the selected one device type icon 515, the device screen 530 may include one first operation screen 531 as the one or more first operation screens 531, and the device screen 530 may be configured that the device screen 530 does not include the second operation screen 534.

In the aspect described above, for example,

the one or more target devices may include an air conditioner.

In the aspect described above, for example,

the one or more target devices may include an illumination device.

In the aspect described above, for example,

the one or more target devices may include an electronic lock,

an operation for turning off a power of the electronic lock may include an operation for unlocking the electronic lock, and

an operation for turning on the power of the electronic lock may include an operation for locking the electronic lock.

In the aspect described above, for example,

the one or more target devices may include a surveillance camera.

Another aspect of the present disclosure is

a non-transitory computer-readable recording medium which stores a program for controlling an information apparatus, the information apparatus having a display and being connected to a network, one or more target devices being controlled over the network,

the program causing a computer of the information apparatus to:

display on the display a display screen including one or more device type icons 515, each of the one or more device type icons 515 representing each of the one or more target devices for each of device types;

when selection of any one of the one or more device type icons 515 is sensed on the display screen, display a device screen 530 for one or more target devices included in one device type corresponding to the selected one device type icon 515, the device screen 530 including one or more first operation screens 531 and a second operation screen 534, each of the one or more first operation screens 531 being used for operating respective one of the one or more target devices, the second operation screen 534 being used for turning off powers of all of the one or more target devices;

output a first control command to the network when a first operation is sensed using any one of the one or more first operation screens 531, the first control command controlling one target device corresponding to the one of the one or more first operation screens 531 among the one or more target devices based on the first operation; and

output a second control command to the network when a second operation is sensed using the second operation screen 534, the second control command turning off powers of all of the one or more target devices based on the second operation.

### INDUSTRIAL APPLICABILITY

The present disclosure is useful as a method and a recording medium for controlling one or more target devices connected to a network.

What is claimed is:

1. A method for controlling an information apparatus, the information apparatus having a display and being connected to a network, one or more target devices being controlled over the network,
the method causing a computer of the information apparatus to:
display on the display a display screen including one or more device type icons, each of the one or more device type icons representing each of the one or more target devices for each of device types;
when selection of any one of the one or more device type icons is sensed on the display screen, display a device screen for one or more target devices included in one device type corresponding to the selected one device type icon, the device screen including one or more first operation screens and a second operation screen, each of the one or more first operation screens being used for operating respective one of the one or more target devices, the second operation screen being used for turning off powers of all of the one or more target devices;
output a first control command to the network when a first operation is sensed using any one of the one or more first operation screens, the first control command controlling one target device corresponding to the one of the one or more first operation screens among the one or more target devices based on the first operation; and
output a second control command to the network when a second operation is sensed using the second operation screen, the second control command turning off powers of all of the one or more target devices based on the second operation.

2. The method according to claim 1, wherein when the second control command is output to the network for turning off the powers of all of the target devices, an OFF control command for turning off a power is output to each of the one or more target devices as the second control command.

3. The method according to claim 1, wherein when the second control command is output to the network for turning off the powers of all of the one or more target devices, a collective OFF control command for turning off the powers of all of the one or more target devices is output to the network as the second control command.

4. The method according to claim 1, wherein the second operation screen is used to collectively turn on the powers of the one or more target devices included in the one device type corresponding to the selected one device type icon.

5. The method according to claim 1, wherein each of the one or more first operation screens is used to turn off the power of respective one of the one or more target devices.

6. The method according to claim 1, wherein
each of the one or more first operation screens is used to turn the power of respective one of the one or more target devices on or off,
each of the one or more first operation screens includes an operation button for displaying an extended operation screen, the extended operation screen being for operating an instruction other than an instruction operable by each of the one or more first operation screens, and
the extended operation screen is displayed on the display when it is judged that selection of the operation button is sensed.

7. The method according to claim 1, wherein
in a case where one target device is included in the one device type corresponding to the selected one device type icon, the device screen includes one first operation screen as the one or more first operation screens, and the device screen includes the second operation screen.

8. The method according to claim 1, wherein
in a case where one target device is included in the one device type corresponding to the selected one device type icon, the device screen includes one first operation screen as the one or more first operation screens, and the device screen does not include the second operation screen.

9. The method according to claim 1, wherein the one or more target devices include an air conditioner.

10. The method according to claim 1, wherein the one or more target devices include an illumination device.

11. The method according to claim 1, wherein
the one or more target devices include an electronic lock,
an operation for turning off a power of the electronic lock includes an operation for unlocking the electronic lock, and
an operation for turning on the power of the electronic lock includes an operation for locking the electronic lock.

12. The method according to claim 1, wherein the one or more target devices include a surveillance camera.

13. A non-transitory computer-readable recording medium which stores a program for controlling an information apparatus, the information apparatus having a display and being connected to a network, one or more target devices being controlled over the network,
the program causing a computer of the information apparatus to:
display on the display a display screen including one or more device type icons, each of the one or more device type icons representing each of the one or more target devices for each of device types;
when selection of any one of the one or more device type icons is sensed on the display screen, display a device screen for one or more target devices included in one device type corresponding to the selected one device type icon, the device screen including one or more first operation screens and a second operation screen, each of the one or more first operation screens being used for operating respective one of the one or more target devices, the second operation screen being used for turning off powers of all of the one or more target devices;
output a first control command to the network when a first operation is sensed using any one of the one or more first operation screens, the first control command controlling one target device corresponding to the one of the one or more first operation screens among the one or more target devices based on the first operation; and
output a second control command to the network when a second operation is sensed using the second operation screen, the second control command turning off powers of all of the one or more target devices based on the second operation.
